(19) United States
(12) Patent Application Publication
(10) Pub. No.: US 2026/0362245 A1
(43) Pub. Date: Nov. 12, 2026

(54) MIGRATION OF NODES IN AN IAB COMMUNICATION SYSTEM

(71) Applicant: CANON KABUSHIKI KAISHA, Tokyo (JP)

(72) Inventors: Pierre VISA, RENNES (FR); Pascal LAGRANGE, LA CHAPELLE DES FOUGERETZ (FR)

(21) Appl. No.: 19/124,817

(22) PCT Filed: Oct. 31, 2023
(86) PCT No.: PCT/EP2023/080345

§ 371 Date: Apr. 25, 2025

(30) Foreign Application Priority Data
Nov. 3, 2022 (GB) 2216392.7
Feb. 15, 2023 (GB) 2302173.6

(51) Int. Cl. H04W 36/00; H04W 36/08; H04W 36/30; H04W 40/22

(52) U.S. Cl. CPC H04W 36/0058; H04W 36/0064; H04W 36/083; H04W 36/087; H04W 36/30; H04W 40/22

(57) ABSTRACT

Methods and apparatus for use in a migration process in which a Mobile Termination, MT, of an Integrated Access Backhaul, IAB, node is migrated from a second IAB topology managed by a second IAB donor Central Unit, CU, to a third IAB topology managed by a third IAB donor CU. The IAB node is managed by a first IAB donor CU of a first IAB topology. A method at the IAB node comprises sending, to the first IAB donor CU, identification information for identifying the third IAB donor CU.

### FIELD OF THE INVENTION

The present invention generally relates to methods for use in a process for migrating nodes and traffic in an Integrated Access and Backhaul, IAB, communication system. Particularly, the present invention relates to methods for use in a migration process in which a Mobile Termination, MT, of an IAB node, for example a mobile IAB node, is migrated in an IAB communication system.

### BACKGROUND

Wireless communication systems are largely deployed to address a wide range of applications, from mobile broadband, massive machine type communications to Ultra Reliable Low Latency Communications (URLLC). Such systems allow a plurality of user equipment (UE) or mobile terminals to share the wireless medium to exchange several types of data content (e.g. video, voice, messaging . . . ) over a radio access network (RAN) through one or more base stations. The base stations are conventionally wired-connected (e.g. through fiber) to a core network, forming an intermediate network, named backhaul (BH).

Examples of such wireless multiple-access communication systems include systems based on 3rd generation partnership project (3GPP-RTM) standards, such as fourth-generation (4G) Long Term Evolution (LTE) or recent fifth-generation (5G) New Radio (NR) systems, or systems based on IEEE 802.11 standards, such as Wi-Fi.

The demand for network densification increases due to the rising number of users and higher throughput requirement.

Facing the issues of high deployment costs and time of the wired backhaul networks with network densification, 3GPP has proposed, from release 16 for 5G NR, a wireless backhaul, also known as Integrated Access and Backhaul, IAB, where part of the wireless (i.e. radio) spectrum is used for the backhaul connection of base stations instead of fiber. The wireless backhaul communications (between base stations) may use the same radio resources as access communications (between a base station and UEs).

IAB turns out to be a competitive alternative to the fiber-based backhauling in dense areas or areas difficult to cover, as it allows scalable and rapid installations without the burden of cabling the base stations.

IAB is most likely to operate in the millimeter wave (mmWave) band to achieve the required Gbps (gigabits per second) data rate. However, millimeter waves are known to be subject to strong attenuations of signal strength in some weather conditions (rain, fog), and to blockage in case of obstacles located in the path between the emitter and the receiver.

To manage these potential radio link failures, a topological redundancy can be provided within the IAB framework, where multiple data paths are set up between the IAB base station directly connected to the core network (also referred to as the “IAB-donor”) and the IAB base station serving UEs (also referred to as the “access IAB-node” for the UEs). Several intermediate IAB base stations (also referred to as IAB-nodes) may be involved in each of the several paths between the IAB-donor and the access IAB-node, thus forming alternative data paths within a multi-hop IAB topology.

Besides, 3GPP has been considering inter-donor redundancy, where an IAB-node, referred to as a boundary IAB node, can access two different parent nodes connected to two different IAB-donors, with each of the IAB-donors managing a different IAB topology (also referred to as IAB network). The boundary IAB-node, even though belonging to a single IAB topology, i.e. belonging to a single IAB-donor for configuration and management, is thus able to route packets from a first IAB topology managed by a first IAB-donor to a second IAB topology managed by a second IAB-donor. The advantage of such inter-donor redundancy lies in the ability for the first IAB-donor to perform offloading by routing some of its packets through the second IAB topology, thus mitigating congestion issues or overcoming radio link failure issues that may arise in the first IAB topology.

There are other situations where an IAB-node becomes a boundary node. For example, in the case of partial migration of an IAB-node, decided by the IAB-donor, where the Mobile Termination (MT) of the IAB-node becomes connected to a single parent IAB-node belonging to another IAB topology controlled by another IAB-donor. This situation may also happen in the case of an IAB-node that experienced radio link failure (RLF) and that has recovered through a parent IAB-node belonging to another IAB topology. In those cases, the migrated IAB-node and its potential descendant IAB node(s) still belong to the initial IAB topology, and such partial migration may be called MT migration. In order to ensure that traffic can be routed through the other IAB topology, MT migration should be followed by traffic migration where the traffic related to the boundary node and its descendant IAB-nodes is routed through the other IAB topology up to the boundary node (i.e. the migrated IAB-node).

Stationary IAB-nodes should only require a single MT migration. Indeed, a backhaul link (defined between two successive IAB-nodes in the wireless backhaul) may experience radio failure due to fluctuations of radio conditions and, for IAB-nodes that do not move, it should be a temporary situation with possible link recovery after some time. Thus, it should not be required for such stationary IAB-nodes to perform multiple MT migrations in the same IAB topology or toward another IAB topology, and the transmission and the handling of multiple protocol messages can be avoided. For the same reason, the migration of the Distributed Unit (DU) of the IAB-node, leaving the control of the IAB-node to a new IAB-Donor, should not be required for stationary nodes. Moreover, it is noted that such DU migration, that may be called full migration, also involves the handover of UEs served by the migrating mobile IAB-node.

Urban environments are usually characterised by a high density of users along with the presence of a significant number of vehicles (e.g. public/private passengers transportation, goods delivery, food trucks . . . ). Some of these vehicles (e.g. buses, trams, trains), may have predictable routes and a significant number of collocated UEs (i.e. passengers' devices). 3GPP is considering that such vehicles could offer an opportunity to increase network coverage and connectivity to the UEs inside the vehicles, or even to UEs in proximity to the vehicles, by installing on these vehicles on-board base stations (or base station elements) that would act as mobile relays. These mobile relays would rely on 5G wireless backhaul (typically IAB, or Integrated Access & Backhaul) for connecting to a fixed donor device.

Thus, based upon the fixed IAB foundations of releases 16 and 17, 3GPP is now considering Mobile IAB systems and architecture, as a part of the release 18 framework, in order to address scenarios focusing on mobile IAB-nodes mounted on vehicles (such as buses, trains, taxis). In such scenarios, mobile IAB-nodes can be referred to as Vehicle Mounted Relays (VMR), providing 5G coverage/capacity to on-board and/or surrounding UEs.

The technical benefits of using VMRs include, among others, is the ability of the VMR to offer good radio link conditions to the nearby UEs. Additionally, comparing with a solution using a UE as relay (i.e. a Sidelink Relay solution), an IAB-node mounted on a vehicle is expected to have better RF/antenna capabilities, and to have less stringent power/battery constraints than a relay UE.

For a mobile IAB-node it may be worth performing multiple MT migrations or DU migration, as the connection to a parent IAB-node belonging to a first IAB topology may not occur again for a long time as the mobile IAB-node moves around or never again in the case where the mobile IAB-node moves away from the parent IAB-node. Besides, for flexible IAB network management, MT and DU migration should be decorrelated, meaning that a DU migration for an IAB-node may independently occur before or after one or several MT migrations of this IAB-node. Moreover, the DU migration for an IAB-node may be performed toward an IAB-donor different to the IAB-donor associated to the MT of this IAB-node. However, executing a MT migration at the same time as the migration of the co-located DU may lead to failure of at least one of the migration procedures or it may drastically increase the complexity of signalling.

Therefore, some new mechanisms are required to provide such flexibility by supporting multiple MT migrations of an IAB-node, decorrelated to its DU migration.

### SUMMARY

In accordance with a first aspect of the present invention, there is provided a method, performed at an IAB node, for use in a migration process in which a Mobile Termination, MT, of the IAB node is migrated from a first parent IAB network node to a second parent IAB network node, the IAB node (e.g. DU of the IAB node) being managed by a first IAB donor Central Unit, CU, of a first IAB topology and the first and second parent IAB network nodes being managed by a second IAB donor CU of a second IAB topology, as recited in claims 1 to 5 of the accompanying claims.

In accordance with a second aspect of the present invention, there is provided a method, performed at a second IAB donor CU, for use in a migration process in which a Mobile Termination, MT, of an IAB node is migrated in a second IAB topology managed by the second IAB CU, the IAB node (e.g. DU of the IAB node) being managed by a first IAB donor CU, of a first IAB topology, as recited in claims 6 to 11 of the accompanying claims.

In accordance with a third aspect of the present invention, there is provided a method, performed at a first IAB donor CU, for use in a migration process in which a Mobile Termination, MT, of an IAB node is migrated from a first parent IAB network node to a second parent IAB network node, the IAB node (e.g. DU of the IAB node) being managed by the first IAB donor CU, and the first and second parent IAB network nodes being managed by a second IAB donor CU different to the first IAB donor CU, as recited in the claims 12 to 19 of the accompanying claims.

The path information sent to the first IAB donor CU (e.g. the F1 terminating donor CU) can be used to inform the F1 terminating donor CU of the one or more routing paths in a different topology to be used for routing data (e.g. F1 data, including user traffic, control traffic) to/from the IAB node, which one or more routing paths are new routing paths as they include a new parent IAB network node. In the case where the migration between parent IAB network nodes involves a new donor-DU (e.g. when the new parent IAB network node is either a new IAB donor DU or a parent IAB node connected (directly or indirectly) to a new IAB donor DU, the one or more routing paths are for routing data associated with the IAB node through the new IAB donor DU.

In accordance with a fourth aspect of the present invention, there is provided a method, performed at an IAB node, for use in a migration process in which a Mobile Termination, MT, of the IAB node is migrated from a second IAB topology managed by a second IAB donor Central Unit, CU, to a third IAB topology managed by a third IAB donor CU, the IAB node (e.g. DU of the IAB node) being managed by a first IAB donor CU which manages a first IAB topology, as recited in the claims 20 to 23 of the accompanying claims.

In accordance with an example, there is provided a method for use in a migration process in which a Mobile Termination, MT, of an Integrated Access Backhaul, IAB, node is migrated from a second IAB topology managed by a second IAB donor Central Unit, CU, to a third IAB topology managed by a third IAB donor CU, the IAB node being managed by a first IAB donor CU which manages a first IAB topology, the method at the IAB node comprising: receiving, from the third IAB donor CU, one or more addresses associated with a target IAB donor DU of the third IAB topology via which data associated with the IAB node is to be routed in the third IAB topology; sending, to the first IAB donor CU, address information including the one or more addresses. Identification information for identifying the third IAB donor CU may be sent to the first IAB donor CU (for example, the address information and identification information may be sent by the IAB node in one message). The IAB node may send IAB node identification information including at least one identifier of the IAB node. The at least one identifier of the IAB node may include one or more of the information elements F1-Terminating IAB-donor UE XnAP ID and non-F1-Terminating IAB-donor UE XnAP ID or RRC-Terminating IAB-donor UE XnAP ID and BAP address(es) assigned to the IAB node (e.g. assigned by the RRC donor CU(s)).

In accordance with a fifth aspect of the present invention, there is provided a method, performed at a second IAB donor CU, for use in a migration process in which a Mobile Termination, MT, of an IAB node is migrated from a second IAB topology managed by the second IAB donor Central Unit, CU, to a third IAB topology managed by a third IAB donor CU, the IAB node (e.g. DU of the IAB node) being managed by a first IAB donor CU which manages a first IAB topology, as recited in the claims 24 to 25 of the accompanying claims.

In accordance with a sixth aspect of the present invention, there is provided a method, performed at a first IAB donor CU, for use in a migration process in which a Mobile Termination, MT, of an IAB node is migrated from a second IAB topology managed by a second IAB donor Central Unit, CU, to a third IAB topology managed by a third IAB donor CU, the IAB node (e.g. DU of the IAB node) being managed by the first IAB donor CU which manages a first IAB topology, as recited in the claims 26 to 30 of the accompanying claims.

Thus, by means of the information (e.g. address information such as the address(es) of the third or target donor DU to which the IAB node is to be or has already migrated and/or identification information (such as PCI or NCGI) for identifying the third IAB donor CU) sent to the first IAB donor CU (F1 terminating donor CU) of the IAB node by the second IAB donor CU (non-F1 terminating donor CU or RRC terminating donor CU) or by the IAB node, the F1 terminating donor CU can be informed of migration of the MT of an IAB node between two different topologies: e.g. from a second IAB topology managed by a second IAB donor Central Unit, CU (e.g. a source IAB donor CU), to a third IAB topology managed by a third IAB donor CU (e.g. a target IAB donor CU) and of at least one new routing path to be used to route data (e.g. F1 traffic, user traffic and control traffic) for the migrated IAB node in the third IAB topology controlled by the target non-F1 terminating donor CU or target RRC terminating donor CU. The F1 terminating donor CU may then update configuration information for the IAB node based on the received information so as to update routing paths (e.g. the F1-C and F1-U routing paths) associated with or for the IAB-node to the new routing paths for routing data to/from the IAB node via the target donor DU.

Identification information including at least one identifier of the IAB node may be provided to the first IAB donor CU (the F1 terminating donor CU): for example, the identification information may be provided by the IAB node or the second IAB donor CU (non-F1/RRC terminating donor CU.) The at least one identifier of the IAB node may include one or more of the information elements F1-Terminating IAB-donor UE XnAP ID and non-F1-Terminating IAB-donor UE XnAP ID or RRC-Terminating IAB-donor UE XnAP ID (assigned by the RRC terminating donor CU(s)) and BAP address(es) assigned to the IAB node (e.g. a BAP address assigned by the RRC terminating donor CU(s)).

In accordance with a seventh aspect of the present invention, there is provided a method, performed at a second IAB donor CU, for use in a migration process in which a Mobile Termination, MT, of an IAB node is to be migrated from a second IAB topology managed by the second IAB donor CU to a third IAB topology managed by a third IAB donor CU, the IAB node (e.g. DU of the IAB node) being managed by a first IAB donor CU which manages a first IAB topology, as recited in the claims 31 to 35 of the accompanying claims.

In accordance with an eighth aspect of the present invention, there is provided a method, performed at a first IAB donor CU, for use in a migration process in which a Mobile Termination, MT, of an IAB node is to be migrated from a second IAB topology managed by a second IAB donor CU to a third IAB topology managed by a third IAB donor CU, the IAB node (e.g. DU of the IAB node) being managed by the first IAB donor CU which manages a first IAB topology, as recited in the claims 36 to 46 of the accompanying claims.

Thus, by means of the handover request, the first donor CU (e.g. F1 terminating donor CU) can be informed of migration of the MT of the IAB node between two different topologies: e.g. from a second IAB topology managed by a second IAB donor CU (e.g. a source IAB donor CU), to a third IAB topology managed by a third IAB donor CU (e.g. a target IAB donor CU).

The first IAB donor CU may initiate and execute migration of the MT of the IAB node to the third IAB donor CU. Alternatively, the first IAB donor CU may initiate MT migration for execution by the second IAB donor CU.

In an example, the method further comprises determining whether a migration process for a Distributed Unit, DU, of the IAB node has been initiated, and in response to determining a migration process for the DU of the IAB node has been initiated, delaying migrating (or delaying initiating migration of) the MT of the IAB node to the third IAB donor CU until completion of the migration process for the DU of the IAB node.

In another example, the method further comprises delaying initiating a migration process for the DU of the IAB nodes until completion of the migration process for the MT of the IAB node, such as until completion of the setting up of one or more routing paths (e.g. F1-C and F1-U) for routing data associated with the IAB node in the third IAB topology.

In an example, the method may include determining whether a migration process for a Distributed Unit, DU, of the IAB node has been initiated; in response to determining a migration process for the DU of the IAB node has been initiated, sending, to the second IAB donor CU, a handover response rejecting the handover request.

In accordance with a ninth aspect of the present invention, there is provided a method, performed at a second IAB donor CU, for use in managing a migration process in which a Mobile Termination, MT, of an Integrated Access Backhaul, IAB, node is to be migrated from a first parent IAB node of a second IAB topology managed by the second IAB donor Central Unit, CU, to a second parent IAB node, the Distributed Unit, DU, of the IAB node being managed by a first IAB donor CU which manages a first IAB topology, as recited in the claims 47 to 51 of the accompanying claims.

In accordance with a tenth aspect of the present invention, there is provided a method, performed at a first IAB donor CU, for use in managing migration of a Distributed Unit, DU, of an Integrated Access Backhaul, IAB, node during a Mobile Termination, MT, migration process in which a MT of the IAB node is to be migrated from a first parent IAB node of a second IAB topology managed by a second IAB donor Central Unit, CU, to a second parent IAB node, the DU of the IAB node being managed by the first IAB donor CU which manages a first IAB topology, as recited in the claims 52 to 58 of the accompanying claims.

In accordance with an eleventh aspect of the present invention, there is provided a method, performed at a first IAB donor CU, for use in managing a migration process in which a Distributed Unit, DU, of an Integrated Access Backhaul, IAB, node is to be migrated from a first IAB topology managed by the first IAB donor Central Unit, CU, toward a third IAB topology managed by a third IAB donor CU, the Mobile Termination, MT, of the IAB node being managed by a second IAB donor CU which manages a second IAB topology, as recited in the claims 59 to 64 of the accompanying claims.

In accordance with an twelfth aspect of the present invention, there is provided a method, performed at a second IAB donor CU, for use in managing migration of a Mobile Termination, MT, of an Integrated Access Backhaul, IAB, node during a Distributed Unit, DU, migration process in which a DU of the IAB node is to be migrated from a first IAB topology managed by a first IAB donor Central Unit, CU, toward a third IAB topology managed by a third IAB donor CU, the Mobile Termination, MT, of the IAB node being managed by the second IAB donor CU which manages a second IAB topology, as recited in the claims 65 to 69 of the accompanying claims.

By ensuring the MT migration is completed before initiating a DU migration (e.g. delaying the initiation or start of the DU migration until MT migration is completed or disabling initiating a migration process for the DU of the IAB node until after the MT of the IAB node has been migrated) or checking whether a DU migration has been initiated or started and if it has, by delaying MT migration until completion of DU migration or disabling initiating a migration process for the MT of the IAB node until after the DU of the IAB node has been migrated, executing a MT migration at the same time as executing a DU migration can be avoided. Since executing a MT migration at the same time as the migration of the co-located DU may lead to failure of at least one of the procedures or it may drastically increase the complexity of signalling, failures and an increase in signalling complexity can be avoided. To ensure a safe approach, it is desirable for a MT migration to be executed and completed while the co-located DU stays connected to the same donor, and for a DU migration to be executed and completed while the co-located MT stays connected to the same donor.

In another aspect of the present invention, there is provided a method for use in a migration process in which a Mobile Termination, MT, of an Integrated Access Backhaul, IAB, node is migrated from a first parent IAB network node associated with a first IAB donor Distributed Unit, DU to a second parent IAB network node associated with a second IAB donor DU, the IAB node being managed by a first IAB donor Central Unit, CU, of a first IAB topology and the first and second IAB donor DUs being managed by a second IAB donor CU of a second IAB topology, the method at the IAB node comprising: sending, to the first IAB donor CU, address information including one or more addresses associated with the second IAB donor DU through which data associated with the IAB node is to be routed in the second IAB topology.

In accordance with a thirteenth aspect of the present invention, there is provided an apparatus for an IAB node for an IAB communication system as recited in the accompanying claims.

In accordance with a fourteenth aspect of the present invention, there is provided an apparatus for an IAB donor CU (e.g. a source IAB donor CU or a target IAB donor CU) for an IAB communication system as recited in the accompanying claims.

In all aspects, the IAB node may be a mobile IAB node.

Further example features of the invention are described in other independent and dependent claims.

Any feature in one aspect of the invention may be applied to other aspects of the invention, in any appropriate combination. In particular, method aspects may be applied to apparatus/device/unit aspects, and vice versa.

Furthermore, features implemented in hardware may be implemented in software, and vice versa. Any reference to software and hardware features herein should be construed accordingly. For example, in accordance with other aspects of the invention, there are provided a computer program comprising instructions which, when the program is executed by one or more processing units, cause the one or more processing units to carry out the method of any aspect or example described above and a computer readable storage medium carrying the computer program.

### BRIEF DESCRIPTION OF THE DRAWINGS

Different aspects of the invention will now be described, by way of example only, and with reference to the following drawings in which:

FIG. 1 is a schematic diagram of a communication system in which the present invention may be implemented according to one or more embodiments;

FIGS. 2a and 2b schematically illustrate stacks of some protocol layers involved into IAB operations;

FIG. 3 is a schematic diagram illustrating the format of a BAP Protocol Data Unit (PDU) or packet;

FIG. 4 is a block schematic diagram of an example wireless communication device in accordance with embodiments of the present invention;

FIG. 5 is a schematic diagram of an example IAB communication system (or IAB network system) in which embodiments and examples of embodiments of the present invention may be implemented;

FIG. 6 is a schematic and simplified diagram illustrating example message flows in accordance with embodiments of the present invention, to support (multiple consecutive) MT migration(s) of an IAB-node in the IAB topology controlled by the non F1 terminating donor-CU of the IAB-node,

FIG. 7a is a flowchart of an example method for managing, at an IAB-node, MT migration in the IAB topology controlled by its non-F1 terminating donor-CU or RRC terminating donor-CU according to one or more embodiments of the present invention;

FIG. 7b is a flowchart of an example method for managing, at the non-F1 terminating donor-CU or RRC terminating donor-CU of an IAB-node, MT migration of the IAB-node according to one or more embodiments of the present invention;

FIG. 7c is a flowchart of an example method for managing, at the F1 terminating donor-CU of an IAB-node, MT migration of the IAB-node in the IAB topology of the non-F1 terminating donor-CU or RRC terminating donor-CU of the IAB-node according to one or more embodiments of the present invention;

FIG. 8 is a schematic diagram of another example IAB communication system (or IAB network system) in which embodiments and examples of embodiments of the present invention may be implemented;

FIG. 9 is a schematic and simplified diagram illustrating example message flows according to one or more embodiments of the invention, to perform a consecutive MT migration of a mobile IAB-node toward a target IAB topology, including the setup of the control data path;

FIG. 10 is a schematic and simplified diagram illustrating example message flows in accordance with one or more embodiments of the present invention, to setup the user data path for a consecutive MT migration of a mobile IAB-node toward a target IAB topology;

FIG. 11 is a schematic and simplified diagram illustrating example message flows in accordance with one or more embodiments of the present invention, to perform a consecutive MT migration of a mobile IAB-node toward a target IAB topology following a Radio Link Failure (RLF) recovery of the IAB-node;

FIG. 12a is a flowchart of an example method in accordance with one or more embodiments of the present invention, for managing, at an IAB-node, the consecutive MT migration toward a target IAB topology different from the IAB topologies controlled by its F1 terminating donor-CU and its source non-F1 terminating donor-CU or source RRC terminating donor-CU;

FIG. 12b is a flowchart of an example method in accordance with one or more embodiments of the present invention, for managing, at the source non-F1 terminating donor-CU or source RRC terminating donor-CU of an IAB-node, the consecutive MT migration of the IAB-node toward a target IAB topology different from the IAB topology controlled by the F1 terminating donor-CU of the IAB-node;

FIG. 12c is a flowchart of an example method in accordance with one or more embodiments of the present invention, for managing, at the F1 terminating donor-CU of an IAB-node, the consecutive MT migration of the IAB-node toward a target IAB topology different from the IAB topology controlled by the source non-F1 terminating donor-CU or source RRC terminating donor-CU of the IAB-node;

FIG. 13 is a schematic and simplified diagram illustrating other example message flows according to one or more embodiments of the invention, to perform a consecutive MT migration of a mobile IAB-node toward a target IAB topology, including the setup of the control and user data paths;

FIG. 14a is a flowchart of an example method in accordance with one or more embodiments of the present invention, for managing, at the source non-F1 terminating donor-CU or source RRC terminating donor-CU of an IAB-node, the consecutive MT migration of the IAB-node toward a target IAB topology different from the IAB topology controlled by the F1 terminating donor-CU of the IAB-node;

FIG. 14b is a flowchart of an example method in accordance with one or more embodiments of the present invention, for managing, at the F1 terminating donor-CU of an IAB-node, the consecutive MT migration of the IAB-node toward a target IAB topology different from the IAB topology controlled by the source non F1 terminating donor-CU of the IAB-node;

FIG. 15 is a schematic and simplified diagram illustrating example message flows according to one or more embodiments of the invention, to avoid initiating a DU migration of an IAB-node during a consecutive MT migration of the IAB-node;

FIG. 16a is a flowchart of an example method in accordance with one or more embodiments of the present invention, for managing, at the source non-F1 terminating donor-CU or source RRC terminating donor-CU of an IAB-node, the consecutive MT migration of the IAB-node toward a target IAB topology different from the IAB topology controlled by the F1 terminating donor-CU of the IAB-node, in a manner that it does not compete with a DU migration of the IAB-node;

FIG. 16b is a flowchart of an example method in accordance with one or more embodiments of the present invention, performed at the F1 terminating donor-CU of an IAB-node, for use in managing the DU migration of the IAB-node during a consecutive MT migration of the IAB-node;

FIG. 17 is a schematic and simplified diagram illustrating example message flows according to one or more embodiments of the invention, to avoid initiating a consecutive MT migration of an IAB-node during a DU migration of the IAB-node;

FIG. 18a is a flowchart of an example method in accordance with one or more embodiments of the present invention, for managing, at the source F1 terminating donor-CU of an IAB-node, the DU migration of the IAB-node in a manner that it does not compete with a consecutive MT migration of the IAB-node;

FIG. 18b is a flowchart of an example method in accordance with one or more embodiments of the present invention, performed at the non-F1 terminating donor-CU or source RRC terminating donor-CU of an IAB-node, for use in managing the MT migration of the IAB-node during a DU migration of the IAB-node.

### DETAILED DESCRIPTION

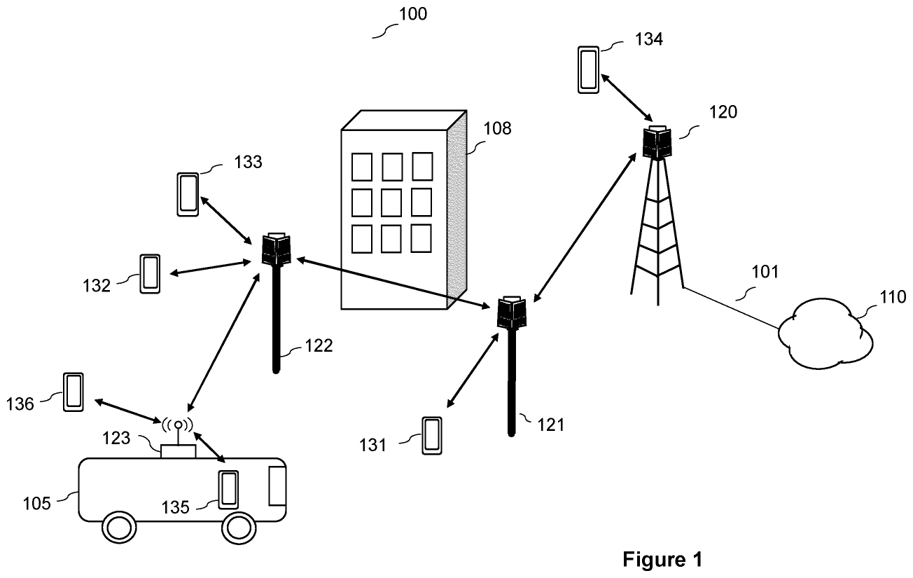

FIG. 1 illustrates an example communication system 100, in particular a mobile radio communication system such as a fifth-generation (5G) New Radio (NR) system including a wireless Integrated Access and Backhaul network supporting mobile IAB-node(s). Although in the following description, embodiments and examples of embodiments of the present invention will be described with respect to a 5G NR system, it will be appreciated that it is not intended that the present invention is limited to 5G NR systems and may be used in any wireless communication systems having a mobile base station. In particular, the following description predominantly uses terminology specific to 5G, but it should be appreciated that such terminology also applies to elements or processes performing an equivalent function in other communication systems.

The system 100 comprises a plurality of UEs (User Equipment) 132, 133, 131 and 134, a remote core network 110, a main Base Station 120, and two Integrated Access and Backhaul (IAB) stations or IAB nodes 121 and 122 (also referred to in the following as IAB-nodes), and a mobile Integrated Access and Backhaul (IAB) station 123 mounted on a vehicle 105 (for example, a bus, a train, a taxi, a car, etc.).

The main Base Station 120, also referred to as the IAB-donor 120, is connected to the core network 110 through a wired link 101, preferably an optical fiber or any other wired means. In embodiments and examples of embodiments of the invention, IAB-donor 120 is a 5G NR gNB with additional functionality to support IAB features, as defined in 3GPP TS 38.300 V17.2.0 specification document.

In order to extend the network coverage of IAB-donor 120 and reach the remote UEs 132, 133 and 131, IAB stations 121 and 122, also referred to as IAB-nodes 121 and 122, have been installed by the operator. By acting as relaying nodes between the IAB-donor 120 and the UEs 132 and 133, IAB-nodes 121 and 122 allow overcoming the reachability issue resulting from presence of building 108, which is an obstacle to the propagation of radio waves and hence to the direct attachment and further communications between the UEs and the IAB-donor 120. This is particularly true when the communications between the IAB-donor 120 and UEs 132 and 133 are operated at millimeter wave frequencies, which are highly sensitive to shadowing phenomena.

The IAB-donor 120 also serves UE 134, which is directly connected to it.

The mobile IAB station 123, also referred to as mobile IAB-node 123 or mIAB node 123, is an IAB-node that is mounted on vehicle 105 and provides network coverage and capacity extension, allowing the IAB-donor 120 to reach onboard remote UEs, like remote UE 135, as well as surrounding UEs or UEs in the vicinity of the IAB-node 123, like remote UE 136.

The IAB-donor 120 and the IAB-nodes 121, 122 and 123 are thus forming a backhaul network or IAB network, or IAB topology, which accommodates UEs 132, 133, 131, 134, 135 and 136. The terms IAB network and IAB topology will be used interchangeably in the following.

The specification of the Integrated Access and Backhaul (IAB) is spread over several 3GPP standard documents, including:
TS 38.300 RAN architecture (V17.2.0),
TS 38.321 MAC protocol (V17.2.0),
TS 38.331 Radio Resource Control (RRC) protocol (V17.2.0),
TS 38.340 Backhaul Adaptation Protocol Layer (V17.2.0),
TS 38.401 RAN architecture (V17.2.0),
TS 38.423 Xn Application Protocol (V17.2.0),
TS 38.473 F1 Application Protocol (V17.2.0).

As IAB-donor 120 and IAB-nodes 121, 122 and 123 are respectively connected to UEs 134, 131, 132, 133, 135 and 136, they are considered as Access IAB-nodes for their respectively connected UEs.

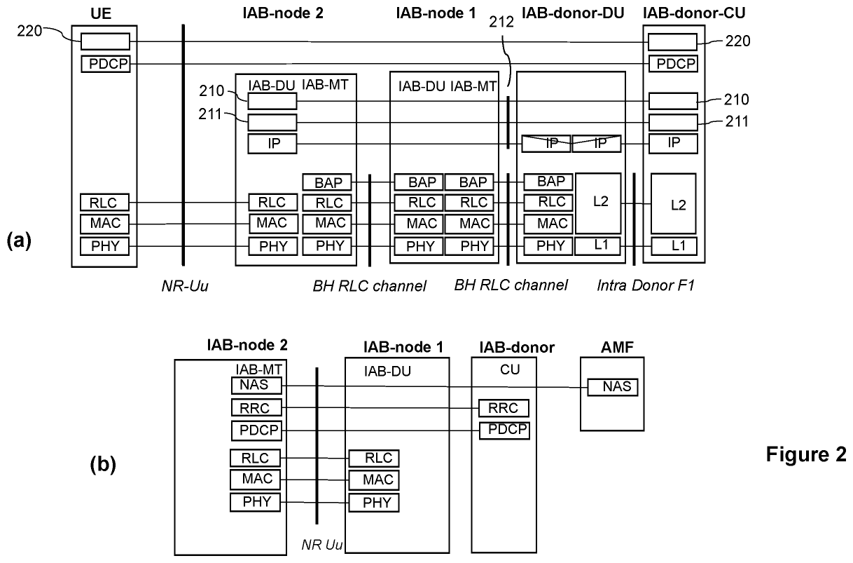

The IAB-donor 120 is a logical node that provides the NR-based wireless backhaul and consists of a central unit (CU or gNB-CU functionality) and connected donor distributed unit(s) (DU or gNB-DU functionality). The IAB-donor-CU or donor-CU (also referred to in the following as IAB-donor CU or IAB donor CU) hosts higher layer protocols, such as PDCP (Packet Data Convergence Protocol) and RRC (Radio Resource Control) protocols, for controlling operation of one or more DUs and each of the one or more IAB-donor-DUs or donor DUs (also referred to in the following as IAB-donor DU or IAB donor DU) includes lower layer protocols, such as the RLC, MAC and physical layer protocols. The IAB-donor-CU or donor-CU and IAB-donor DU or donor DU may be located far from the other or may be located in the same physical device. The gNB-DU functionality is defined in 3GPP TS 38.401. It aims at terminating the NR access interface to the UEs and next-hop IAB-nodes, and at terminating the F1 protocol to the IAB-donor gNB-CU functionality as shown in FIGS. 2a and 2b discussed below.

The IAB nodes, which may serve multiple radio sectors, are wireless backhauled to the IAB-donor 120, via one or multiple hops over one or more intermediate IAB nodes. They form a directed acyclic graph (DAG) topology with the IAB-donor at its root.

The IAB nodes each consist of an IAB-DU (IAB-Distributed Unit) and an IAB-MT (IAB-Mobile Termination). The gNB-DU functionality on an IAB-node is also referred to as IAB-DU and allows the downstream (toward the UE) connection to the next-hop IAB or to a UE. The IAB-MT functionality includes, e.g., physical layer, layer-2, RRC and Non Access Stratum (NAS) functionalities to connect to the gNB-DU of an upstream IAB-node (including the IAB-donor 120 in which case it connects to the IAB-donor gNB-CU, hence to the core network 110, for instance for initialization, registration and configuration).

In this DAG topology, the neighbour node on the IAB-DU's interface is referred to as child node and the neighbour node on the IAB-MT's interface is referred to as parent node. The direction toward the child node is further referred to as downstream while the direction toward the parent node is referred to as upstream.

The IAB-donor 120 (e.g. the IAB-donor CU) performs centralized resource, topology and route management for the whole IAB topology. This includes configuring the IAB-nodes according to the network topology, e.g. in order to perform appropriate routing of data packets.

FIGS. 2a and 2b schematically illustrate stacks of some protocol layers involved in IAB operations.

F1 interface supports the exchange of signalling information between the endpoints, as well as the data transmission to the respective endpoints. From a logical standpoint, F1 interface is a point-to-point interface between the endpoints.

In 5G NR, F1-C is the functional interface in the Control Plane (CP) between the IAB-donor-CU and an IAB-node-DU (e.g. of IAB-node 2), and between the IAB-donor-CU and an IAB-donor DU. F1-U is the functional interface in the User Plane (UP) for the same units. F1-C and F1-U are shown by reference 212 in FIG. 2a. In this example, F1-U and F1-C are carried over two backhaul hops (from IAB-donor to IAB-node1 and then from IAB-node1 to IAB-node2).

In the User Plane, boxes 210 at the IAB-donor-CU and the IAB-node DU refer to the GTP-U layer and boxes 211 refer to the UDP layer. GTP-U stands for GPRS Tunnelling Protocol User Plane. GTP-U Tunnels are used to carry encapsulated PDUs and signalling messages between a given pair of GTP-U Tunnel Endpoints (refer to 3GPP TS 29.281 for more details), here boxes 210 at the IAB-donor-CU and the IAB-node DU. The well-known User Datagram Protocol (UDP) is a transport layer protocol providing a best effort datagram service and fit to use with an IP protocol.

In the Control Plane, boxes 210 indicate the F1AP (F1 Application Protocol) layer and boxes 211 indicate the SCTP (Stream Control Transmission Protocol) layer. The F1 Application Protocol (as defined in 3GPP TS38.473 and TS 38.401) provides signalling services between the IAB-donor-CU and the IAB-node DU, or UE associated services. These services are for example initialization, configuration, and so on. The well-known SCTP layer provides reliable, in sequence transport of messages with congestion control.

F1-U and F1-C rely on an IP transport layer between the IAB-donor-CU and the IAB-node DU as defined in 3GPP TS 38.401.

The transport between the IAB-donor DU and the IAB-donor-CU also uses an IP transport Layer over various media, like for example wires or optical fiber when the IAB-donor-CU is remote from the IAB-donor DU, or locally in a virtual instantiation of the IAB-donor-CU and the IAB-donor DU on the same physical machine. IAB-specific transport between IAB-donor-CU and IAB-donor-DU is specified in 3GPP TS 38.401.

L1 and L2 on the FIG. 2a stand respectively for the transport and physical layers appropriate to the medium in use.

The IP layer can also be used for non-F1 traffic, such as Operations, Administration and Maintenance traffic.

On the wireless backhaul, the IP layer is itself carried over the backhaul adaptation protocol (BAP) sublayer, which enables routing over multiple hops. The BAP sublayer is specified in TS 38.340.

The IAB-DU's IP traffic is routed over the wireless backhaul via the BAP sublayer. In a downstream direction, upper layer packets are encapsulated by the BAP sublayer at the IAB-donor DU, thus forming BAP packets or packet data units (PDUs) or data packets. The BAP packets are routed by the BAP layer or entity (and corresponding BAP entities in the IAB-DU and IAB-MT) of the intermediate IAB-nodes, if any. The BAP packets are finally de-encapsulated by the BAP sublayer at the destination IAB-node (which may be an access IAB-node should the upper layer packets in the BAP packets be intended for a UE).

In an upstream direction, upper layer packets are encapsulated by the BAP sublayer at an initiator IAB-node (which may be an access IAB-node should the upper layer packets come from a UE), thus forming BAP packets or data units (PDUs) or data packets. The BAP packets are routed by the BAP layer (and corresponding BAP entities in the IAB-DU and IAB-MT) of the intermediate IAB-nodes, if any. The BAP packets are finally de-encapsulated by the BAP sublayer at the IAB-donor DU.

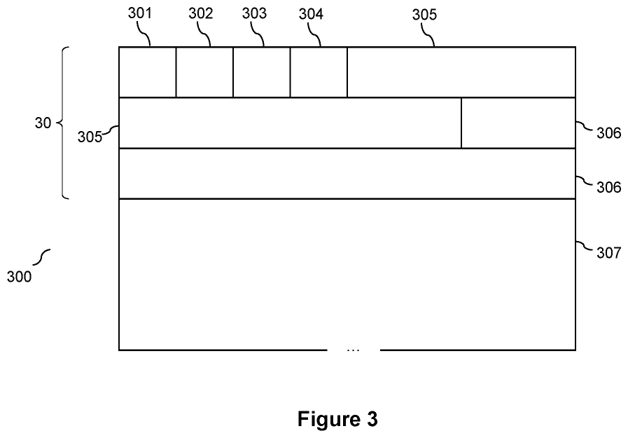

On the BAP sublayer, packets are routed based on the BAP routing ID, which is carried in the BAP header of the BAP packets, and which is set by the BAP sublayer of the emitting IAB-donor-DU or initiator IAB-node (e.g. a network node in the IAB network generating the BAP packets). FIG. 3 illustrates the format of a BAP Data Protocol Data Unit (PDU) or packet. It is specified in the standardized version paragraph 6.2 of 3GPP TS38.340 release 17.2.0.

The payload section 307 is usually an IP packet. The header 30 includes fields 301 to 306. Field 301, named D/C field, is a Boolean indicating whether the corresponding BAP packet is a BAP Data packet or a BAP Control packet. Fields 302-304 are 1-bit reserved fields, preferably set to 0 (to be ignored by the receiver).

Fields 305 and 306 indicate together the BAP routing ID for the BAP packet. BAP address field 305, also referred to as DESTINATION field, is located in the leftmost 10 bits while BAP path identity field 306, also referred to as PATH field, is located in the rightmost 10 bits.

Field 305 carries the BAP address (i.e. on the BAP sublayer) of the destination IAB-node or IAB-donor DU for the BAP packet. For the purpose of routing, each IAB-node and IAB-donor DU in an IAB network is configured (by IAB-donor-CU of the IAB network) with a designated and unique BAP address. Field 306 carries a path ID identifying the routing path the BAP packet should follow to this destination in the IAB topology. For the purpose of routing, the routing paths, including their path ID, are configured (by IAB-donor-CU of the IAB network) in the IAB-nodes of the IAB network.

The BAP header is added to the packet when it arrives from upper layers to the BAP layer, and it is stripped off by the BAP layer when it has reached its destination node. The selection of the packet's BAP routing ID is configured by the IAB-donor-CU.

For instance, when the BAP packet is generated by a node, i.e. either by the IAB-donor-DU for downstream transmission or by an initiator (which may be an access IAB-node should the upper layer packets come from a UE) for upstream transmission, the BAP header with the BAP Routing ID is built by this node according to a configuration table defined in 3GPP TS 38.340. This table is called Downlink Traffic to Routing ID Mapping Configuration table in the IAB-donor-DU or Uplink Traffic to Routing ID Mapping Configuration table in the initiator IAB-node. In intermediate IAB-nodes, the BAP header fields are already specified in the BAP packet to forward.

As mentioned above, these configuration tables defining the BAP paths (hence the routing strategy and the configuration of the IAB-nodes given the IAB network topology) are usually defined by the IAB-donor-CU and transmitted to the IAB-nodes to configure them.

To transport messages over the 5G NR radio medium, three more sublayers (RLC, MAC and PHY) are implemented at each IAB-node below the BAP sublayer. The RLC (Radio Link Control) sublayer is responsible for the segmentation or reconstruction of packets. It is also responsible for requesting retransmissions of missing packets. The RLC layer is further described in TS38.322. The MAC (Media Access Channel) protocol sublayer is responsible for selecting available transmission formats for the user data and for the mapping of logical channel to the transport channels. The MAC handles also a part of the Hybrid Automated Repetition request scheme. The MAC layer is detailed in TS 38.321. On the emitter or transmitter side, the MAC encapsulates the data packet issued from the RLC. It adds a header carrying information necessary to the MAC function. On the receiver side, the MAC decapsulates the data packet issued from the PHY sublayer, deletes its header and passes the remaining data to the RLC. The PHY sublayer provides an electrical interface to the transmission medium (the air) by converting the stream of information into physical modulation signals, modulating a carrier frequency at emitter side. At the receiver side the PHY sublayer converts the physical modulation signals back to a stream of information. The PHY layer is described in TS 38.201, TS 38.211, TS 38.212, TS 38.213, TS 38.214.

To pass messages towards the user or control plane, two other sublayers are used in the UE and IAB-donor-CU: the PDCP (Packet Data Convergence Protocol) sublayer and either the SDAP (Service Data Adaptation Protocol) sublayer for the User Plane communications or the RRC (Radio Resource Control) sublayer for the Control Plane communications.

The PDCP sublayer handles IP Header compression/decompression, ciphering/deciphering, and handles the integrity on the data packet if necessary. It mandatorily numbers the packets on the emitter side and reorders the packets on the receiver side. The PDCP sublayer is described in 3GPP TS38.323.

SDAP sublayer 220 for the User Plane handles the Quality of Service. It is described in TS38.324. On the UE side, the SDAP sublayer exchanges the payload data with the user's application (voice, video, etc . . . —not shown in the Figure). On the IAB-donor-CU side, the SDAP sublayer exchanges the data with the Core Network 110 (Internet traffic, Cloud, etc . . . ).

RRC sublayer 220 for the Control Plane handles the configuration of the protocol entities of the User Plane protocol stack. It is described in TS38.331. It is responsible for the handling of, inter alia, broadcasting information necessary to a UE to communicate with a cell; transmitting paging messages, managing connection, including setting up bearers; mobility functions; measurement configuration and reporting; devices capabilities.

The interface (for both CP and UP) between nodes using the layers PDCP, RLC, MAC and PHY is referenced NR-Uu. This mainly concerns the interface with the UE.

The interface (for both CP and UP) between nodes using the layers BAP, RLC, MAC and PHY is named BackHaul RLC Channel (BH RLC channel). This mainly concerns the interfaces between the IAB-nodes.

NR-Uu is the interface between the UE and the radio access network, i.e. its access IAB-node (for both CP and UP).

FIG. 2b comes from 3GPP TS 38.300 V17.2.0 and illustrates the protocol stack for the support of IAB-MT's RRC and NAS connections. The Non-Access Stratum (NAS) protocol handles the messages between the core network and a user equipment, or an IAB-node. It manages the establishment of communication sessions and maintains communications with the IAB-node or the user equipment as it moves. The 5G NAS is described in 3GPP TS 24.501. The 5G Core Access and Mobility Management Function (AMF) is a function within the Core Network that receives all connection and session related information from the UEs connected to the IAB node, as well as similar information for the IAB-node. AMF is only responsible for handling connection and mobility management tasks.

The IAB-MT establishes signalling Radio Bearers SRBs (bearers carrying RRC and NAS messages) with the IAB-donor-CU. These SRBs are transported between the IAB-MT and its parent node(s) over NR-Uu interface(s).

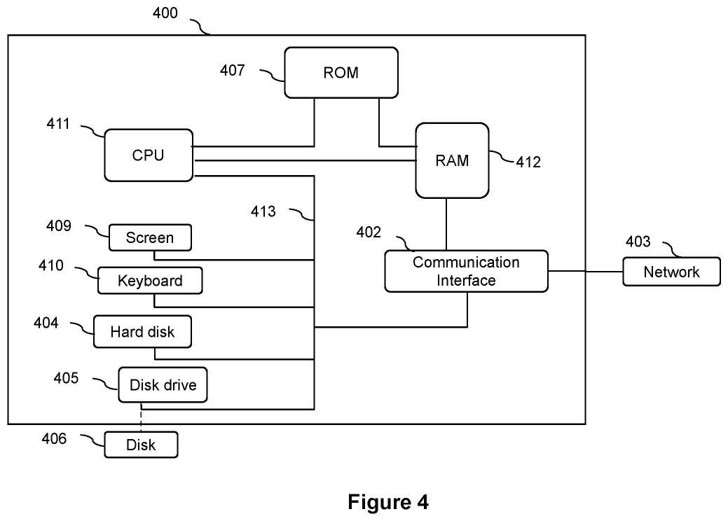

FIG. 4 shows a schematic representation of an example communication device (apparatus) or station, in accordance with one or more example embodiments of the present disclosure.

The communication device 400 may be a device such as a micro-computer, a workstation or a light portable device. The communication device 400 may comprise a communication bus 413 to which there are preferably connected:
a central processing unit 411, such as a microprocessor, denoted CPU. The central processing unit 411 may be a single processing unit or processor or may comprise two or more processing units or processors carrying out the processing required for the operation of the communication device 400. The number of processors and the allocation of processing functions to the central processing unit 411 is a matter of design choice for a skilled person;
memory for storing data and computer programs containing instructions for the operation of the communication device 400. The computer programs may contain a number of different program elements (modules) or sub-routines containing instructions for a variety of operations and for implementing the methods in accordance with one or more embodiments of the invention; and
at least one communication interface 402 for communicating with other devices or nodes in a communication system, such as the communication system of FIG. 1. The at least one communication interface 402 may be connected to the radio communication network 403, such as a wireless communication network for 5G NR (e.g. according to release 17 and/or subsequent releases), over which digital data packets or frames or control frames are transmitted. The frames are written from a FIFO sending memory in RAM 412 to the communication interface for transmission or are read from the communication interface for reception and writing into a FIFO receiving memory in RAM 412 under the control of a software application running in the CPU 411.

Each of a donor CU, a donor DU, an IAB node and a UE may be implemented in such a communication device/apparatus 100.

The memory may include:
a read only memory 407, denoted ROM, for storing computer programs for implementing methods in accordance with one or more embodiments of the invention;
a random-access memory 412, denoted RAM, for storing the executable code of methods according to one or more embodiments of the invention as well as the registers adapted to record variables and parameters necessary for implementing methods according to one or more embodiments of the invention.

Optionally, the communication device 400 may also include the following components:
a data storage means 404 such as a hard disk, for storing computer programs for implementing methods according to one or more embodiments of the invention;
a disk drive 405 for a disk 406, the disk drive being adapted to read data from the disk 1106 or to write data onto said disk;
a screen 409 for displaying decoded data and/or serving as a graphical interface with the user, by means of a keyboard 410 or any other input/output means.

In an example arrangement, the communication bus 413 provides communication and interoperability between the various elements included in the communication device 400 or connected to it. The representation of the bus is not limiting and in particular, the central processing unit is operable to communicate instructions to any element of the communication device 400 directly or by means of another element of the communication device 400.

The disk 406 may optionally be replaced by any information medium such as for example a compact disk (CD-ROM), rewritable or not, a ZIP disk, a USB key or a memory card and, in general terms, by an information storage means that can be read by a microcomputer or by a microprocessor, integrated or not into the communication device, possibly removable and adapted to store one or more programs whose execution enables a method according to embodiments of the invention to be implemented.

The executable code may optionally be stored either in read only memory 407, on the hard disk 404 or on a removable digital medium such as for example a disk 406 as described previously. According to an optional variant, the executable code of the programs can be received by means of the communication network 403, via the interface 402, in order to be stored in one of the storage means of the communication device 400, such as the hard disk 404, before being executed.

The central processing unit 411 may be adapted to control and direct the execution of the instructions or portions of software code of the program or programs according to the invention, which instructions are stored in one of the aforementioned storage means. On powering up, the program or programs that are stored in a non-volatile memory, for example on the hard disk 404 or in the read only memory 407, are transferred into the random-access memory 412, which then contains the executable code of the program or programs, as well as registers for storing the variables and parameters necessary for implementing the invention.

In an example implementation, the communication device (apparatus) is a programmable device/apparatus which uses software to implement the invention. Instructions may be executed by one or more processors of the apparatus, such as one or more digital signal processors (DSPs), general purpose microprocessors, application specific integrated circuits (ASICs), field programmable logic arrays (FPGAs), or other equivalent integrated or discrete logic circuitry to implement the invention for a network node (e.g. IAB node, IAB donor DU, etc.). Accordingly, the term “central processing unit” as used herein may refer to any of the foregoing structure or any other structure suitable for implementation of the techniques described herein. However, alternatively, the present invention may be implemented in hardware (for example, in the form of an Application Specific Integrated Circuit or ASIC or other logic element).

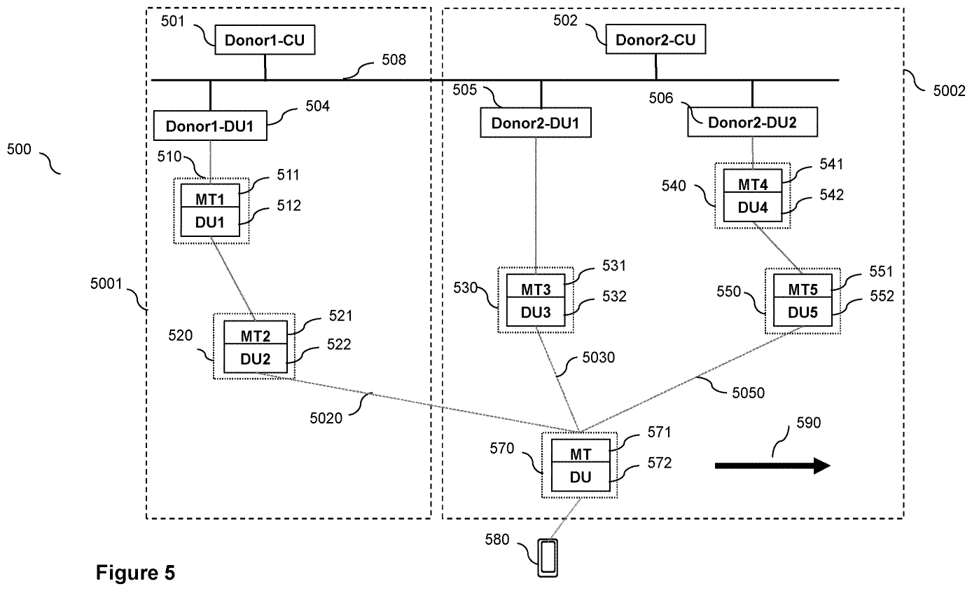

FIG. 5 illustrates an example of an IAB communication system (or IAB network system) 500 in which embodiments and examples of embodiments of the present invention may be implemented. In one example implementation, the radio links between the IAB nodes and between the IAB nodes and the IAB donor DUs (referred to as BH radio links) are operated over the millimeter wave frequency band (i.e. above 30 GHz), which is highly sensitive to radio channel disturbance. An IAB network will also be referred to as an IAB topology or topology and so in this application, the terms IAB network and IAB topology and topology will be used interchangeably.

IAB communication system 500 is composed of two IAB networks or IAB topologies 5001 and 5002 with each IAB topology comprising a set of IAB nodes (e.g. the set may comprise a plurality of IAB nodes or at least one IAB node) and an IAB-donor-CU for controlling or managing the plurality of IAB nodes. The set of IAB nodes may include one or more IAB-nodes, such as initiator IAB-nodes which generate BAP packets and also intermediate or relay IAB-nodes. Each of the IAB nodes communicate with at least one other IAB node over a wireless backhaul (BH) link. Although the FIG. 5 shows two IAB topologies 5001 and 5002, the present invention is not limited to two IAB topologies and may be implemented in an IAB communication system comprising more than two IAB topologies with each topology comprising a set of IAB nodes and an IAB donor-CU as discussed above.

As discussed above, each IAB node comprises a Mobile Termination (MT) part or unit, controlled and configured by the IAB donor using RRC messaging as defined in 3GPP TS 38.331, and a Distributed Unit (DU) part, controlled and configured by the IAB donor using F1-AP messaging as defined in 3GPP TS 38.473. For example, IAB-node 510 comprises a MT part or unit 511 and a DU part 512. IAB-node 570 is a mobile IAB node and thus includes a mobile MT (MT) 571 and a mobile DU (DU) 572.

IAB topology 5001 includes IAB-donor-CU 501 (identified as Donor1-CU in FIG. 5), and its associated IAB-donor-DU 504 (identified as Donor1-DU1 in FIG. 5), and a plurality of IAB-nodes 510 and 520, similar to IAB-nodes 121 and 122.

IAB topology 5002 includes IAB-donor-CU 502 (identified as Donor2-CU in FIG. 5), its associated IAB-donor-DUs, IAB-donor-DU 505 (identified as Donor2-DU1 in FIG. 5) and IAB-donor-DU 506 (identified as Donor2-DU2 in FIG. 5), and a plurality of IAB-nodes 530, 540, 550, similar to IAB-nodes 121 and 122, and IAB-node 570, that may be similar to mobile IAB-node 123. All IAB-nodes can be access nodes serving UEs like the UE 580 served by the mobile IAB-node 570. The IAB topology 5002 is transparent for the UE 580 that connects to the donor-CU 502 through the DU part or DU unit 572 of the mobile IAB-node 570. Although FIG. 5 shows only one UE 580, it will be appreciated that there will be a plurality of UEs connected to the network nodes of the IAB communication system 500.

A wired backhaul IP network interconnects the IAB-donor-CUs 501 and 502, and the IAB-donor-DUs 505, 506 and 504 through the wired backhaul 508. For instance, this wired backhaul 508 consists of optical fiber cables.

IAB-Donor-CU 501, IAB-Donor-DU 504 and IAB-nodes 510 and 520 are part of the same IAB network or IAB topology 5001, which is configured and managed or controlled by IAB-Donor-CU 501.

IAB-Donor-CU 502, IAB-Donor-DUs 505 and 506, IAB-nodes 530, 540, 550 are part of the same IAB network or IAB topology 5002, which is configured and managed or controlled by IAB-Donor-CU 502.

It is assumed that the mobile IAB-node 570 has initially a single parent IAB-node 520 through the backhaul link 5020, and that IAB-node 570 belongs to the IAB topology 5001 controlled by the IAB-Donor-CU 501. When moving, and in view of its proximity to IAB topology 5002, in particular to the IAB-node 530 when in the position shown in FIG. 5, the mobile IAB-node 570 may be able to establish a wireless backhaul link 5030 with the IAB-node 530. Such a backhaul link is possible for a stationary IAB-node, and it is very likely to happen for a mobile IAB-node like IAB-node 570, moving, for instance, in the direction of the IAB topology 5002 (shown by arrow 590 in FIG. 5).

Several scenarios are possible according to the IAB framework release 17.

As a first scenario, the topology redundancy procedure may be applied, as described in TS 38.401 V17.2.0 section 8.17.2, where a dual connectivity is established for the IAB-node 570 with two parent IAB-nodes 520 and 530 belonging to two different IAB topologies.

Each IAB-DU and IAB Donor DU supports wireless communication in coverage area(s) referred to as cell(s). In other words, each IAB-DU and IAB Donor DU is associated with cell(s). Wireless communication devices (such as UEs, or other IAB-nodes) located within a cell may connect to the node (i.e. IAB-DU or IAB Donor DU) serving the cell in order to communicate with other devices (e.g. other UEs, IAB-nodes, servers providing access to the Internet, etc.) via the node. When the IAB-node 570 is initially connected to a single IAB topology (e.g. IAB topology 5001), the MT part or unit MT 571 of IAB-node 570 periodically performs a cell search procedure, as defined in 3GPP TS 38.300, trying to detect PSS (Primary Synchronization Signal) and SSS (Secondary Synchronization Signal) of neighbouring cells. The IAB-node 570 may report to its donor-CU 501 the presence of a new cell activated or controlled by the IAB-node 530, through a measurement report which includes the identifier of the cell. The identifier of a cell also enables the identification of the IAB Donor CU managing this cell. Based on the analysis of the measurement report, the donor-CU 501 may request to the donor-CU 502 the establishment of a dual connectivity for the IAB-node 570 with an additional connection through the IAB-node 530. The donor-CU 502 may accept the request and proceed to the connection of the IAB-node 570 according to the procedure described in TS 37.340 V17.2.0 section 10.2. As a result, the IAB-node 570, still belonging to IAB topology 5001, is now also connected to IAB-node 530, which belongs to IAB topology 5002, and it may be referred to as a boundary node between IAB topology 5001 and IAB topology 5002. Actually, the IAB-node 570 retains its F1 connection and its RRC connection to the donor-CU 501, which can be referred to as the F1-terminating IAB-donor-CU, and it has another RRC connection to the donor-CU 502, which can be referred to as the non-F1-terminating IAB-donor-CU. The IAB donor-CU that terminates the RRC connection of the IAB-node may be referred to as the RRC terminating donor-CU or RRC donor-CU. The RRC terminating donor-CU may be an F1 terminating donor CU or a non-F1 terminating donor CU.

As the IAB-node or boundary node 570 is part of the IAB topology 5001 (from the F1 connection point of view), it is controlled (e.g. configured and managed) by the IAB-Donor-CU 501 of IAB topology 5001. Through the second RRC connection, the donor-CU 502, assigns a second BAP address to be used for routing packets through the IAB topology 5002. Thus, IAB-node 570 acting as a boundary node is assigned two BAP addresses: one BAP address for IAB topology 5001 and one BAP address for IAB topology 5002. Such a boundary node can help provide network path diversity by providing alternative routing paths through the IAB topologies 5001 and 5002.

Indeed, the IAB-donor-CU 501 may take benefit of the dual connectivity of IAB-node 570 between IAB topology 5001 and IAB topology 5002, to balance the traffic load in IAB topology 5001 by offloading, or migrating, some traffic (user traffic or control traffic) initially planned to be routed through IAB nodes 510, 520, and the BH link 5020 to the IAB-node 570. In the IAB communication system, all traffic communicated over backhaul links uses a F1 interface (F1-C or F1-U) between an IAB donor CU and an IAB-DU. Thus, the traffic or backhaul traffic that is offloaded or migrated is F1 traffic and can include control and user traffic. In this case and as described in TS 38.401 V17.2.0 section 8.17.2, the donor-CU 501 triggers the IAB transport migration management procedure specified in TS 38.423 V17.2.0 section 8.5.2. The donor-CU 502 may reject the request for a part or for the full traffic to be migrated, for instance because of load issue in the IAB topology 5002. Thus, for example, traffic initially planned to be routed between the donor-CU 501 and the IAB-node 570 over a backhaul path (path 1) which includes donor-DU 504, IAB nodes 510 and 520 may be migrated or offloaded to a backhaul path (path 2) which includes donor-DU 505 and IAB node 530.

As a second scenario, the BH link or BH radio link 5020 may also experience radio link deficiency due to some unexpected interference or shadowing phenomena. For such reasons, the IAB-node 570 may lose the connection with the IAB-node 520 and declare a Radio Link Failure (RLF) for the BH link 5020. Then, the IAB-node 570 will try to reestablish the connection with the same or a different parent IAB-node (or donor-DU). Thus, for instance, the IAB-node 570 may try to join the IAB topology 5002 managed by IAB-donor-CU 502 with a connection through the new parent IAB-node 530 and the BH link 5030. In this case, the inter-CU backhaul RLF recovery procedure may be applied, as described in TS 38.401 V17.2.0 section 8.17.4, which enables the recovery of an IAB-node to another parent node underneath a different IAB-donor-CU, when the IAB-MT of the IAB-node declares a backhaul RLF. In such a procedure, the donor-CU 502 sends to the donor-CU 501 a request to retrieve the context of the IAB-node 570. Based on the response from the donor-CU 501, the donor-CU 502 may accept the connection of the IAB-node 570, which becomes a boundary node still belonging to the IAB topology 5001. Actually, the IAB-node 570 retains its F1 connection to the donor-CU1 which can be referred to as the F1-terminating IAB-donor-CU, and it has a RRC connection to the donor-CU 502, which can be referred to as the non-F1-terminating IAB-donor-CU or RRC terminating donor-CU or RRC donor-CU.

Then, the IAB-donor-CU 501 may request the migration of the F1 traffic (user traffic and control traffic) related to the IAB-node 570 toward the IAB topology 5002. In this case, the donor-CU 501 triggers the IAB transport migration management procedure specified in TS 38.423 V17.2.0 section 8.5.2. The donor-CU2 502 may reject the request for a part or for the full traffic to be migrated, for instance because of load issue in the IAB topology 5002.

As a third scenario, the IAB-node 570 may be partially migrated toward the IAB topology 5002, meaning the MT 571 becomes connected to the donor-CU 502, thus the RRC connection is migrated from the IAB-Donor-CU 501 to the IAB-donor-CU 502. Indeed, based on the measurement report provided by the IAB-node 570, the donor-CU 501 may detect that the IAB-node 570 would have a better connection through a cell of the IAB-node 530 belonging to the IAB topology 5002. Then, the donor-CU 501 may trigger the IAB Inter-CU Topology Adaptation procedure described in TS 38.401 V17.2.0 section 8.17.3.1. In this procedure, the donor-CU 501 sends a handover request to the donor-CU 502 with information for the donor-CU 502 to establish a RRC connection to the IAB-node 570. Based on this information, the donor-CU 502 may accept the handover request and proceed to the admission of the IAB-node 570 (e.g. to set up a connection with the IAB-node 570), which becomes a boundary node still belonging to the IAB topology 5001, with its F1 connection with the donor-CU 501 (i.e. the F1 terminating donor-CU), and its RRC connection with the donor-CU2 502 (i.e. the non-F1 terminating donor-CU or RRC terminating donor-CU). This procedure may be applied after the topology redundancy procedure (first scenario), has been performed or, by anticipation, before a connection loss between the IAB-node 570 and the IAB-node 520.

Then, the IAB-donor-CU 501 may request the migration of the backhaul or F1 traffic related to the IAB-node 570 toward the IAB topology 5002. In this case, the donor-CU 501 also triggers the IAB transport migration management procedure specified in TS 38.423 V17.2.0 section 8.5.2. The donor-CU2 may reject the request for a part or for the full traffic to be migrated, for instance because of load issue in the IAB topology 5002.

In case the IAB-node 570 has some child IAB-node(s), a similar inter-CU topology adaptation procedure applies, as specified in TS 38.401 V17.2.0 section 8.17.3.2, where the donor-CU 501 additionally configures the migrating node and the child IAB-node(s) to correctly route the BAP packets.

In these scenarios, the IAB topology 5001 may be referred to as the source IAB network or source IAB topology, and the topology 5002 may be referred to as the target IAB network or target IAB topology. Also, the donor-CU 501 may be referred to as the source IAB-Donor-CU or source donor-CU, and the donor-CU 502 may be referred to as the target IAB-Donor-CU or target donor-CU.

The outcome of the procedures applied in the second and third scenario is the MT migration, also called partial migration, of the IAB-node 570. In the first scenario, where a dual connectivity is established for the IAB-node 570 with two parent IAB-nodes 520 and 530, the MT remains connected to the source IAB-node 520.

In all the three scenarios described above, the UE 580 still connects to the donor-CU 501 through the DU part or unit DU 572 of the mobile IAB-node 570. In case the IAB-node 570 has some child IAB-node(s), such child IAB-node still belongs to the IAB topology 5001, fully controlled (through F1 and RRC connections) by the donor-CU 501.

While still moving, the IAB-node 570 may become in a position where a backhaul link 5050 with the IAB-node 550 may have a better quality than the backhaul link 5030 with the IAB-node 530. At some point, the IAB-node 570 may also experience RLF on the backhaul link 5030. Thus, the three scenarios described above may be repeated but this time considering intra-CU procedures. Indeed, the donor-CU 502 may have to handle:
either the intra-CU topological redundancy procedure described in TS 38.401 V17.2.0 section 8.2.4, resulting in the dual-connectivity of the IAB-node 570 with two parent IAB-nodes 530 and 550,
the intra-CU backhaul RLF recovery procedure described in TS 38.401 V17.2.0 section 8.2.5, resulting in a consecutive MT migration of the IAB-node 570 with a new single parent IAB-node 550,
or the intra-CU topology adaptation procedure described in TS 38.401 V17.2.0 section 8.2.3.1, resulting also in a consecutive MT migration of the IAB-node 570 with a new single parent IAB-node 550.

With the cases involving MT migration of the IAB-node 570 to the parent IAB-node 550, the donor-CU 502 has to switch from a first backhaul path including donor-DU 505 and IAB-node 530 to a second backhaul path (which includes donor-DU 506, IAB-nodes 540 and 550) to reach the IAB-node 570, and the donor-CU 501 has to be informed to redirect its offloaded traffic (control and user traffic) through the donor-DU 506 instead of donor-DU 505. With dual-connectivity, the donor-CU 502 may still have the choice to maintain the first backhaul path through the donor-DU 505 and the IAB-node 530 to reach the IAB-node 570, or to switch to the second backhaul path through the donor-DU 506 and the IAB-nodes 540 and 550. When the second backhaul path is selected by the donor-CU 502, this case can be also considered as a consecutive MT migration for the IAB-node 570, and the donor-CU 501 has to be informed.

Examples of methods, in accordance with one or more embodiments of the present invention, which enable the F1 terminating donor CU of an IAB node (e.g. a mobile IAB node) to be informed of migration of the MT of the IAB node between IAB nodes in the IAB topology controlled by a non-F1 terminating donor CU or RRC terminating donor-CU of the IAB node (e.g. a consecutive MT migration of the IAB node where the MT migration is a new MT migration toward a new parent IAB node which is managed by a donor-CU that is different from the donor-CU serving the DU of the IAB node or which is at least connected to a different donor-DU (compared to the previous parent IAB node) which is managed by a donor-CU that is different from the donor-CU serving the DU of the IAB node or which is a new parent IAB node connected to the same donor-DU) and of at least one new routing path to be used to route data (e.g. user traffic and control traffic, F1 traffic) associated with the migrated IAB node in the IAB topology controlled by a non-F1 terminating donor CU (e.g. to be used for routing data to/from the migrated IAB node or between the migrated IAB node and the F1 terminating donor CU in the IAB topology controlled by a non-F1 terminating donor CU) will now be described. Although the following methods/apparatus will be described primarily with respect to a mobile IAB node, it will be appreciated that it is not intended that the invention is limited to mobile IAB nodes. The methods in accordance with one or more embodiments of the present invention may apply to stationary IAB nodes e.g. that are at the edge of one IAB topology and in the proximity of one or more IAB nodes in a neighbouring IAB topology. A non-F1 terminating donor CU or non-F1 donor CU is also known as a RRC terminating donor CU or RRC donor CU.

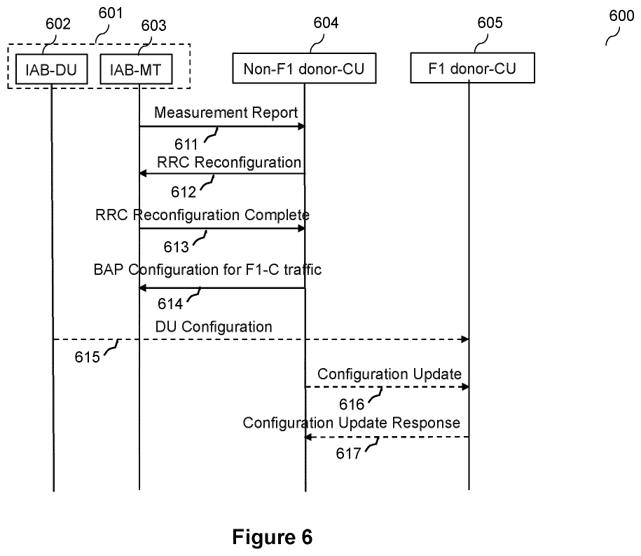

FIG. 6 is a schematic and simplified diagram 600 illustrating some example message flows, in accordance with one or more embodiments of the present invention, to support (multiple consecutive) MT migration(s) of an IAB-node in the IAB topology controlled by the non-F1 terminating donor-CU of the IAB-node. Multiple consecutive MT migrations involves multiple new MT migrations between different parent IAB nodes which may be managed by donor-CUs which are different to the donor-CU serving the DU of the IAB node or which are at least connected (directly or indirectly) to different donor-DUs which are managed by a different donor-CU to the donor-CU serving the DU of the IAB node or which are connected (directly or indirectly) to the same donor-DU.

This figure shows an IAB-node 601 that may be a mobile IAB-node like the IAB-node 570 of FIG. 5 and/or the IAB-node 123 of FIG. 1. When the IAB-node 601 is a mobile IAB-node, it comprises a Mobile Termination (MT) 603 (identified as IAB-MT), and a Distributed Unit (DU) 602 (identified as IAB-DU). The figure also shows a non-F1 terminating donor-CU (or non-F1 donor-CU) 604 terminating the RRC connection to the IAB-node 601 through the IAB-MT 603, and a F1 terminating donor-CU (or F1 donor-CU) 605 terminating the F1 connection to the IAB-node 601 through the IAB-DU 602. As an example and with reference to the IAB communication system of FIG. 5, the F1 terminating donor CU 605 for the IAB-node is the donor-CU 501, the MT 571 of the IAB-node 570 has migrated to the IAB topology 5002 managed by donor-CU 502 and the non-F1 terminating donor CU 604 is the donor-CU 502.

At the beginning of the flow 600, it is assumed that the control path (F1-C) and user path (F1-U) setup by the F1 donor-CU 605 to reach the IAB-node 601, uses one or several backhaul path(s) through the IAB topology controlled by the non-F1 donor-CU 604 through a donor-DU not represented in the FIG. 6. For instance, with reference to FIG. 5, one such backhaul path may include the donor-DU 505 and the IAB-node 530.

Then, it is assumed that the non-F1 donor-CU 604 receiving a measurement report 611 from the IAB-node 601, initiates a MT migration of the IAB-node 601 as described above with reference to FIG. 5 in the case where the MT 571 of the IAB-node 570 is migrated from IAB-node 530 to a new parent IAB-node 550, with both IAB-nodes 530 and 550 belonging to the same IAB topology 5002 which is managed by a non-F1 terminating donor CU. In this example, the MT migration may be considered as a consecutive MT migration as the MT migration from parent IAB-node 530 to parent IAB-node 550 involves a migration between two different donor DUs (505, 506) which are managed by donor-CU 502 which is different to donor-CU 501 which manages the DU (DU 572) of the IAB-node 570. The intra-CU topology adaptation procedure is used as an example to further describe the flows 600 of FIG. 6.

The measurement report 611 is received by the non-F1 donor-CU 604 through the F1 message UL RRC MESSAGE TRANSFER (specified in TS 38.423) sent by the source parent IAB-node of the IAB-node 601 (for instance IAB-node 530 in the FIG. 5), which embeds the RRC message with the measurement report sent by the IAB-MT 603 to the DU part of the source parent IAB-node. The measurement report is the result of the measurements regularly performed by IAB-MT 603 on signals received from the serving cell and one or more target cells, such as the Signal Synchronization Block (SSB) transmitted in the serving cell and in the target cells. The target cells may be neighbouring cells to the serving or source cell (i.e. the current serving cell). Once the IAB-MT 603 discovers at least one SSB that meets predefined criteria (for instance a received power that exceeds a predefined threshold), a measurement report may be generated and transmitted to provide radio link quality information for different cells in the vicinity of the IAB-node 601. The identity of each target cell is included in the measurement report to allow the non-F1 donor-CU 604 to identify the target donor-CU associated with each target cell.

Based on the received measurement report, the non-F1 donor-CU 604 may detect that the IAB-node 601 receives radio signals in a target cell from a target parent IAB-node with a better quality than in the source serving cell. Taking the example of a target parent IAB-node (for instance IAB-node 550 in the FIG. 5) belonging to the same IAB topology as the source parent IAB-node (e.g. IAB-node 530), the non-F1 donor-CU 604 may decide to apply the intra-CU topology adaptation procedure for the IAB-node 601. Moreover, in the example, the target parent IAB-node involves a new donor DU to route packets (e.g. donor DU 506 instead of donor-DU 505 in the FIG. 5). Although in this example, the migration involves migrating the MT of the IAB-node 601 from a parent IAB-node 530 connected to donor-DU 505 to a new parent IAB-node 550 connected (albeit indirectly) to new donor-DU 506, it will be appreciated the following (e.g. the intra-CU topology adaptation procedure) may also be applied in the case where the migration involves migrating the MT of the IAB-node 601 from a parent IAB-node to a new parent IAB-node, where both the old and the new parent IAB-nodes are connected (directly or indirectly) to the same donor-DU. In this case, it is still helpful to inform the F1 donor-CU of such a migration because the F1-donor-CU may have to reconfigure the migrating IAB-node. F1 donor-CU can be informed by the non-F1 donor-CU with IAB transport migration modification procedure as discussed below.

After requesting to the target parent IAB-node (e.g. IAB-node 550) to create a UE context for the IAB-node 601 (procedure not represented in the FIG. 6 specified in TS 38.423 V17.2.0 section 8.2.4), the non-F1 donor-CU 604 sends a RRC Reconfiguration message 612 to the IAB-MT 603, through the F1 message UE CONTEXT MODIFICATION REQUEST sent to the source parent IAB-node, which will relay to the IAB-node 601 the RRC Reconfiguration information embedded in this F1 message. In particular, the RRC Reconfiguration message 612 contains the Transport Network Layer (TNL) address(es) (i.e. IP address(es)) identifying the target donor-DU for packets routing (e.g. data routing). In the example of the FIG. 5, the address(es) of the donor-DU 506 replace(s) the address(es) of the donor-DU 505.

After the IAB-node 601 performs a random-access procedure toward the target parent IAB-node (e.g. IAB-node 550), the IAB-node 601 sends a RRC Reconfiguration Complete message 613 to the non-F1 donor-CU 604 (via the target parent IAB-node and a F1 message UL RRC MESSAGE TRANSFER embedding the RRC Reconfiguration Complete information).

In case the intra-CU topological redundancy or the intra-CU backhaul RLF recovery procedure is used, the exchange of messages will be slightly different but in all cases the identification of the target donor-DU is provided to the IAB-node 601 through a message (e.g. a RRC Reconfiguration message) like the message 612.

The next part concerns the update of routing paths, such as the F1 paths (F1-C and F1-U), between the IAB-node 601 and the F1 donor-CU 605 through the target donor-DU.

The non-F1 donor-CU 604 configures BH RLC channels and BAP-sublayer routing entries (for backhaul links) on the target path between the target parent IAB-node (e.g. IAB-node 550) of the IAB-node 601 and the target IAB-donor-DU (e.g. donor-DU 506). The non-F1 donor-CU 604 may establish additional BH RLC channels to the migrating IAB-MT (e.g. for the backhaul link between the target parent IAB-node and the IAB-MT 603 of the IAB-node 601) via the RRC message 614.

As a first option to inform the F1 donor-CU 605 about path information associated with one or more routing paths (e.g. backhaul paths) to be used for routing data associated with the IAB node through the new parent IAB node, which path information may inform the F1 Donor-CU 605 of the target donor-DU, the DU part (IAB-DU 602) of the IAB-node 601 may send a DU Configuration message 615 to the F1 donor-CU 605. This message may be the F1 message gNB-DU CONFIGURATION UPDATE specified in TS 38.473 V17.2.0 section 9.2.1.7 including the identification of the target donor-DU for F1-C and F1-U traffic. This information is known by the IAB-node 601 since the reception of the message 612. The destination address of the message 615 is the F1 donor-CU 605, and when this IP packet is received by the target donor-DU, it can be routed in the wired backhaul (508 in the FIG. 5) up to the F1 donor-CU 605.

With the reception of the identification of the target donor-DU, the F1 donor-CU 605 can update its configuration (e.g. update routing paths associated with the IAB node based on the received information) to deliver F1 packets to the IAB-node 601 via the target donor-DU (e.g. donor-DU 506). Then the path for the F1 control data (F1-C) is updated.

To complete the update of the path for F1 user data (F1-U), the F1 donor-CU 605 may initiate the IAB Transport Migration Management procedure specified in TS 38.423 V17.2.0 section 8.5.2, with protocol messages (not represented in the FIG. 6) exchanged between the F1 donor-CU 605 and the non-F1 donor-CU 604. The non-F1 donor-CU 604 may provide new configuration parameters (e.g. BH RLC channels) to be used by the IAB-node 601 to send user data packets in the IAB topology controlled by the non-F1 donor-CU 604. These configuration parameters may then be provided by the F1 donor-CU 605 to the IAB-node 601 through a F1 message (for instance using the BAP MAPPING CONFIGURATION message specified in TS 38.473 V17.2.0 section 9.2.9.1).

As a second option to inform the F1 donor-CU 605 about path information associated with one or more routing paths (e.g. backhaul paths) to be used for routing data associated with the IAB node through the new parent IAB node, which path information may inform the F1 Donor-CU 605 of the address(es) of the target donor-DU (e.g. which represent one or more new paths to be used for routing data for the migrated mobile IAB-node 601), the non-F1 donor-CU 604 may provide this information by initiating a procedure represented with the messages Configuration Update 616 and Configuration Update Response 617. The message 616 sent by the non-F1 donor-CU 604 may include the identification of the target donor-DU, and the message 617 may be an acknowledgment from the F1 donor-CU.

According to one example, the message 616 may be the IAB TRANSPORT MIGRATION MODIFICATION REQUEST message, and the message 617 may the IAB TRANSPORT MIGRATION MODIFICATION RESPONSE, both specified in TS 38.423 V17.2.0 (Xn protocol) sections 9.1.4.4 and 9.1.4.5, and used in the IAB Transport Migration Modification procedure. Thus, at the same time, the non-F1 donor-CU 604 may provide, in the message 616, new configuration parameters (e.g. BH RLC channels) to be used by the IAB-node 601 to send user data packets in the IAB topology controlled by the non-F1 donor-CU 604. According to this example, the F1 donor-CU receives in a single message all the necessary information to update the F1 paths with the IAB-node 601 compared to option 1 described above where after receiving the DU configuration message 615, the F1 donor-CU 605 initiates the IAB Transport Migration Management procedure to update the path for F1 user data.

According to another example, the message 616 may be the NG-RAN NODE CONFIGURATION UPDATE message, and the message 617 may the NG-RAN NODE CONFIGURATION UPDATE ACKNOWLEDGE, both specified in TS 38.423 V17.2.0 (Xn protocol) sections 9.1.3.4 and 9.1.3.5. After this NG-RAN node Configuration Update procedure and to complete the F1 paths setup, the F1 donor-CU 605 may execute, for instance, an IAB Transport Migration Management procedure. Described in TS 38.423 V17.2.0 section 8.5.2. With this procedure, the F1 donor-CU 605 requests and gets from the non-F1 donor-CU 604 the information related to the F1 paths (e.g. the BH RLC channels) to be configure in the IAB-node 601. Instead of the IAB Transport Migration Management procedure, the non-F1 donor-CU 604 may initiate, for the same purpose (i.e. to complete the F1 paths setup after the NG-RAN node Configuration Update procedure), the IAB Transport Migration Modification procedure described in TS 38.423 V17.2.0 section 8.5.3.

In order for the F1 donor-CU 605 to be able to identify the migrating IAB-node 601 associated with a message received at the F1 donor-CU 605, which message indicates an IAB-node has migrated within the IAB topology managed by the non-F1 donor-CU 604 and one or more new routing/backhaul paths are to be used for routing data associated with the migrating IAB-node, the message sent to the F1 donor-CU 605 includes one or more identifiers of the migrating IAB-node. For example, in those procedures (NG-RAN node Configuration Update, IAB Transport Migration Management and IAB Transport Migration Modification), the identifiers of the IAB-node 601 is present in all the messages with one or more of the information elements F1-Terminating IAB-donor UE XnAP ID and non-F1-Terminating IAB-donor UE XnAP ID or RRC-Terminating IAB-donor UE XnAP ID, both defined at the first MT migration of the IAB-node 601. As specified in TS 38.423 section 9.2.3.16, the NG-RAN node UE XnAP ID uniquely identifies a UE over the Xn interface within the NG-RAN node. Thus, each donor-CU assigns a value to each IAB node in its IAB topology (as the IAB-MT is considered as a UE). The F1 donor-CU 605 will have assigned an ID to IAB-node 601 when it was admitted in its IAB topology. At MT migration the non-F1 donor-CU 604 will assign another ID to IAB node 601. Both IDs are exchanged in handover request/acknowledge messages. Another identifier of the IAB-node 601 is the BAP address assigned to the IAB-node. Each IAB-donor-CU that terminates a RRC connection with an IAB-node assigns a BAP address to this IAB-node (to use it as the destination BAP address for the BAP packets to be routed to this IAB-node in the IAB topology controlled by this IAB-donor-CU). The F1 donor-CU 605 may have assigned a BAP address to IAB-node 601 if it was admitted in its IAB topology. At MT migration the non-F1 donor-CU or RRC donor-CU 604 will assign another BAP address to IAB node 601.

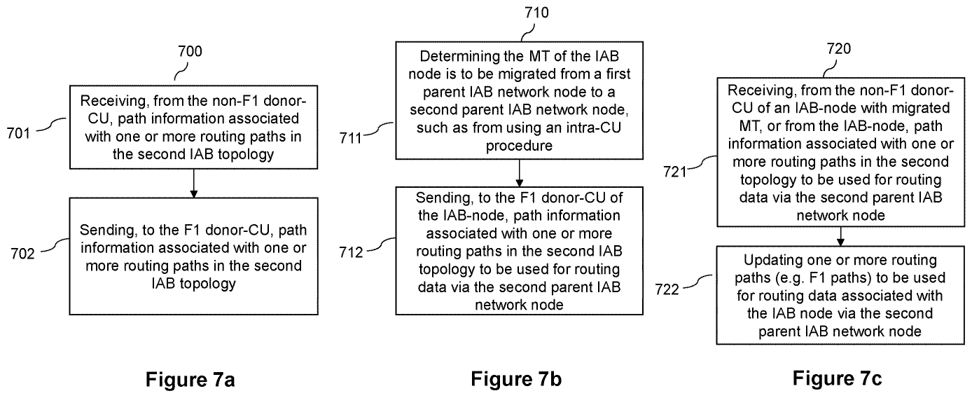

FIGS. 7a-7c are flowcharts showing example methods in accordance with one or more embodiments of the invention that are performed at different network nodes in a wireless communication system (such as communication system shown and described with reference to FIG. 1 and IAB communication system shown and described with reference to FIG. 5). Briefly, a method for use in a migration process (or for use in part of a migration process) in which a MT of an IAB node (such as a mobile IAB node) is migrated (e.g. is migrated consecutively) in a second IAB topology from a first parent IAB network node (such as a source IAB network node) to a second parent IAB network node (such as a target IAB network node), where the IAB node is managed (or controlled or served) by a first IAB donor CU (e.g. the F1 terminating donor CU of the IAB node with which the IAB node retains a F1 connection) of a first IAB topology and the first and second parent IAB network nodes are managed (or controlled or served) by a second IAB donor CU (e.g. a non-F1 terminating donor CU or RRC terminating donor CU of the IAB node with which the IAB node has a RRC connection) of the second IAB topology is disclosed. The method comprises sending, to the first IAB donor CU, path information associated with one or more routing paths in the second topology to be used for routing data associated with the IAB node (e.g. data to be routed to and from the IAB node) via or through the second parent IAB network node. The first parent IAB network node is associated with a first IAB donor Distributed Unit, DU, and the second parent IAB network node is associated with a second IAB donor DU, the first and second IAB donor DUs being connected to the second IAB donor CU. The first parent IAB network node is one of an IAB node of the second IAB topology or the first IAB donor DU and the second parent IAB network node is one of an IAB node of the second IAB topology or the second IAB donor DU. The path information sent to the F1 terminating donor CU can be used to inform the F1 terminating donor CU of the one or more routing paths in a different topology to be used for routing data (e.g. F1 data, including user traffic, control traffic) to/from the IAB node, which one or more routing paths are new routing paths as they include a new parent IAB network node. In the case where the migration between parent IAB network nodes involves a new donor-DU (e.g. when the new parent IAB network node is either a new IAB donor DU or a parent IAB node connected (directly or indirectly) to a new IAB donor DU, the one or more routing paths are for routing data associated with the IAB node through the new IAB donor DU.

The information associated with one or more routing paths may be or may include one or more addresses or address information (such as IP address(es), TNL address(es)) associated with the second or new IAB donor DU. An IAB TNL address is specified in TS 38.423 section 9.2.2.92: it indicates an IPV4 or IPv6 address or an IPv6 address prefix assigned to an IAB-node. There may be one or several IP address for F1-C traffic and one or several address for F1-U traffic (see TS 38.331 section 5.3.5.12a.1.2, IP Address Addition/Modification). In an example, identification information including at least one identifier of the IAB node may be sent. Such identifiers may include the identifiers known to the F1 terminating donor CU and/or the non-F1 terminating donor CU of the IAB node: for example, the message may include one or more of the information elements F1-Terminating IAB-donor UE XnAP ID and non-F1-Terminating IAB-donor UE XnAP ID or RRC-Terminating IAB-donor UE XnAP ID and BAP address(es) assigned to the IAB node (e.g. the BAP address assigned by the non-F1/RRC terminating donor CU(s)). The path information and identification information may be sent by the IAB node (e.g. as described below in more detail with reference to FIG. 7a) or by the second IAB donor CU (e.g. the non-F1 terminating donor CU of the mobile IAB node) (e.g. as described below in more detail with reference to FIG. 7b). The second IAB donor CU (e.g. the non-F1 terminating donor CU of the mobile IAB node) may also send configuration information including configuration parameters, such as one or more of BH RLC channel information and BAP-sublayer routing information, for each backhaul link in the one or more routing paths. The path information and the configuration information may be sent by the second IAB donor CU (e.g. the non-F1 terminating donor CU of the mobile IAB node) in the same message.

Although the following methods/apparatus will be described primarily with respect to a mobile IAB node, it will be appreciated that it is not intended that the invention is limited to mobile IAB nodes. The methods in accordance with one or more embodiments of the present invention may apply to stationary IAB nodes e.g. that are at the edge of one IAB topology and in the proximity of one or more IAB nodes in a neighbouring IAB topology.

Thus, by means of the information (e.g. address(es) of the target donor DU associated with the new parent IAB network node to which the IAB node is to be or has already migrated) sent to the first IAB donor CU (F1 terminating donor CU) of the IAB node by the second IAB donor CU (non-F1 terminating donor CU) or by the IAB node, the F1 terminating donor CU can be informed of migration of the MT of an IAB node between parent IAB network nodes in the IAB topology controlled by a non-F1 terminating donor CU of the IAB node (e.g. consecutive MT migration of the IAB node) and of at least one new routing path to be used to route data (e.g. F1 data, user traffic or control traffic) for the migrated IAB node in the IAB topology controlled by a non-F1 terminating donor CU (e.g. for routing data to/from the migrated IAB node or between the migrated IAB node and the F1 terminating donor CU in the IAB topology controlled by a non-F1 terminating donor CU). The F1 terminating donor CU may then update configuration information for the IAB node based on the received information so as to update routing paths (e.g. the F1-C and F1-U routing paths) for the IAB-node to the new routing paths for routing data to/from the IAB node via or through the target donor DU.

FIG. 7a is a flowchart showing an example method 700, in accordance with one or more embodiments of the invention, performed at an IAB node (e.g. a mobile IAB node or mIAB node) for use in a migration process (or for use in part of a migration process) in which a MT of the IAB node is migrated (e.g. is migrated consecutively) in a second IAB topology which is different to a first IAB topology to which the IAB node belongs. Method 700 is for managing, at an IAB-node, consecutive MT migration in the IAB topology controlled by its non-F1 terminating donor-CU. For example, with reference to the IAB communication system shown in and described with respect to FIG. 5, the IAB node performing the method 700 may be the mobile IAB-node 570 belonging to IAB topology 5001 controlled by the IAB donor CU 501 (e.g. a F1 terminating donor CU of the mobile IAB node 570 with which the mobile IAB node 570 retains a F1 connection). The migration process may involve the migration of the MT 571 of the mIAB node 570 from parent IAB node 530 associated with IAB donor DU 505 to parent IAB node 550 associated with IAB donor DU 506 (when the routing path for the mobile IAB node 570 switches from a routing path including the parent IAB node 530 and IAB donor DU 505 to a routing path including the parent IAB node 550, IAB node 540 and IAB donor DU 506) in the IAB topology 5002 controlled by the IAB donor CU 502 (e.g. a non-F1 terminating donor CU of the mobile IAB node 570 with which the mobile IAB node 570 has a RRC connection). The method 700 as shown in and described with respect to FIG. 7a may be performed by software elements and/or hardware elements. The IAB node may be implemented in a communication device 400 as shown in and described with reference to FIG. 4 with the method as shown in and described with respect to FIG. 7a being performed by one or more processing units, such as the central processing unit 411.

As part of the migration process where the MT of an IAB-node, such as the MT 571 of mobile IAB-node 570, which is controlled by a F1 terminating donor CU, such as the IAB donor CU 501 of IAB topology 5001, is migrated from one parent IAB network node associated with one IAB donor DU (e.g. source donor-DU) to another parent IAB network node associated with another IAB donor DU (e.g. target donor-DU) in the same IAB topology controlled by a non-F1 terminating donor-CU (e.g. from IAB donor DU 505 to IAB donor DU 506 in the IAB topology 5002 controlled by IAB donor-CU 502), at step 701, an IAB-node, like the IAB-node 570, may receive from its non-F1 terminating donor-CU, like the donor-CU 502, path information associated with the one or more routing paths in the second IAB topology to be used for routing data associated with the IAB node through the target parent IAB network node. The path information may include one or more address(es) of the target donor-DU (e.g. IP addresses), like the donor-DU 506, in the IAB topology controlled by the non-F1 donor-CU. For example, the IAB-node may receive the address(es) of the target donor-DU in a message such as message 612 as described above.

At step 702, the IAB-node 570 sends path information associated with one or more routing paths to be used for routing data associated with or for the mobile IAB node 570 (e.g. for routing data to and from the mobile IAB node) via the target IAB donor DU (e.g. IAB donor DU 506). The path information may be sent after the MT of the IAB node 570 has migrated. The path information associated with one or more routing paths may be or may include address information such as one or more addresses (such as IP address(es), TNL address(es)) associated with the second IAB donor DU (e.g. the target donor DU). In an example, the IAB-node 570 may further send identification information including an identifier(s) of the mobile IAB node known by the two IAB donor-CUs 501, 502: for example, the message may include one or more of the information elements F1-Terminating IAB-donor UE XnAP ID and non-F1-Terminating IAB-donor UE XnAP ID or RRC-Terminating IAB-donor UE XnAP ID and BAP address(es) assigned to the IAB node. The IAB node 570 may send the received path information (e.g. received address(es) of the target donor-DU) to its F1 terminating donor-CU, like donor-CU 501, controlling another IAB topology 5001 to that of the IAB topology 5002 controlled by the donor-CU 502. For example, the IAB-node 570 may send the received address(es) of the target donor-DU in a message such as DU configuration message 615 as described above.

FIG. 7b is a flowchart showing an example method 710, in accordance with one or more embodiments of the invention, performed at a second IAB donor CU (e.g. the non-F1 terminating donor-CU of an IAB-node) for use in a migration process (or for use in part of a migration process) for a MT of an IAB node (e.g. a mobile IAB node or mIAB node). Method 710 is for managing, at the non-F1 terminating donor-CU of an IAB-node, the consecutive MT migration of the IAB-node. For example, with reference to the IAB communication system shown in and described with respect to FIG. 5, the second IAB donor CU performing the method 710 may be the IAB donor CU 502 (e.g. a non-F1 terminating donor CU of the IAB node 570 with which the IAB node 570 has a RRC connection). The IAB node may be mobile IAB-node 570 belonging to IAB topology 5001 controlled by the IAB donor CU 501 (e.g. a F1 terminating donor CU of the mobile IAB node 570 with which the mobile IAB node 570 retains a F1 connection). The migration process may involve the migration of the MT 571 of the mIAB node 570 from parent IAB node 530 associated with IAB donor DU 505 to parent IAB node 550 associated with IAB donor DU 506 in the IAB topology 5002 controlled by the IAB donor CU 502. The method 710 as shown in and described with respect to FIG. 7b may be performed by software elements and/or hardware elements. The non-F1 terminating IAB donor CU may be implemented in a communication device 400 as shown in and described with reference to FIG. 4 with the method as shown in and described with respect to FIG. 7b being performed by one or more processing units, such as the central processing unit 411.

At step 711, a non-F1 terminating donor-CU, like the donor-CU 502, of an IAB-node, like the IAB-node 570, determines the MT of an IAB-node, such as the MT 571 of mobile IAB-node 570, which is controlled by a F1 terminating donor CU, such as the IAB donor CU 501 of IAB topology 5001, is to be migrated from a first parent IAB network node to a second parent IAB network node in the same IAB topology controlled by a non-F1 terminating donor-CU (e.g. the migration involves a change from IAB donor DU 505 to IAB donor DU 506 in the IAB topology 5002 controlled by IAB donor-CU 502). The first parent IAB network node is associated with an IAB donor DU (e.g. source donor-DU) and the first parent IAB network node may be the source donor-DU or another IAB node. The second parent IAB network node is associated with a second IAB donor DU (e.g. target donor-DU) and the second parent IAB network node may be the target donor-DU or another IAB node. For example, a non-F1 terminating donor-CU, like the donor-CU 502, determines that the execution of an intra-CU procedure leads to the identification of a target donor-DU to route the packets to or from the IAB-node 570 in the IAB topology controlled by the non-F1 terminating donor-CU 502. The intra-CU procedure may be an intra-CU topology adaptation procedure, or an intra-CU topological redundancy procedure, or intra-CU backhaul RLF recovery procedure for the IAB-node as discussed above.

At step 712, the non-F1 terminating donor-CU 502 sends to the F1 terminating donor-CU 501 of the IAB-node 570 controlling another IAB topology, path information associated with one or more routing paths to be used for routing data associated with or for the IAB node 570 via the second IAB donor DU 506 (e.g. for routing data to and from the IAB node 570 via the second IAB donor DU 506). The path information associated with one or more routing paths may be or may include address information such as one or more addresses (such as IP address(es), TNL address(es)) associated with the second IAB donor DU (e.g. the target donor DU). In an example, the non-F1 terminating donor-CU 502 may send identification information including an identifier(s) of the mobile IAB node known by the two IAB donor-CUs 501, 502: for example, the message may include one or more of the information elements F1-Terminating IAB-donor UE XnAP ID and non-F1-Terminating IAB-donor UE XnAP ID or RRC-Terminating IAB-donor UE XnAP ID and BAP address(es) assigned to the IAB node. The non-F1 terminating donor-CU 502 may therefore send to the F1 terminating donor-CU 501 of the IAB-node 570 the address(es) of the target donor-DU along with the identifiers of the IAB-node known by the two donor-CUs. For example, the non-F1 terminating donor-CU 502 may send the received address(es) of the target donor-DU in a message such as message 616 described above. Configuration information including configuration parameters, such as one or more of BH RLC channel information and BAP-sublayer routing information, for each backhaul link in the one or more routing paths may also be sent by the non-F1 terminating donor-CU. The configuration information may be sent in the same message as the received address(es) as discussed above.

FIG. 7c is a flowchart showing an example method 720, in accordance with one or more embodiments of the invention, performed at a first donor CU (e.g. the F1 terminating donor-CU of an IAB-node) for use in a migration process (or for use in part of a migration process) for a MT of an IAB node. Method 710 is for managing, at the F1 terminating donor-CU of an IAB-node, the consecutive MT migration of the IAB-node in the IAB topology of the non-F1 terminating donor-CU of the IAB-node. For example, with reference to the IAB communication system shown in and described with respect to FIG. 5, the first IAB donor CU performing the method 720 may be the IAB donor CU 501 (e.g a F1 terminating donor CU of the IAB node 570 with which the IAB node 570 retains a F1 connection). The IAB node may be mobile IAB-node 570 belonging to IAB topology 5001 controlled by the IAB donor CU 501. The migration process may involve the migration of the MT 571 of the mIAB node 570 from parent IAB node 530 associated with IAB donor DU 505 to parent IAB node 550 associated with IAB donor DU 506 in the IAB topology 5002 controlled by the IAB donor CU 502 (e.g. a non-F1 terminating donor CU of the mobile IAB node 570 with which the mobile IAB node 570 has a RRC connection). The method 720 as shown in and described with respect to FIG. 7c may be performed by software elements and/or hardware elements. The F1 terminating IAB donor CU may be implemented in a communication device 400 as shown in and described with reference to FIG. 4 with the method as shown in and described with respect to FIG. 7c being performed by one or more processing units, such as the central processing unit 411.

As part of the migration process where the MT of an IAB-node, such as the MT 571 of mobile IAB-node 570, which is controlled by a F1 terminating donor CU, such as the IAB donor CU 501 of IAB topology 5001, is migrated from one parent IAB network node associated with one IAB donor DU (e.g. source donor-DU) to another parent IAB network node associated with another IAB donor DU (e.g. target donor-DU) in the same IAB topology controlled by a non-F1 terminating donor-CU (e.g. from IAB donor DU 505 to IAB donor DU 506 in the IAB topology 5002 controlled by IAB donor-CU 502), at step 721, the F1 terminating donor-CU, like the IAB-donor-CU 501, receives path information associated with one or more routing paths to be used for routing data associated with or for the mobile IAB node 570 (e.g. for routing data to and from the mobile IAB node) via or through the target IAB donor DU (e.g. IAB donor DU 506). The path information may be received from the non-F1 terminating donor-CU 502 of the IAB-node 570 or may be received from the IAB-node 570. The path information may be received after the MT of the IAB node 570 has migrated. The path information associated with one or more routing paths may be or may include address information, such as one or more addresses (such as IP address(es), TNL address(es)) associated with the second IAB donor DU (e.g. the target donor DU). In an example, the F1 terminating donor CU may also receive identification information including an identifier(s) of the mobile IAB node known by the two IAB donor-CUs 501, 502: for example, the message may include one or more of the information elements F1-Terminating IAB-donor UE XnAP ID and non-F1-Terminating IAB-donor UE XnAP ID or RRC-Terminating IAB-donor UE XnAP ID and BAP address(es) assigned to the IAB node. For example, the F1 terminating donor-CU, like the IAB-donor-CU 501, receives, from the non-F1 terminating donor-CU 502 of an IAB-node with its MT part already migrated in the IAB topology controlled by the non-F1 terminating donor-CU 502, the address(es) of a target donor-DU (e.g. target donor DU 506), along with the identifiers of the IAB-node known by the two donor-CUs (e.g. in a message such as message 616). Alternatively, the address(es) of the target donor-DU are received from the IAB-node (e.g. in a message such as message 615). When the message is received from the non-F1 terminating donor CU 502 of the mobile IAB node, the message may also include configuration parameters, such as one or more of BH RLC channel information and BAP-sublayer routing information, for each backhaul link in the one or more routing paths.

At step 722, the F1 terminating donor-CU 501 may update configuration information for the IAB-node 570 based on the received information so as to update routing paths (e.g. the F1-C and F1-U routing paths) associated with or for the IAB-node 570 to the new routing paths for routing data to/from the IAB node via the target donor-DU 506. For example, the F1 terminating donor-CU updates the F1 paths (control and user data paths) to reach the IAB-node through the target donor-DU in the IAB topology controlled by the non-F1 terminating donor-CU of the IAB-node. The F1 terminating donor-CU 501 may also send configuration information to the IAB-node 570 to configure the IAB-node based on the configuration parameters, such as one or more of BH RLC channel information and BAP-sublayer routing information, received from the non-F1 terminating donor-CU 502.

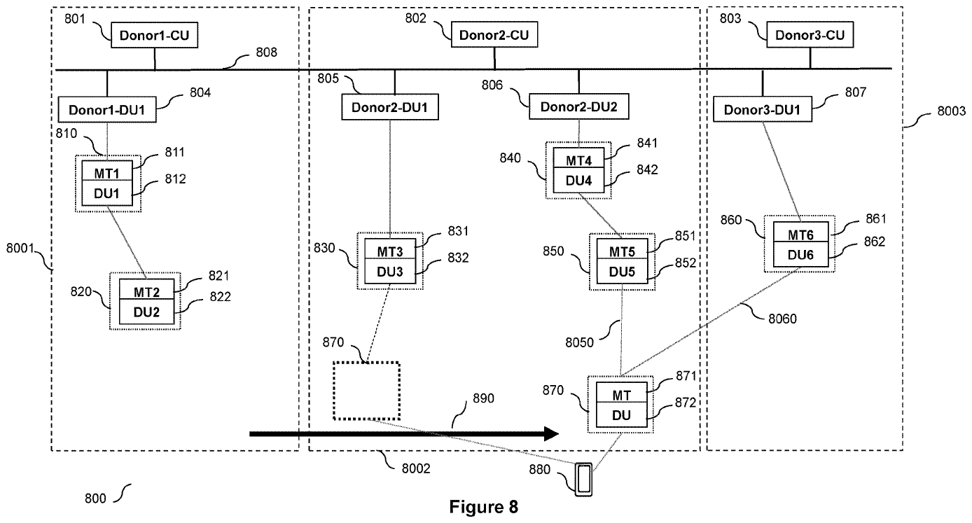

FIG. 8 illustrates an example of another IAB communication system (or IAB network system) 800 in which embodiments and examples of embodiments of the present invention may be implemented. In one example implementation, the BH radio links are operated over the millimeter wave frequency band (i.e. above 30 GHz), which is highly sensitive to radio channel disturbance. An IAB network will also be referred to as an IAB topology or topology and so in this application, the terms IAB network and IAB topology and topology will be used interchangeably.

IAB communication system 800 is composed of three IAB networks or IAB topologies 8001, 8002, and 8003 with each IAB topology comprising a set of IAB nodes (e.g. the set may comprise a plurality of IAB nodes or at least one IAB node) and an IAB-donor-CU for controlling or managing the plurality of IAB nodes. The set of IAB nodes may include one or more IAB-nodes, such as initiator IAB-nodes which generate BAP packets and also intermediate or relay IAB-nodes. Each of the IAB nodes communicate with at least one other IAB node over a wireless backhaul (BH) link. Although FIG. 8 shows three IAB topologies 8001, 8002, and 8003, the present invention is not limited to three IAB topologies and may be implemented in an IAB communication system comprising more than two IAB topologies with each topology comprising a set of IAB nodes and an IAB donor-CU as discussed above.

As discussed above, each IAB node comprises a Mobile Termination (MT) part or unit, controlled and configured by the IAB donor using RRC messaging as defined in 3GPP TS 38.331, and a Distributed Unit (DU) part, controlled and configured by the IAB donor using F1-AP messaging as defined in 3GPP TS 38.473. For example, IAB-node 810 comprises a MT part or unit 811 and a DU part 812. IAB-node 870 is a mobile IAB node and thus includes a mobile MT (MT) 871 and a mobile DU (DU) 872.

IAB topology 8001 includes IAB-donor-CU 801 (identified as Donor1-CU in FIG. 8), and its associated IAB-donor-DU 804 (identified as Donor1-DU1 in FIG. 8), and a plurality of IAB-nodes 810 and 820, similar to IAB-nodes 121 and 122.

IAB topology 8002 includes IAB-donor-CU 802 (identified as Donor2-CU in FIG. 8), its associated IAB-donor-DUs, IAB-donor-DU 805 (identified as Donor2-DU1 in FIG. 8) and IAB-donor-DU 806 (identified as Donor2-DU2 in FIG. 8), and a plurality of IAB-nodes 830, 840, 850, similar to IAB-nodes 121 and 122, and IAB-node 870, that may be similar to mobile IAB-node 123. All IAB-nodes can be access nodes serving UEs like the UE 880 served by the mobile IAB-node 870. The IAB topology 8002 is transparent for the UE 880 that connects to the donor-CU 802 through the DU part or unit DU 872 of the mobile IAB-node 870. Although FIG. 8 shows only one UE 880, it will be appreciated that there will be a plurality of UEs connected to the network nodes of the IAB communication system 800.

IAB topology 8003 includes IAB-donor-CU 803 (identified as Donor1-CU in FIG. 8), and its associated IAB-donor-DU 807 (identified as Donor1-DU1 in FIG. 8), and an IAB-node 860, similar to IAB-nodes 121 and 122.

A wired backhaul IP network interconnects the IAB-donor-CUs 801, 802, and 803, and the IAB-donor-DUs 804, 805, 806 and 807 through the wired backhaul 808. For instance, this wired backhaul 808 consists of optical fiber cables.

IAB-Donor-CU 801, IAB-Donor-DU 804 and IAB-nodes 810 and 820 are part of the same IAB network or IAB topology 8001, which is configured and managed or controlled by IAB-Donor-CU 801.

IAB-Donor-CU 802, IAB-Donor-DUs 805 and 806, and IAB-nodes 830, 840, 850 are part of the same IAB network or IAB topology 8002, which is configured and managed or controlled by IAB-Donor-CU 802.

IAB-Donor-CU 803, IAB-Donor-DU 807, and IAB-node 860 are part of the same IAB network or IAB topology 8003, which is configured and managed or controlled by IAB-Donor-CU 803.

It is assumed that the mobile IAB-node 870 had initially a single parent IAB-node 820, and that IAB-node 870 belongs to the IAB topology 8001 controlled by the IAB-Donor-CU 801. When moving, and in view of its proximity to IAB topology 8002, in particular to the IAB-node 830 when the mobile IAB-node 870 is in the position shown in dotted lines in FIG. 8, the mobile IAB-node 870 may be able to establish a wireless BH link with the IAB-node 830. Such a BH link is possible for a stationary IAB-node, and it is very likely to happen for a mobile IAB-node like IAB-node 870, moving, for instance, in the direction of the IAB topology 8002 (shown by arrow 890 in FIG. 8).

Then, the F1 donor-CU 801 may have decided to perform the migration of the MT part 871 of the IAB-node 870 toward the IAB topology controlled by the donor-CU 802, which became the non-F1 donor-CU for the IAB-node 870 (i.e. the MT part 871 of the IAB-node 870 is migrated toward the parent IAB-node 830). For this purpose, the F1 donor-CU 801 may have initiated the inter-CU Topology Adaptation procedure described in TS 38.401 V17.2.0 section 8.17.3.1 or section 8.17.3.2 (when the IAB-node 870 has descendant IAB-nodes). As a result, the IAB-node 801 still belongs to the IAB topology 8001, with its F1 connection to the donor-CU 801, but its RRC connection is now to the donor-CU2 802. After that procedure, the IAB-donor-CU 801 may request the migration toward the IAB topology 8002 (i.e. through the donor-DU 805) of the backhaul traffic related to the IAB-node 870. In this case, the donor-CU 801 triggers the IAB transport migration management procedure specified in TS 38.423 V17.2.0 section 8.5.2.

While the mobile IAB-node 870 is still moving, the MT part 871 of the IAB-node 870 may then have been migrated by the non-F1 donor-CU 802 toward the parent IAB-node 850, using the backhaul link 8050 between the IAB-node 850 and the IAB-node 870. For this purpose, the non-F1 donor-CU 802 may have applied the intra-CU topology adaptation procedure described in TS 38.401 V17.2.0 section 8.2.3.1 (or section 8.17.3.2), resulting in a consecutive MT migration of the IAB-node 870 with a new single parent IAB-node 850. Still, the IAB-node 801 has its F1 connection with the donor-CU 801 and its RRC connection with the donor-CU2 802.

After being informed to use the donor-DU 506 instead of donor-DU 505 to route the F1 traffic related to the IAB-node 870, the donor-CU 801 may request the migration of the traffic related to the IAB-node 570 toward the IAB topology 5002. In this case, the donor-CU 801 triggers the IAB transport migration management procedure specified in TS 38.423 V17.2.0 section 8.5.2.

While further moving, this time in the direction of IAB topology 8003 controlled by the donor-CU 803, the IAB-node 870 may become in a position where a backhaul link 8060 with the IAB-node 860 may have a better quality than the backhaul link 8050 with the IAB-node 850. Thus, the donor-CU 802 may apply the inter-CU Topology Adaptation procedure described in TS 38.401 V17.2.0 section 8.17.3.1 or 8.17.3.2. After this consecutive MT migration, the IAB-node 801 still belongs to the IAB topology 8001, with its F1 connection with the donor-CU 801, but its RRC connection with the donor-CU3 803. However, the donor-CU 801 has to be informed of the new non-F1 donor-CU 803 for the IAB-node 870 and of the new donor-DU 807 to redirect the offloaded traffic (control and user traffic) through the donor-DU 807 instead of donor-DU 806.

In all the MT migration cases described above, the UE 880 still connects to the donor-CU 801 through the DU part or unit DU 872 of the mobile IAB-node 870. In case the IAB-node 870 has some child IAB-node(s), such child IAB-node still belongs to the IAB topology 8001, and it is still fully controlled (through F1 and RRC connections) by the donor-CU 801.

Examples of methods, in accordance with one or more embodiments of the present invention, which enable the F1 terminating donor CU of an IAB node to be informed of migration of the MT of the IAB node between one IAB topology (source topology) controlled by a non-F1 terminating donor CU or RRC terminating donor CU of the IAB node to another IAB topology (target topology) controlled by another non-F1 terminating donor CU or RRC terminating donor CU of the IAB node (e.g. consecutive MT migration of the IAB node between non-F1 terminating topologies) and of at least one new routing path to be used to route data (e.g. F1 traffic, user traffic and control traffic) associated with or for the migrated IAB node in the target IAB topology (e.g. to be used for routing data to/from the migrated IAB node or between the migrated IAB node and the F1 terminating donor CU in the IAB topology controlled by a non-F1 terminating donor CU) will now be described. Although the following methods/apparatus will be described primarily with respect to a mobile IAB node, it will be appreciated that it is not intended that the invention is limited to mobile IAB nodes. The methods in accordance with one or more embodiments of the present invention may apply to stationary IAB nodes e.g. that are at the edge of one IAB topology and in the proximity of one or more IAB nodes in a neighbouring IAB topology.

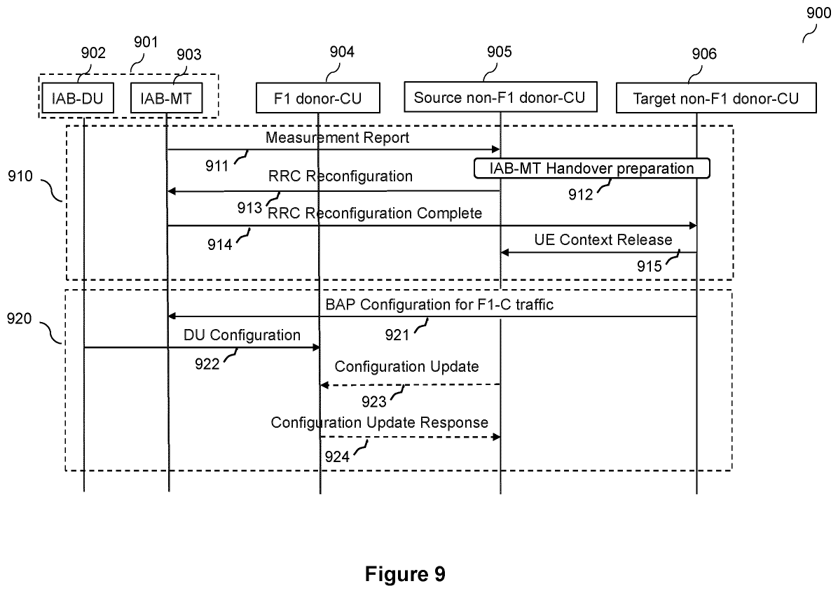

FIG. 9 is a schematic and simplified diagram 900 illustrating some example message flows according to one or more embodiments of the invention, to perform a consecutive MT migration of an IAB-node toward a target IAB topology, including the setup of the control data path. Consecutive MT migration may involve a new MT migration between different parent IAB nodes which are managed by different donor-CUs which are different to the donor-CU serving the DU of the IAB node.

This figure shows an IAB-node 901 that may be a mobile IAB-node like the IAB-node 870 of FIG. 8 and/or the IAB-node 123 of FIG. 1, composed of a Mobile Termination (MT) 903 (identified as IAB-MT), and of a Distributed Unit (DU) 902 (identified as IAB-DU). The figure also shows a source non-F1 terminating donor-CU (or non-F1 donor-CU) 905 terminating the RRC connection to the IAB-node 901 through the IAB-MT 903, a F1 terminating donor-CU (or F1 donor-CU) 904 terminating the F1 connection to the IAB-node 901 through the IAB-DU 902, and a target non-F1 donor-CU 906 that becomes, during the described procedure, the new non-F1 terminating donor-CU for the IAB-node 901. As an example and with reference to the IAB communication system of FIG. 8, the F1 terminating donor CU 904 for the IAB-node is the donor-CU 801, the MT 871 of the IAB-node 870 has migrated to the IAB topology 8002 managed by donor-CU 802 and so the source non-F1 terminating donor CU 905 is the donor-CU 802. As the IAB-node moves towards the IAB topology 8003, the IAB node 860 is identified as a target IAB node to which the MT of IAB node 870 can be migrated and so the target non-F1 terminating donor CU 906 is the donor-CU 803.

At the beginning of the flow 900, it is assumed that the control path (F1-C) and user path (F1-U) setup by the F1 donor-CU 904 to reach the IAB-node 901, uses one or several backhaul path(s) through the IAB topology controlled by the source non-F1 donor-CU 905 through a donor-DU not represented in the FIG. 9. For instance, with reference to FIG. 8, one such backhaul path may include the donor-DU 806 and the IAB nodes 840 and 850.

The first part of the flowchart describes the procedure 910 to migrate the IAB-MT 903 from the source non-F1 donor-CU 905 to the target non-F1 donor-CU 906, and the setup of the new path for RRC protocol messages.

Indeed, it is assumed that the source non-F1 donor-CU 905 receiving a measurement report 911 from the IAB-node 901, initiates a consecutive MT migration of the IAB-node 901 to another IAB topology as described above with reference to FIG. 8 in the case where the MT 871 (903) of the IAB-node 870 (901) is migrated from the parent IAB-node 850 of IAB topology 8002 to a new parent IAB-node 860 of the different IAB topology 8003. The inter-CU topology adaptation procedure is used as an example to further describe the flows 900 of FIG. 9.

The measurement report 911 is received by the source non-F1 donor-CU 905 through the F1 message UL RRC MESSAGE TRANSFER (specified in TS 38.423) sent by the source parent IAB-node of the IAB-node 901 (for instance parent IAB-node 850 in the FIG. 8), which embeds the RRC message with the measurement report sent by the IAB-MT 903 to the DU part of the source parent IAB-node. The measurement report is the result of the measurements regularly performed by IAB-MT 903 on signals received from the serving cell and one or more target cells, such as the Signal Synchronization Block (SSB) transmitted in the serving cell and in the target cells. The target cells may be neighbouring cells to the serving or source cell (i.e. the current serving cell). Once the IAB-MT 903 discovers at least one SSB that meets predefined criteria (for instance a received power that exceeds a predefined threshold), a measurement report may be generated and transmitted to provide radio link quality information for different cells in the vicinity of the IAB-node 901. The identity of each cell is included in the measurement report to allow the non-F1 donor-CU 905 to identify the target CU associated with the cell. Indeed, the identification of a donor-CU can be deduced from the Physical Cell identity (PCI) broadcasted in each cell managed by this donor-CU in a synchronization signal, and/or from the New Radio Cell Group Identifier (NCGI) also broadcasted in each cell managed by this donor-CU in a System Information Block (SIB) message. The PCI and/or the NCGI may be reported by the IAB-node 901 in the measurement report 911.

Based on the received measurement report, the source non-F1 donor-CU 905 may detect that the IAB-node 901 receives radio signals in a target cell of a target parent IAB-node with a better quality than in the source serving cell. Taking the example of a target parent IAB-node (for instance IAB-node 860 in the FIG. 8) belonging to a different IAB topology as the source parent IAB-node (e.g. parent IAB-node 850), the source non-F1 donor-CU 905 may decide to apply the inter-CU topology adaptation procedure for the IAB-node 901. The target parent IAB-node in the target IAB topology involves a new donor DU to route packets (e.g. donor DU 807 instead of donor-DU 806 in the FIG. 8). The target parent IAB-node may be an IAB-node or an IAB donor DU.

The IAB-MT 903 migration is triggered by the handover preparation procedure 912 described in TS 38.423 V17.2.0 section 8.2.1, where the source non-F1 donor-CU 905 sends a HANDOVER REQUEST message to the target non-F1 donor-CU 906 including the necessary information related to the IAB-MT 903 so that handover can be performed. For instance, the message includes the identification of the target cell where the IAB-node 901 will switch to, and thus it identifies the target parent IAB-node that controls the target cell. After requesting to the target parent IAB-node a UE context setup for the IAB-node 901, the target non-F1 donor-CU 906 performs admission control and provides the new RRC configuration information to the source non-F1 donor-CU 905 with the HANDOVER REQUEST ACKNOWLEDGE message. The individual steps of the handover preparation procedure are not shown in FIG. 9 which for simplicity shows box 912 representing the IAB-MT handover preparation.

Then, the source non-F1 donor-CU 905 can relay the RRC configuration information to the IAB-MT 903 through the message RRC Reconfiguration 913. Actually, the message 913 is first embedded in the F1 message UE CONTEXT MODIFICATION REQUEST, specified in TS 38.473, and sent by the source non-F1 donor-CU 905 to the source parent IAB-node of the IAB-node 901. Then this source parent IAB sends the RRC Reconfiguration message 913 to the IAB-MT 903. In particular, the RRC Reconfiguration message 913 contains address information, such as the Transport Network Layer (TNL) address(es) (i.e. IP address(es)) identifying the target donor-DU for packets routing (e.g. data routing). In the example of the FIG. 8, the address(es) of the donor-DU 807 replace(s) the address(es) of the donor-DU 806.

After the IAB-node 901 performs a random-access procedure toward the target parent IAB node (e.g. IAB-node 860 in FIG. 8), the IAB-node 901 sends a RRC Reconfiguration Complete message 914 to the target non-F1 donor-CU 906 (via the target parent IAB-node and a F1 message UL RRC MESSAGE TRANSFER embedding the RRC Reconfiguration Complete information).

The procedure 910 ends with the Xn message UE CONTEXT RELEASE 915, specified in TS 38.423, sent by the target non-F1 donor-CU 906 to the source non-F1 donor-CU 905. However, the identifiers of the IAB-node 901 at the F1 donor-CU 904 and at the source non-F1 donor-CU 905 are retained by the source non-F1 donor-CU 905 as F1 paths for the IAB-node 901 may still be used through the IAB topology controlled by the source non-F1 donor-CU 905.

The next part (messages 921 and 922) concerns the procedure 920 to update F1 paths (F1-C and F1-U) between the IAB-node 901 and the F1 donor-CU 905 through the target donor-DU in the IAB topology controlled by the target non-F1 donor-CU 906.

The target non-F1 donor-CU 906 configures BH RLC channels and BAP layer routing entries on the target path between the target parent IAB-node (e.g. IAB node 860 in FIG. 8) of the IAB-node 901 and the target IAB-donor-DU (e.g. IAB donor DU 807 in FIG. 8). The target non-F1 donor-CU 906 may establish additional BH RLC channels and BAP configurations to the migrating IAB-MT via RRC message 921.

Then, the DU part (IAB-DU 902) of the IAB-node 901 may send a DU Configuration message 922 to the F1 donor-CU 904. This message may be the F1 message gNB-DU CONFIGURATION UPDATE specified in TS 38.473 V17.2.0 section 9.2.1.7 including the identifier of the target non-F1 donor-CU 906 and the identification of the target donor-DU for F1-C and F1-U traffic. The PCI and/or the NCGI of the target cell managed by the target non-F1 donor-CU 906 may be reported by the IAB-node 901 to the F1 donor-CU 904, so that the F1 donor-CU 904 may derive the identifier of the target non-F1 donor-CU 906. The address(es), such as IP address(es), of the target donor-DU is known by the IAB-node 901 since the reception of the message 913. The destination address of the message 922 is the F1 donor-CU 904, and when this IP packet is received by the target donor-DU in the IAB topology controlled by the target non-F1 donor-CU 906, the IP packet can be routed in the wired backhaul (808 in the FIG. 8) up to the F1 donor-CU 904. With the reception of the identification of the target donor-DU, the F1 donor-CU 904 can update its configuration (e.g. update routing paths associated with the IAB node based on the received information) to deliver F1 packets to the IAB-node 901 via or through the target donor-DU (e.g. IAB donor DU 807) of the IAB topology 8003. Then the path for the F1 control data (F1-C) is updated.

As an alternative option to inform the F1 donor-CU 904 about the identifier of the target non-F1 donor-CU, the source non-F1 donor-CU 905 may provide this information by initiating a procedure represented with the messages Configuration Update 923 and Configuration Update Response 924. The message 923 sent by the source non-F1 donor-CU 904 may include the identifier of the target non-F1 donor-CU 906, and the message 924 may be an acknowledgment from the F1 donor-CU 904. The identifier of a donor-CU is specified in TS 38.423 V17.2.0 section 9.2.2.3 with the information element Global NG-RAN Node ID.

According to one example, the message 923 may be the IAB TRANSPORT MIGRATION MODIFICATION REQUEST message, and the message 924 may the IAB TRANSPORT MIGRATION MODIFICATION RESPONSE, both specified in TS 38.423 V17.2.0 (Xn protocol) sections 9.1.4.4 and 9.1.4.5, and which are messages used in the IAB Transport Migration Modification procedure. By using this procedure, the source non-F1 donor-CU 905 may also inform the F1 donor-CU 904 to release the traffic offloaded through the IAB topology controlled by the source non-F1 donor-CU 905.

According to another example, the message 923 may be the NG-RAN NODE CONFIGURATION UPDATE message, and the message 924 may the NG-RAN NODE CONFIGURATION UPDATE ACKNOWLEDGE, both specified in TS 38.423 V17.2.0 (Xn protocol) sections 9.1.3.4 and 9.1.3.5, and which are messages used in the NG-RAN node Configuration Update procedure.

In order for the F1 donor-CU 904 to be able to identify the migrating IAB-node 901 associated with a message received at the F1 donor-CU 904, which message indicates an IAB-node has migrated from the IAB topology managed by a source non-F1 donor-CU 905 to a target IAB topology managed by a target non-F1 donor-CU 906 (a new non-F1 donor CU) and one or more new paths are to be used for routing data for the migrating IAB-node through the topology of the target non-F1 donor-CU 906, the message sent to the F1 donor-CU 605 includes identifiers of the migrating IAB-node associated with each of the non-F1 donor CU controlled IAB topologies. For example, in those procedures (NG-RAN node Configuration Update, IAB Transport Migration Modification), the identifiers of the IAB-node 901 is present in all the messages with one or more of the information elements F1-Terminating IAB-donor UE XnAP ID and non-F1-Terminating IAB-donor UE XnAP ID or RRC-Terminating IAB-donor UE XnAP ID and BAP address(es) assigned to the IAB node (for example, a BAP address assigned to the IAB node by the source non-F1/RRC donor CU and/or a BAP address assigned to the IAB node by the target non-F1/RRC donor CU), defined at the first MT migration of the IAB-node 901 to a first non-F1 donor CU controlled IAB topology (at the F1 donor-CU 904 and the source non-F1 donor-CU 905). At the consecutive MT migration of the IAB-node 901 to a second non-F1 donor CU controlled IAB topology (the target IAB topology), the target non-F1 donor-CU 906 assigns an identifier to the IAB-node 901, which is shared with the source non-F1 donor-CU 905 in the HANDOVER REQUEST ACKNOWLEDGE message containing the Target NG-RAN node UE XnAP ID information element.

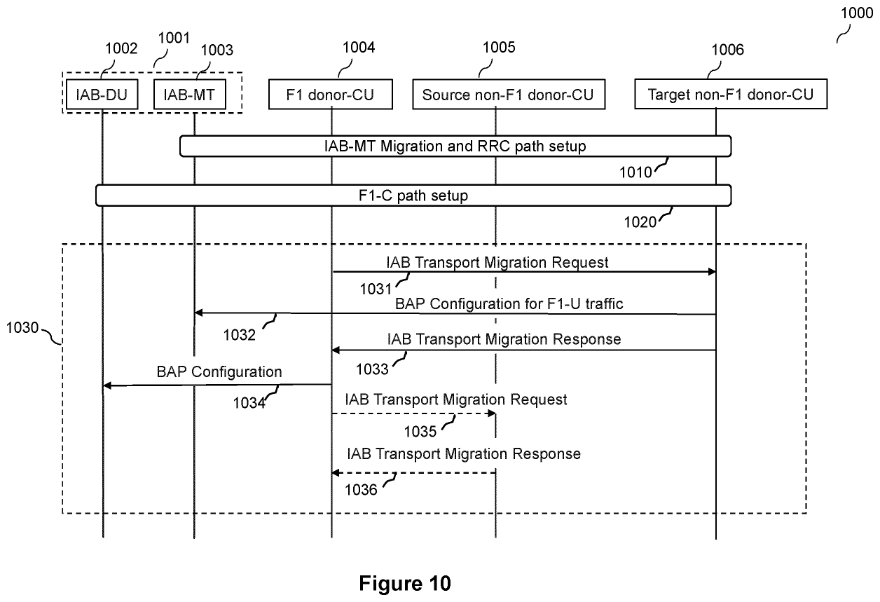

FIG. 10 is a schematic and simplified diagram 1000 illustrating some example message flows in accordance with one or more embodiments of the present invention, to setup the user data path for a consecutive MT migration of an IAB-node toward a target IAB topology. FIG. 10 shows the next step(s) following the procedures described with reference to FIG. 9 with the steps 910 and 920.

This figure shows an IAB-node 1001 that may be a mobile IAB-node like the IAB-node 870 of FIG. 8 and/or the IAB-node 123 of FIG. 1, composed of a Mobile Termination (MT) 1003 (identified as IAB-MT), and of a Distributed Unit (DU) 1002 (identified as IAB-DU). The figure also shows a source non-F1 terminating donor-CU (or non-F1 donor-CU) 1005 terminating the RRC connection to the IAB-node 1001 through the IAB-MT 1003, a F1 terminating donor-CU (or F1 donor-CU) 1004 terminating the F1 connection to the IAB-node 1001 through the IAB-DU 1002, and a target non-F1 donor-CU 1006 that becomes, during the described procedure, the new non-F1 terminating donor-CU for the IAB-node 1001. As an example and with reference to the IAB communication system of FIG. 8, the F1 terminating donor CU 1004 for the IAB-node is the donor-CU 801, the MT 871 of the IAB-node 870 has migrated to the IAB topology 8002 managed by donor-CU 802 and so the source non-F1 terminating donor CU 1005 is the donor-CU 802. As the IAB-node moves towards the IAB topology 8003, the IAB node 860 is identified as a target IAB node to which the MT of IAB node 870 can be migrated and so the target non-F1 terminating donor CU 1006 is the donor-CU 803.

At the beginning of the flow 1000, it is assumed that the control path (F1-C) and user path (F1-U) setup by the F1 donor-CU 1004 to reach the IAB-node 1001, uses one or several backhaul path(s) in the IAB topology controlled by the source non-F1 donor-CU 1005 through a donor-DU not represented in the FIG. 10. For instance, with reference to FIG. 8, one such backhaul path may include the donor-DU 806 and the IAB nodes 840 and 850.

A consecutive MT migration of the mobile IAB-node 1001 toward a target IAB topology is performed with the step 1010 corresponding to the step 910 of the FIG. 9. Then, the control data path is setup in the target topology with the step 1020 corresponding to the step 920 of the FIG. 9.

To complete the consecutive MT migration, the paths for F1 user data (F1-U) shall be updated with the procedure 1030. The F1 donor-CU 1004 may initiate the IAB Transport Migration Management procedure specified in TS 38.423 V17.2.0 section 8.5.2, with protocol messages directly exchanged between the F1 donor-CU 1004 and the target non-F1 donor-CU 1006, without the involvement of the source non-F1 donor-CU 1005. The F1 donor-CU 1004 sends to the target non-F1 donor-CU 1006 the message 1031 corresponding to the IAB TRANSPORT MIGRATION MODIFICATION REQUEST message specified in TS 38.423 V17.2.0 (Xn protocol) section 9.1.4.2, for the purpose of setting up the configuration of the user traffic to/from the IAB-node 1001 in the IAB topology controlled by the target non-F1 donor-CU 1006. According to this request, the target non-F1 donor-CU 1006 may configure or modify BH RLC channels and BAP layer routing entries on the target path between the IAB-node 1001 and the target IAB-donor-DU. In particular, the target non-F1 donor-CU 1006 may send the message 1032 to the IAB-node 1001 containing BAP configuration information. The message 1032 may be the RRC Reconfiguration message specified in TS 38.331. Then, the target non-F1 donor-CU 1006 responds to the F1 donor-CU 1004 with the message 1033 corresponding to the IAB TRANSPORT MIGRATION MANAGEMENT RESPONSE, specified in TS 38.423 V17.2.0 (Xn protocol) section 9.1.4.3, to provide new configuration parameters (e.g. BH RLC channels) to be used by the IAB-node 1001 to send user data packets in the IAB topology controlled by the target non-F1 donor-CU 1006. These configuration parameters may then be provided by the F1 donor-CU 1005 to the IAB-node 1001 through the message 1034 (for instance using the F1 message BAP MAPPING CONFIGURATION message specified in TS 38.473 V17.2.0 section 9.2.9.1).

Finally, and in case the source non-F1 donor-CU 1005 has not used the IAB Transport Migration Modification procedure to request the release of the traffic offloaded by the F1 donor-CU 1004 (i.e. with the messages 923 and 924 in the FIG. 9), the F1 donor-CU 1004 may initiate the IAB Transport Migration Management procedure with the messages 1035 and 1036. By using this procedure, the source non-F1 donor-CU 1005 may also inform the F1 donor-CU 1004 to release the traffic offloaded through the IAB topology controlled by the source non-F1 donor-CU 1005. The F1 donor-CU 1004 sends to the source non-F1 donor-CU 1005 the message 1035 corresponding to the IAB TRANSPORT MIGRATION MANAGEMENT REQUEST message specified in TS 38.423 V17.2.0 section 9.1.4.2, for the purpose of releasing the traffic to/from the IAB-node 1001 offloaded in the IAB topology controlled by the target non-F1 donor-CU 1006. Then, the source non-F1 donor-CU 1005 responds to the F1 donor-CU 1004 with the message 1036 corresponding to the IAB TRANSPORT MIGRATION MANAGEMENT RESPONSE, specified in TS 38.423 V17.2.0 (Xn protocol) section 9.1.4.3.

In the procedure IAB Transport Migration Management, the identifiers of the IAB-node 1001 is present in all the messages with one or more of the information elements F1-Terminating IAB-donor UE XnAP ID and non-F1-Terminating IAB-donor UE XnAP ID or RRC-Terminating IAB-donor UE XnAP ID and BAP address(es) assigned to the IAB node, either defined at the first MT migration of the IAB-node 1001 to a first non-F1 donor CU controlled IAB topology (at the F1 donor-CU 1004 and the source non-F1 donor-CU 1005), or at the target non-F1 donor-CU 1006 during the consecutive MT migration of the IAB-node 1001 to a second non-F1 donor CU controlled IAB topology (the target IAB topology) (step 1010).

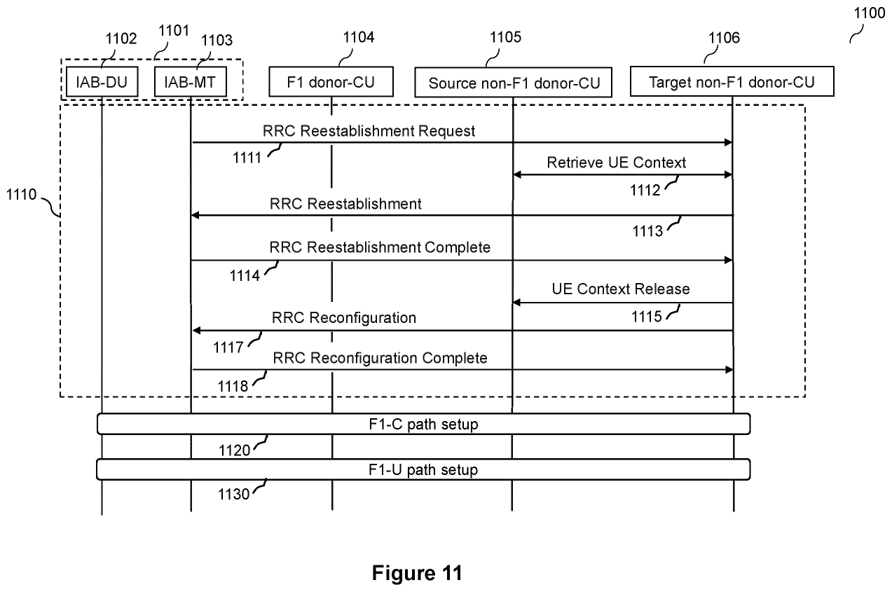

FIG. 11 is a schematic and simplified diagram 1100 illustrating some example message flows in accordance with embodiments of the present invention, to perform a consecutive MT migration of an IAB-node toward a target IAB topology following a Radio Link Failure (RLF) recovery of the IAB-node.

This figure shows an IAB-node 1101 that may be a mobile IAB-node like the IAB-node 870 of FIG. 8 and/or the IAB-node 123 of FIG. 1, composed of a Mobile Termination (MT) 1103 (identified as IAB-MT), and of a Distributed Unit (DU) 1102 (identified as IAB-DU). The figure also shows a source non-F1 terminating donor-CU (or non-F1 donor-CU) 1105 terminating the RRC connection to the IAB-node 1101 through the IAB-MT 1103, a F1 terminating donor-CU (or F1 donor-CU) 1104 terminating the F1 connection to the IAB-node 1101 through the IAB-DU 1102, and a target non-F1 donor-CU 1106 that becomes, during the described procedure, the new non-F1 terminating donor-CU for the IAB-node 1101. As an example and with reference to the IAB communication system of FIG. 8, the F1 terminating donor CU 1104 for the IAB-node is the donor-CU 801, the MT 871 of the IAB-node 870 has migrated to the IAB topology 8002 managed by donor-CU 802 and so the source non-F1 terminating donor CU 1105 is the donor-CU 802. As the IAB-node moves towards the IAB topology 8003, the IAB node 860 is identified as a target IAB node to which the MT of IAB node 870 can be migrated and so the target non-F1 terminating donor CU 1106 is the donor-CU 803.

At the beginning of the flow 1100, it is assumed that the control path (F1-C) and user path (F1-U) setup by the F1 donor-CU 1104 to reach the IAB-node 1101, uses one or several backhaul path(s) in the IAB topology controlled by the source non-F1 donor-CU 1105 through a donor-DU not represented in the FIG. 11. For instance, with reference to FIG. 8, one such backhaul path may include the donor-DU 806 and the IAB nodes 840 and 850.

The first part of the flowchart describes the procedure 1110 resulting in the migration of the IAB-MT 1103 after a RLF recovery to the IAB topology controlled by the target non-F1 donor-CU 1106 (e.g. the IAB-MT 1103 is migrated to the IAB node 860 in IAB topology 8003). It includes the setup of the new path for RRC protocol messages.

The IAB-MT 1103 of the IAB-node 1101 regularly performs measurement on signals received at the IAB-MT 1103 from the serving cell and one or more target cells, such as the Signal Synchronization Block (SSB) transmitted in the serving cell and in the target cells. The target cells may be neighbouring cells to the serving or source cell (i.e. the current serving cell). In the case where the IAB-node 1101 is connected via a backhaul link to the IAB-node 850, the serving or source cell is the cell served by the IAB-node 850.

It may happen that the SSB signal in the serving cell meets predefined criteria (for instance a received power that is below a predefined threshold) during a sufficient time to declare a RLF for the link between the IAB node 1101 and its source parent IAB-node (for instance the link 8050 between the IAB-node 870 and the IAB-node 850 in the FIG. 8). Besides, the IAB-node 1101 may have detected a SSB signal that meets predefined criteria (for instance a received power that is above a predefined threshold) sufficient to attempt a new connection in the corresponding target cell. In that case, the mobile IAB-node 1101 triggers an inter-CU backhaul RLF recovery procedure as described in TS 38.401 V17.2.0 section 8.17.4. It consists in the IAB-node 1101 performing a random-access procedure to obtain uplink resources, and then to transmit a RRC Reestablishment Request message 1111 in the target cell. This RRC message, as specified in TS 38.331, is received by the target parent IAB-node (IAB-node 860 in the example of the FIG. 8), and the message is relayed to the target non-F1 donor-CU 1106 (donor-CU 807 in the example of the FIG. 8), through the F1 message INITIAL UL RRC MESSAGE TRANSFER specified in TS 38.401 V17.2.0 section 9.2.3.1.

Upon reception of this RRC Reestablishment Request 1111 including information to identify the source non-F1 donor-CU 1105 of the IAB-node 1101 (e.g. the Physical Cell Identity of the cell where the IAB-node 1101 was connected to prior to the failure), the target non-F1 donor-CU 1106 initiate the procedure 1112 to retrieve the UE context of the IAB-node 1101 from the source non-F1 donor-CU 1105 (donor-CU 806 in the example of the FIG. 8). In this procedure, the target non-F1 donor-CU 1106 sends to the source non-F1 donor-CU 1105 the Xn protocol message RETRIEVE UE CONTEXT REQUEST specified in TS 38.423 V17.2.0 section 9.1.1.8. The source non-F1 donor-CU 1105 responds with the Xn message RETRIEVE UE CONTEXT RESPONSE specified in TS 38.423 V17.2.0 section 9.1.1.9. After the decision to accept the reestablishment request from the IAB-node 1101, the target non-F1 donor-CU 1106 sends the RRC Reestablishment message 1113 to the IAB-node 1101, embedded in a F1 message DL RRC MESSAGE TRANSFER, specified in TS 38.473 V17.2.0 section 9.2.3.2, and sent to the target parent IAB-node of the IAB-node 1101 (e.g. IAB-node 860 in FIG. 8). Then, the IAB-MT 1103 of the IAB-node 1101 sends a RRC Reestablishment Complete message 1114 to the target non-F1 donor-CU 1106 (via the target parent IAB-node and a F1 message UL RRC MESSAGE TRANSFER embedding the RRC Reestablishment Complete information).

After requesting to the target parent IAB-node, a UE context setup for the IAB-node 1101, the target non-F1 donor-CU 1106 sends the Xn message UE CONTEXT RELEASE 1115, specified in TS 38.423, to the source non-F1 donor-CU 1105, which is informed of the new non-F1 donor-CU for the IAB-node 1101. However, the identifiers of the IAB-node 1101 at the F1 donor-CU 1104 and at the source non-F1 donor-CU 1105 are retained by the source non-F1 donor-CU 1105 as F1 paths are still considered as functional by the F1 donor-CU 1104.

Besides, the target non-F1 donor-CU 1106 sends a RRC configuration message 1117 to the IAB-MT 1103, embedded in the F1 message DL RRC MESSAGE TRANSFER sent to the target parent IAB-node of the IAB-node 1101. In particular, the RRC Reconfiguration message 1117 contains the Transport Network Layer (TNL) address(es) (i.e. IP address(es)) identifying the target donor-DU for packets routing (e.g. data routing). In the example of FIG. 8, the address(es) of the donor-DU 807 replace(s) the address(es) of the donor-DU 806. In response, the IAB-MT 1103 of the IAB-node 1101 sends a RRC Reconfiguration Complete message 1118 to the target non-F1 donor-CU 1106 (via the target parent IAB-node and a F1 message UL RRC MESSAGE TRANSFER embedding the RRC Reconfiguration Complete information).

To complete the consecutive MT migration of the IAB-node 1101, the control data path in the IAB topology of the target non-F1 donor-CU 1106 is setup with the step 1120 corresponding to the step 920 of the FIG. 9, in which the IAB-node 1101 may inform the F1 donor-CU 1104 about the identifier of the target non-F1 donor-CU 1106 and the address(es) of the target donor-DU, or in which the source non-F1 donor-CU 905 may inform the F1 donor-CU 1104 about the identifier of the target non-F1 donor-CU 1106. Also, the user data path is setup with the step 1130 corresponding to the step 1030 of the FIG. 10.

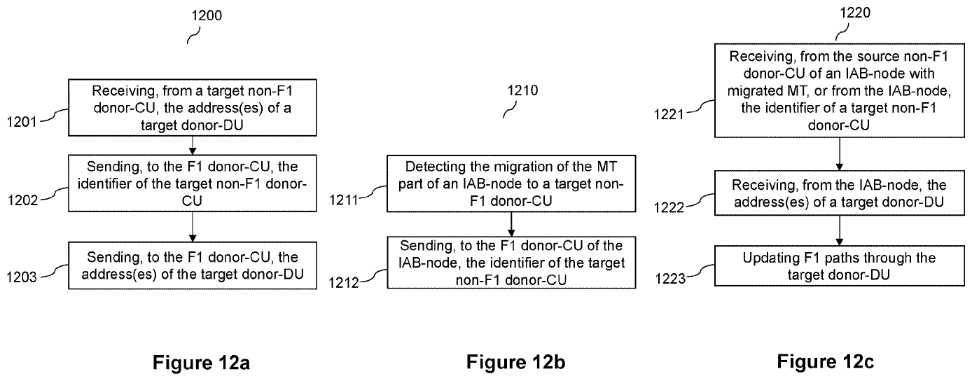

FIGS. 12a-12c are flowcharts showing example methods in accordance with one or more embodiments of the invention that are performed at different network nodes in a wireless communication system (such as communication system shown and described with reference to FIG. 1 and IAB communication system shown and described with reference to FIG. 8). The example methods at the different network nodes are for use in a migration process (or for use in part of a migration process) in which a MT of an IAB node is migrated (e.g. is migrated consecutively) from a second IAB topology managed by a second IAB donor Central Unit, CU (e.g. a source IAB donor CU), to a third IAB topology managed by a third IAB donor CU (e.g. a target IAB donor CU), where the IAB node is managed (or controlled or served) by a first IAB donor CU (e.g. the F1 terminating donor CU of the IAB node with which the IAB node retains a F1 connection) of a first IAB topology. The second and third IAB donor CUs are non-F1 terminating donor CUs or RRC terminating donor CUs of the IAB node. The first IAB donor CU or F1 terminating donor CU receives address information (e.g. from the IAB node) including one or more addresses (such as IP address(es), TNL address(es)) associated with a target IAB donor DU of the third IAB topology via or through which data (e.g. F1 traffic, user traffic, control traffic) associated with the IAB node is to be routed in the third IAB topology (e.g. data that is to be routed to/from the IAB node in the third IAB topology through the target IAB donor DU). The first IAB donor CU or F1 terminating donor CU also receives, from the IAB node (e.g. as described below in more detail with reference to FIG. 12a) or the second IAB donor CU (e.g. the source non-F1 terminating donor CU as described below in more detail with reference to FIG. 12b), identification information (such as PCI or NCGI) for identifying the third IAB donor CU (e.g. the target non-F1 terminating donor CU). In an example, the first IAB donor CU or F1 terminating donor CU may also receive, from the IAB node or the second IAB donor CU (e.g. the source non-F1 terminating donor CU), identification information including at least one identifier of the IAB node. Such identifiers may include the identifiers known to the F1 terminating donor CU and the non-F1 terminating donor CU of the IAB node: for example, the message may include one or more of the information elements F1-Terminating IAB-donor UE XnAP ID and non-F1-Terminating IAB-donor UE XnAP ID or RRC-Terminating IAB-donor UE XnAP ID and BAP address(es) assigned to the IAB node.

Although the following methods/apparatus will be described primarily with respect to a mobile IAB node, it will be appreciated that it is not intended that the invention is limited to mobile IAB nodes. The methods in accordance with one or more embodiments of the present invention may apply to stationary IAB nodes e.g. that are at the edge of one IAB topology and in the proximity of one or more IAB nodes in a neighbouring IAB topology.

Thus, by means of the information (e.g. address information such as the address(es) of the target donor DU to which the IAB node is to be or has already migrated and/or identification information (such as PCI or NCGI) for identifying the third IAB donor CU) sent to the first IAB donor CU (F1 terminating donor CU) of the IAB node by the second IAB donor CU (non-F1 terminating donor CU) or by the IAB node, the F1 terminating donor CU can be informed of migration of the MT of an IAB node between two different topologies: e.g. from a second IAB topology managed by a second IAB donor Central Unit, CU (e.g. a source IAB donor CU), to a third IAB topology managed by a third IAB donor CU (e.g. a target IAB donor CU) and of at least one new routing path to be used to route data (e.g. user traffic and control traffic) for the migrated IAB node in the third IAB topology controlled by the target non-F1 terminating donor CU. The F1 terminating donor CU may then update configuration information for the IAB node based on the received information so as to update routing paths (e.g. the F1-C and F1-U routing paths) associated with or for the IAB-node to the new routing paths for routing data to/from the IAB node via the target donor DU.

FIG. 12a is a flowchart showing an example method 1200, in accordance with one or more embodiments of the invention, performed at an IAB node (e.g. the mobile IAB node or mIAB node) for use in a migration process (or for use in part of a migration process) in which a MT of the IAB node is migrated (e.g. is migrated consecutively) from a second IAB topology to a third topology, which topologies are both different to a first IAB topology to which the IAB node belongs. Method 1200 is for managing, at an IAB-node, the consecutive MT migration toward a target IAB topology different from the IAB topologies controlled by its F1 terminating donor-CU and its source non-F1 terminating donor-CU. For example, with reference to the IAB communication system shown in and described with respect to FIG. 8, the IAB node performing the method 1200 may be the mobile IAB-node 870 belonging to IAB topology 8001 controlled by the IAB donor CU 801 (e.g. a F1 terminating donor CU of the mobile IAB node 870 with which the mobile IAB node 870 retains a F1 connection). The migration process may involve the migration of the MT 871 of the mIAB node 870 from IAB donor DU 806 in the IAB topology 8002 controlled by the IAB donor CU 802 (e.g. a non-F1 terminating donor CU of the mobile IAB node 870 with which the mobile IAB node 870 has a RRC connection and which is operating as a source non-F1 terminating donor CU) to IAB donor DU 807 in the IAB topology 8003 controlled by the IAB donor CU 803 (e.g. a non-F1 terminating donor CU of the mobile IAB node 870 which is operating as a target non-F1 terminating donor CU). Such a migration involves switching routing paths for the mobile IAB node 870 from a routing path including the parent IAB node 850, IAB node 840 and IAB donor DU 806 to a routing path including the parent IAB node 860, and IAB donor DU 807. The method 1200 as shown in and described with respect to FIG. 12a may be performed by software elements and/or hardware elements. The IAB node may be implemented in a communication device 400 as shown in and described with reference to FIG. 4 with the method as shown in and described with respect to FIG. 12a being performed by one or more processing units, such as the central processing unit 411.

At step 1201, an IAB-node, like the IAB-node 870, receives from a target non-F1 terminating donor-CU, like the donor-CU 803, address information including one or more addresses associated with a target IAB donor DU, such as the donor-DU 807, of the third IAB topology 8003 via which data associated with the IAB node is to be routed in the third IAB topology. Thus, the IAB node 807 may receive the address(es) of a target donor-DU, like the donor-DU 807, in the IAB topology controlled by the target non-F1 terminating donor-CU. For example, the IAB-node 870 may receive the address(es) of the target donor-DU in a message, such as RRC Reconfiguration message 913 or 1117 as described above.

At step 1202, the IAB-node may send the identifier of the target non-F1 terminating donor-CU to its F1 terminating donor-CU, like donor-CU 801, controlling another IAB topology. For example, the IAB-node 870 may send identification information for identifying the target non-F1 terminating donor-CU 803. The identification information may include an identifier such as the PCI or NCGI for the target cell from which the F1 terminating donor CU 801 can identify the target non-F1 terminating donor-CU 803.

At step 1203, the IAB-node sends the received address(es) of the target donor-DU to its F1 terminating donor-CU. For example, the IAB-node 870 may send address information including the one or more address(es) of the target donor-DU 807 in a message, such as DU message 922 as described above. The identification information identifying the target non-F1 terminating donor-CU 803 may also be sent in the same message as the address information (e.g. message 922) or in a separate message.

In an example, the IAB-node 870/570 may further send identification information including an identifier(s) of the mobile IAB node known by the two IAB donor-CUs (F1 terminating donor-CU 801 and source non-F1 terminating donor-CU 802): for example, the message may include one or more of the information elements F1-Terminating IAB-donor UE XnAP ID and non-F1-Terminating IAB-donor UE XnAP ID or RRC-Terminating IAB-donor UE XnAP ID and BAP address(es) assigned to the IAB node.

In an example method (which method is not explicitly shown in the figures) for use in a migration process in which a MT of an IAB node is migrated from a second IAB topology managed by a second IAB donor CU (source non-F1/RRC terminating donor CU) to a third IAB topology managed by a third IAB donor CU (target non-F1/RRC terminating donor-CU), the IAB node being managed by a first IAB donor CU (F1 terminating donor-CU) which manages a first IAB topology, the IAB-node sends identification information for identifying the target non-F1/RRC terminating donor-CU to its F1 terminating donor-CU, like donor-CU 801, controlling another IAB topology. For example, the IAB-node 870 may send identification information for identifying the target non-F1 terminating donor-CU 803. The identification information may include an identifier such as the PCI or NCGI for the target cell from which the F1 terminating donor CU 801 can identify the target non-F1 terminating donor-CU 803. The IAB-node 870/570 may further send identification information for identifying the mobile IAB node, such as an identifier(s) associated with the mobile IAB node (e.g. assigned or known by the source non-F1/RRC terminating donor-CU 802 on migration to the topology controlled by the source non-F1/RRC terminating donor-CU 802 or assigned or known by the target non-F1/RRC terminating donor-CU 803 on migration to the topology controlled by the source non-F1/RRC terminating donor-CU 803). For example, the message may include one or more of the information elements F1-Terminating IAB-donor UE XnAP ID and non-F1-Terminating IAB-donor UE XnAP ID or RRC-Terminating IAB-donor UE XnAP ID (assigned by the RRC terminating donor CU(s)) and BAP address(es) assigned to the IAB node (e.g. the BAP address assigned to the IAB node by the source and/or target non-F1/RRC terminating donor CU). Thus, by means of the identification information (e.g. address information such as the address(es) of the third or target donor DU to which the IAB node is to be or has already migrated and/or identification information (such as PCI or NCGI) for identifying the third IAB donor CU) sent to the first IAB donor CU (F1 terminating donor CU) of the IAB node by the second IAB donor CU (non-F1 terminating donor CU or RRC terminating donor CU) or by the IAB node, the F1 terminating donor CU can be informed of migration of the MT of an IAB node between two different topologies and can then update routing paths for the IAB-node 870 based on the received information to new routing paths for routing data to/from the IAB node via the topology managed by the target non-F1/RRC terminating donor CU.

FIG. 12b is a flowchart showing an example method 1210, in accordance with one or more embodiments of the invention, performed at a second IAB donor CU (e.g. the source non-F1 terminating donor-CU of an IAB-node) for use in a migration process (or for use in part of a migration process) for a MT of an IAB node. Method 1210 is for managing, at the source non-F1 terminating donor-CU of an IAB-node, the consecutive MT migration of the IAB-node toward a target IAB topology different from the IAB topology controlled by the F1 terminating donor-CU of the IAB-node. For example, with reference to the IAB communication system shown in and described with respect to FIG. 8, the second IAB donor CU performing the method 1210 may be the IAB donor CU 802 (e.g. a non-F1 terminating donor CU of the IAB node 870 with which the IAB node 870 has a RRC connection). The IAB node may be mobile IAB-node 870 belonging to IAB topology 8001 controlled by the IAB donor CU 801 (e.g. a F1 terminating donor CU of the mobile IAB node 870 with which the mobile IAB node 870 retains a F1 connection). The migration process may involve the migration of the MT 871 of the mIAB node 870 from IAB donor DU 806 in the IAB topology 8002 controlled by the IAB donor CU 802, which is operating as the source non-F1 terminating donor CU, to IAB donor DU 807 in the IAB topology 8003 controlled by the IAB donor CU 803, which is operating as the target non-F1 terminating donor CU. The method 1210 as shown in and described with respect to FIG. 12b may be performed by software elements and/or hardware elements. The non-F1 terminating IAB donor CU may be implemented in a communication device 400 as shown in and described with reference to FIG. 4 with the method as shown in and described with respect to FIG. 12b being performed by one or more processing units, such as the central processing unit 411.

At step 1211, a source non-F1 terminating donor-CU, like the donor-CU 802, of an IAB-node, like the IAB-node 870, detects the migration of the MT part of the IAB-node to a target non-F1 terminating donor-CU, like the donor-CU 803. For example, the source non-F1 terminating donor-CU 802 determines the MT 871 of the mobile IAB node 870 is to be migrated to a target IAB donor DU 807 of the IAB topology 8003 via which data associated with the IAB node is to be routed in the IAB topology 8003. This information may be obtained (e.g. the determination made) through the decision by the source non-F1 terminating donor-CU 802 itself upon the reception of a measurement report from the IAB-node 870 (such as the measurement report 911 discussed above), or this information may be obtained by the reception of a UE context release message (such as messages 915, 1115 described above) related to the IAB-node 870 from a target non-F1 terminating donor-CU 803 for the IAB-node.

At step 1212, the source non-F1 terminating donor-CU 802 sends to the F1 terminating donor-CU 801 of the IAB-node controlling another IAB topology 8001, the identifier of the target non-F1 terminating donor-CU 803 along with the identifiers of the IAB-node known by the two donor-CUs (F1 terminating donor-CU 801 and source non-F1 terminating donor-CU 802). For example, the source non-F1 terminating donor-CU 802 sends identification information for identifying the target non-F1 terminating donor-CU 803. The identification information may include an identifier such as the PCI or NCGI for the target cell from which the F1 terminating donor CU 801 can identify the target non-F1 terminating donor-CU 803.

FIG. 12c is a flowchart showing an example method 1220, in accordance with one or more embodiments of the invention, performed at a first donor CU (e.g. the F1 terminating donor-CU of an IAB-node) for use in a migration process (or for use in part of a migration process) for a MT of an IAB node. Method 1220 is for managing, at the F1 terminating donor-CU of an IAB-node, the consecutive MT migration of the IAB-node toward a target IAB topology different from the IAB topology controlled by the source non-F1 terminating donor-CU of the IAB-node. For example, with reference to the IAB communication system shown in and described with respect to FIG. 8, the first IAB donor CU performing the method 1220 may be the IAB donor CU 801 (e.g a F1 terminating donor CU of the IAB node 870 with which the IAB node 870 retains a F1 connection). The IAB node may be mobile IAB-node 870 belonging to IAB topology 8001 controlled by the IAB donor CU 801. The migration process may involve the migration of the MT 871 of the mIAB node 870 from IAB donor DU 806 in the IAB topology 8002 controlled by the IAB donor CU 802, which is operating as the source non-F1 terminating donor CU, to IAB donor DU 807 in the IAB topology 8003 controlled by the IAB donor CU 803, which is operating as the target non-F1 terminating donor CU. The method 1220 as shown in and described with respect to FIG. 12c may be performed by software elements and/or hardware elements. The F1 terminating IAB donor CU may be implemented in a communication device 400 as shown in and described with reference to FIG. 4 with the method as shown in and described with respect to FIG. 12c being performed by one or more processing units, such as the central processing unit 411.

At step 1221, a F1 terminating donor-CU, like the IAB-donor-CU 801, receives identification information for identifying the target non-F1 terminating donor-CU 803. The identification information may include an identifier such as the PCI or NCGI for the target cell to which the IAB node 870 has migrated and from which the F1 terminating donor CU 801 can identify the target non-F1 terminating donor-CU 803. For example, a F1 terminating donor-CU, like the IAB-donor-CU 801, receives, from the source non-F1 terminating donor-CU 802 of an IAB-node with its MT part already migrated in the IAB topology 8002 controlled by the source non-F1 terminating donor-CU 802, the identifier of a target non-F1 terminating donor-CU 803, along with the identifiers of the IAB-node known by the two donor-CUs (F1 terminating donor-CU 801 and source non-F1 terminating donor-CU 802). Alternatively, the identifier of the target non-F1 terminating donor-CU is received at the F1 terminating donor-CU 801 from the IAB-node 870.

At step 1222, the F1 terminating donor-CU 801 receives, from the IAB-node 870, address information including one or more addresses associated with the target IAB donor DU 807 of the IAB topology 8003 via which data associated with the IAB-node 870 is to be routed in the IAB topology 8003. For example, the F1 terminating donor-CU 801 receives the address(es) of a target donor-DU 807 in the IAB topology controlled by the target non-F1 terminating donor-CU 803 for the IAB-node.

At step 1223, the F1 terminating donor-CU 801 may update routing paths for the IAB-node 870 based on the received information so as to update routing paths (e.g. the F1-C and F1-U routing paths) for the IAB-node 870 to new routing paths for routing data to/from the IAB node via the target donor-DU 506. For example, the F1 terminating donor-CU updates the F1 paths (control and user data paths) to reach the IAB-node 870 through the target donor-DU 807 in the IAB topology controlled by the target non-F1 terminating donor-CU 803 of the IAB-node.

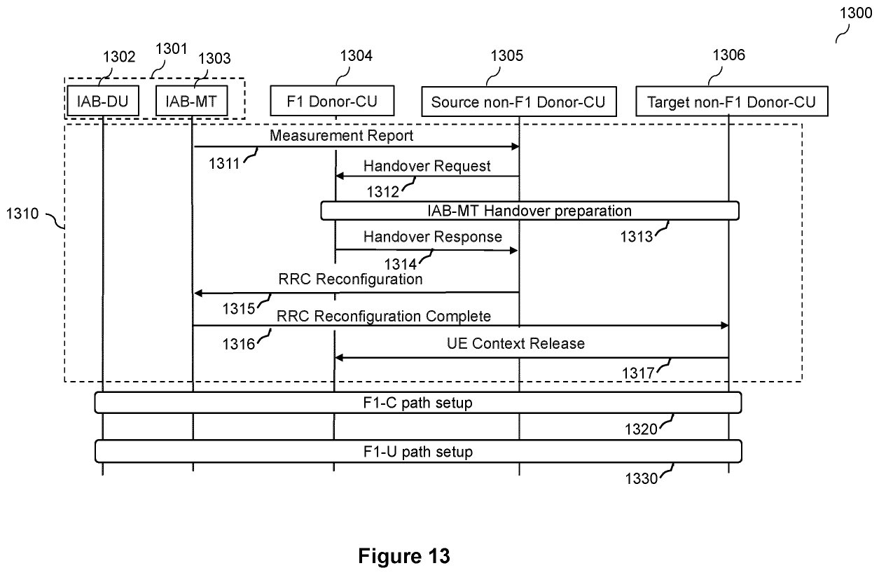

FIG. 13 is a schematic and simplified diagram 1300 illustrating some example message flows according to one or more embodiments of the invention, to perform a consecutive MT migration of an IAB-node toward a target IAB topology, including the setup of the control and user data paths.

This figure shows an IAB-node 1301 that may be a mobile IAB-node like the IAB-node 870 of FIG. 8 and/or the IAB node 123 of FIG. 1, composed of a Mobile Termination (MT) 1303 (identified as IAB-MT), and of a Distributed Unit (DU) 1302 (identified as IAB-DU). The figure also shows a source non-F1 terminating donor-CU (or non-F1 donor-CU) 1305 terminating the RRC connection to the IAB-node 1301 through the IAB-MT 1303, a F1 terminating donor-CU (or F1 donor-CU) 1304 terminating the F1 connection to the IAB-node 1301 through the IAB-DU 1302, and a target non-F1 donor-CU 1306 that becomes, during the described procedure, the new non-F1 terminating donor-CU for the IAB-node 1301. As an example and with reference to the IAB communication system of FIG. 8, the F1 terminating donor CU 1304 for the IAB-node is the donor-CU 801, the MT 871 of the IAB-node 870 has migrated to the IAB topology 8002 managed by donor-CU 802 and so the source non-F1 terminating donor CU 1305 is the donor-CU 802. As the IAB-node moves towards the IAB topology 8003, the IAB node 860 is identified as a target IAB node to which the MT of IAB node 870 can be migrated and so the target non-F1 terminating donor CU 1306 is the donor-CU 803.

At the beginning of the flowchart 1300, it is assumed that the control path (F1-C) and user path (F1-U) setup by the F1 donor-CU 1304 to reach the IAB-node 1301, uses one or several backhaul path(s) in the IAB topology 8002 controlled by the source non-F1 donor-CU 1305 through a donor-DU not represented in the FIG. 13. For instance, with reference to FIG. 8, one such backhaul path may include the donor-DU 806.

The first part of the flowchart describes the procedure 1310 resulting in the migration of the IAB-MT 1303 to the IAB topology 8003 controlled by the target non-F1 donor-CU 1306. It includes the setup of the new path for RRC protocol messages (e.g. set up of a path to support F1-C traffic to/from the target non-F1 donor-CU).

Indeed, it is assumed that the source non-F1 donor-CU 1305 receiving a measurement report 1311 from the IAB-node 1301, initiates a MT migration or consecutive MT migration of the IAB-node 1301 to another IAB topology.

The measurement report 1311 is received by the source non-F1 donor-CU 1305 through the F1 message UL RRC MESSAGE TRANSFER (specified in TS 38.423) sent by the source parent IAB node of the IAB-node 1301 (for instance parent IAB-node 850 in the FIG. 8), which embeds the RRC message with the measurement report sent by the IAB-MT 1303 to the DU part of the source parent IAB-node. The measurement report is the result of the measurements regularly performed by IAB-MT 1303 on signals received from the serving cell and one or more target cells, such as the Signal Synchronization Block (SSB) transmitted in the serving cell and in the target cells. The target cells may be neighbouring cells to the serving or source cell (i.e. the current serving cell). Once the IAB-MT 1303 discovers at least one SSB that meets predefined criteria (for instance a received power that exceeds a predefined threshold), a measurement report may be generated and transmitted to provide radio link quality information for different cells in the vicinity of the IAB-node 901. The identity of each target cell is included in the measurement report to allow the non-F1 donor-CU 1305 to identify the target CU associated with each target cell.

Based on the received measurement report, the source non-F1 donor-CU 1305 may detect that the IAB-node 1301 receives radio signals in a target cell controlled by a target parent IAB-node with a better quality than in the source serving cell. Taking the example of a target parent IAB-node (for instance IAB-node 860 in the FIG. 8) belonging to a different IAB topology as the source parent IAB-node (for instance IAB-node 850 in the FIG. 8), the source non-F1 donor-CU 1305 may decide to apply a handover preparation procedure for the IAB-node 1301.

The IAB-MT 1303 migration is triggered by the message Handover Request 1312 sent by the source non-F1 donor-CU 1305 to the F1 donor-CU 1304 of the IAB-node 1301. This message 1312 may be the HANDOVER REQUEST message specified in TS 38.423 V17.2.0 section 9.1.1.1, but with a new information element indicating that the handover is to be performed by the F1 donor-CU 1304 toward a target non-F1 donor-CU 1306. Thus, this message includes the identifiers of the IAB-node 1301 known by the two donor-CUs (source non-F1 donor-CU 1305 and F1 donor-CU 1304), and the identifier of the target non-F1 donor-CU 1306 in addition to the other information elements present in the message as specified in TS 38.423.

Upon the reception of the message 1312, the F1 donor-CU 1304 triggers the legacy handover preparation procedure 1313 described in TS 38.423 V17.2.0 section 8.2.1, where the F1 donor-CU 904 sends a HANDOVER REQUEST message to the target non-F1 donor-CU 1306 including the necessary information related to the IAB-MT 1303 so that hand over can be performed. For instance, the message includes the identification of the target cell where the IAB-node 1301 will switch to, and thus it identifies the target parent IAB-node (e.g. IAB node 860) that controls the target cell. After requesting to the target parent IAB-node a UE context setup for the IAB-node 1301, the target non-F1 donor-CU 1306 performs admission control and provides the new RRC configuration information to the F1 donor-CU 1304 with the HANDOVER REQUEST ACKNOWLEDGE message. Then the F1 donor-CU 1304 forwards this response to the source non-F1 donor-CU 1305 through the message Handover Response 1314, which may be a copy of the received F1 message HANDOVER REQUEST ACKNOWLEDGE. The individual steps of the handover procedure are not shown in FIG. 13 which for simplicity shows box 1313 representing the IAB-MT handover preparation.

Then, the source non-F1 donor-CU 1305 can relay the RRC configuration information to the IAB-MT 1303 through the RRC Reconfiguration message 1315. Actually, the message 1315 is first embedded in the F1 message UE CONTEXT MODIFICATION REQUEST, specified in TS 38.473, and sent by the source non-F1 donor-CU 1305 to the source parent IAB-node (e.g. IAB node 850) of the IAB-node 1301. Then this source parent IAB sends the RRC Reconfiguration message 1315 to the IAB-MT 1303. In particular, the RRC Reconfiguration message 1313 contains the Transport Network Layer (TNL) address(es) (i.e. IP address(es)) identifying the target donor-DU for packets routing (e.g. data routing). In the example of the FIG. 8, the address(es) of the donor-DU 807 replace(s) the address(es) of the donor-DU 806.

After the IAB-node 1301 performs a random-access procedure toward the target parent IAB node (e.g. IAB-node 860 in FIG. 8), the IAB-node 1301 sends a RRC Reconfiguration Complete message 1316 to the target non-F1 donor-CU 1306 (via the target parent IAB-node and a F1 message UL RRC MESSAGE TRANSFER embedding the RRC Reconfiguration Complete information).

The procedure 1310 ends with the Xn message UE CONTEXT RELEASE 1315, specified in TS 38.423, sent by the target non-F1 donor-CU 1306 to the F1 donor-CU 1304. This message may be forwarded by the F1 donor-CU 1304 to the source non-F1 donor-CU 1305. However, the identifiers of the IAB-node 1301 at the F1 donor-CU 1304 and at the source non-F1 donor-CU 1305 are retained by these two donor-CUs as F1 paths for the IAB-node 1301 may still be used through the IAB topology controlled by the source non-F1 donor-CU 1305.

To complete the consecutive MT migration of the IAB-node 1301, the control data path in the IAB topology of the target non-F1 donor-CU 1306 is setup with the step 1320 corresponding to the step 920 of the FIG. 9, in which the IAB-node 1301 may inform the F1 donor-CU 1304 about the address(es) of the target donor-DU. Also, the user data path is setup with the step 1330 corresponding to the step 1030 of the FIG. 10.

In case a DU migration of the IAB-node 1301 is on-going while receiving the handover request message 1312, the F1 donor-CU 1304 may wait for the completion of the DU migration before launching or initiating the MT handover preparation step 1313. Alternatively, the F1 donor-CU may reject the handover request and directly respond to the source non-F1 donor-CU 1305 with the handover response message 1314 indicating the rejection (e.g. the handover response is negative indicating migration or handover of the MT has been rejected). For example, the F1 donor-CU 1304 may determine whether a migration process for a DU (e.g. IAB-DU 1102) of the IAB-node 1301 has been initiated (e.g. and is on-going) and in response to determining the migration process for the DU of the IAB node has been initiated, the F1 donor-CU 1304 may delay migrating the MT of the IAB node to the third IAB donor CU until completion of the migration process for the DU of the IAB node. Alternatively, in response to determining a migration process for the DU of the IAB node has been initiated, the F1 donor-CU 1304 may send, to the second IAB donor CU, a handover response rejecting the handover request. During the execution of the procedure of the FIG. 13 and until the completion of steps 1320 and 1330, the F1 donor-CU may refrain from launching a DU migration of the IAB-node 1301. For example, the F1 donor-CU may delay initiating a migration process for the DU of the IAB nodes until completion of the migration process for the MT of the IAB node, such as until completion of the setting up of the one or more routing paths (e.g. for F1 traffic). Each of these steps help to avoid the concurrence of MT and DU migration procedures that may lead to the failure of at least one of the migrations.

As an alternative example, when the F1 donor-CU 1304 receives the Handover Request message 1312 from the source non-F1 donor-CU 1305, the F1 donor-CU 1304 may acknowledge this request by sending the Handover Response message 1314 to the non-F1 donor-CU 1305. Upon reception of this message 1314 the non-F1 donor-CU 1305 executes MT migration (with the target non-F1 donor CU 1306) as described above with respect to step 912 of FIG. 9. Before sending the Handover Response message 1314 to the non-F1 donor-CU 1305, the F1 donor-CU 1304 may check whether a DU migration is on-going for the co-located IAB-DU 1302 of the IAB-MT 1303 of the IAB node 1301. If a DU migration is on-going, the F1 donor-CU 1304 may wait for the completion of this DU migration before sending the Handover Response message 1314 with a positive response. In other words, the F1 donor-CU 1304 sends a handover response in the Handover Response message 1314 as a positive response on completion of an on-going DU migration in order to trigger the non-F1 donor-CU 1305 to execute an MT migration. Alternatively, when the F1 donor-CU 1304 determines a DU migration is on-going, the F1 donor-CU 1304 may send a handover response in the Handover Response message 1314 which is a negative response (e.g. indicating the F1 donor-CU 1304 has rejected the handover request).

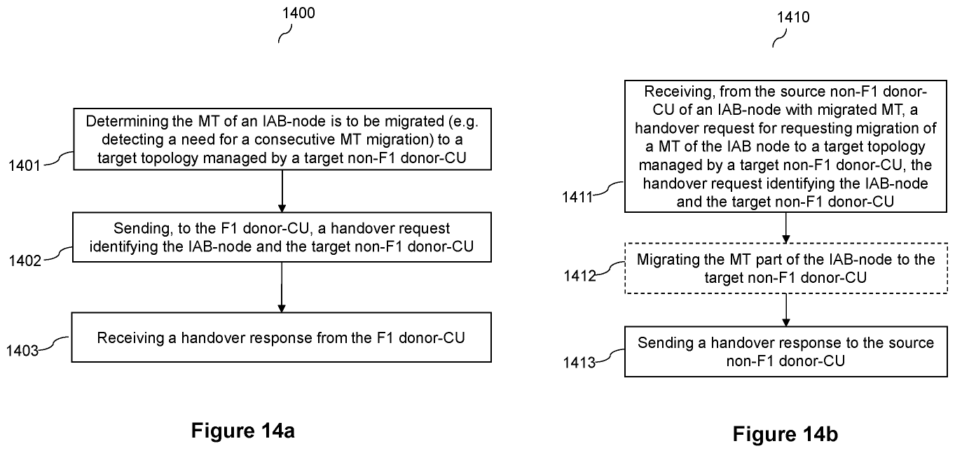

FIGS. 14a-14b are flowcharts showing example methods in accordance with one or more embodiments of the invention that are performed at different network nodes in a wireless communication system (such as communication system shown and described with reference to FIG. 1 and IAB communication system shown and described with reference to FIG. 8). The example methods at the different network nodes are for use in a migration process (or for use in part of a migration process) in which a MT of an IAB node is migrated (e.g. is migrated consecutively) from a second IAB topology managed by a second IAB donor Central Unit, CU (e.g. a source IAB donor CU), to a third IAB topology managed by a third IAB donor CU (e.g. a target IAB donor CU), where the IAB node is managed (or controlled or served) by a first IAB donor CU (e.g. the F1 terminating donor CU of the IAB node with which the IAB node retains a F1 connection) of a first IAB topology. The second and third IAB donor CUs are non-F1 terminating donor CUs of the IAB node. After the source IAB donor CU determines the MT of the IAB node is to be migrated from the second IAB topology to the third IAB topology, the first IAB donor CU or F1 terminating donor CU receives a handover request from the source IAB donor CU. The handover request (e.g. message 1312 described above) includes IAB node identification information for identifying the IAB node having a MT to be migrated and identification information, such as the PCI or NCGI of the target cell to which the MT is to be migrated, for identifying the target IAB donor CU managing the third IAB topology to which the MT of the IAB node is to be migrated. The F1 terminating donor CU may then initiate a procedure to migrate the MT of the IAB node to the target IAB donor CU (e.g. such as the procedure 1313 discussed above which involves the F1 terminating donor CU co-operating with the target IAB donor CU and source IAB donor CU). Alternatively, the source non-F1 terminating donor CU may initiate a procedure to migrate the MT of the IAB node to the target IAB donor CU. After migration is complete (e.g. handover has been accepted by the target IAB donor CU), the F1 terminating donor CU sends a handover response to the source IAB donor CU which may include configuration information associated with one or more routing paths for routing data associated with the IAB node in the third IAB topology. The configuration information includes one or more addresses (such as IP address(es), TNL address(es)) associated with a target IAB donor DU of the third IAB topology via/through which data (e.g. F1 traffic, user traffic, control traffic) is to be routed for the IAB node in the third IAB topology (e.g. data is to be routed to/from the IAB node in the third IAB topology through the target IAB donor DU). The configuration information received at the F1 terminating donor CU may be provided to the IAB node (e.g. via the source IAB donor CU).

Thus, by means of the handover request and the configuration information received at the first IAB donor CU (F1 terminating donor CU) of the IAB node, the F1 terminating donor CU can be informed of migration of the MT of the IAB node between two different topologies: e.g. from a second IAB topology managed by a second IAB donor Central Unit, CU (e.g. a source IAB donor CU), to a third IAB topology managed by a third IAB donor CU (e.g. a target IAB donor CU) and of at least one new routing path to be used to route data (e.g. user traffic and control traffic) associated with or for the migrated IAB node in the third IAB topology controlled by the target non-F1 terminating donor CU.

FIG. 14a is a flowchart showing an example method 1400, in accordance with one or more embodiments of the invention, performed at a second IAB donor CU (e.g. the source non-F1 terminating donor-CU of an IAB-node) for use in a migration process (or for use in part of a migration process) for a MT of an IAB node. Method 1400 is for managing, at the source non-F1 terminating donor-CU of an IAB-node, the consecutive MT migration of the IAB-node toward a target IAB topology different from the IAB topology controlled by the F1 terminating donor-CU of the IAB-node. For example, with reference to the IAB communication system shown in and described with respect to FIG. 8, the second IAB donor CU performing the method 1400 may be the IAB donor CU 802 (e.g. a non-F1 terminating donor CU of the IAB node 870 with which the IAB node 870 has a RRC connection). The IAB node may be mobile IAB-node 870 belonging to IAB topology 8001 controlled by the IAB donor CU 801 (e.g. a F1 terminating donor CU of the mobile IAB node 870 with which the mobile IAB node 870 retains a F1 connection). The migration process may involve the migration of the MT 871 of the mIAB node 870 from IAB donor DU 806 in the IAB topology 8002 controlled by the IAB donor CU 802, which is operating as the source non-F1 terminating donor CU, to IAB donor DU 807 in the IAB topology 8003 controlled by the IAB donor CU 803, which is operating as the target non-F1 terminating donor CU. The method 1400 as shown in and described with respect to FIG. 14a may be performed by software elements and/or hardware elements. The non-F1 terminating IAB donor CU may be implemented in a communication device 400 as shown in and described with reference to FIG. 4 with the method as shown in and described with respect to FIG. 14a being performed by one or more processing units, such as the central processing unit 411.

At step 1401, a source non-F1 terminating donor-CU, like the donor-CU 802, of an IAB-node, like the IAB-node 870, detects the migration of the MT part of the IAB-node to a target non-F1 terminating donor-CU, like the donor-CU 803. For example, the source non-F1 terminating donor-CU 802 determines the MT 871 of the IAB node 870 is to be migrated from the second IAB topology 8002 to the third IAB topology 8003. This information may be obtained (e.g. the determination made) through the decision by the source non-F1 terminating donor-CU itself upon the reception of a measurement report from the IAB-node. For example, the measurement report indicates that the MT 871 of the IAB node 870 should be migrated to, for example, a cell of the third IAB topology, based on measurements made on signals received at the IAB node 870.

At step 1402, the source non-F1 terminating donor-CU 802 sends to the F1 terminating donor-CU 801 of the IAB-node 870 controlling another IAB topology 8001, a handover request for the IAB-node toward a target non-F1 terminating donor-CU 803. The handover request includes identification information, such as PCI or NCGI for the target cell in the third IAB topology to which the MT is to be migrated, for identifying the target IAB donor CU 803 managing the third IAB topology 8003 to which the MT of the IAB node 870 is to be migrated. The handover request may also include identification information for identifying the IAB node 870 having the MT to be migrated. For example, the request includes the identifier of the target non-F1 terminating donor-CU 803 along with the identifiers of the IAB-node known by the two donor-CUs (F1 terminating donor-CU and source non-F1 terminating donor-CU). The request may be the Handover request 1312 discussed above.

At step 1403, the source non-F1 terminating donor-CU 802 may receive, from the F1 terminating donor-CU 801 of the IAB-node, a handover response. The handover response may indicate handover has been accepted (positive handover response) when handover has been accepted by the target non-F1 terminating donor CU 803 and may indicate handover has been rejected (negative handover response) when handover has been rejected by the target non-F1 terminating donor CU. When handover has been accepted, the handover response may include configuration information associated with one or more routing paths for routing data associated with the mobile IAB node in the third IAB topology 8003. The configuration information may include one or more addresses associated with a target IAB donor DU 807 of the third IAB topology via or through which data associated with the IAB node 870 is to be routed in the third IAB topology. The configuration information embedded in the handover response is forwarded to the IAB-node 870. The response may be the Handover Response 1314 discussed above.

In an alternative example, when the F1 terminating donor-CU 801 receives the Handover Request message 1312 from the source non-F1 terminating donor-CU 802, the F1 terminating donor-CU 801 may acknowledge this request by sending a handover response (e.g. the Handover Response message 1314) to the non-F1 terminating donor-CU 802. Upon reception of this handover response at step 1403 the non-F1 terminating donor-CU 802 executes MT migration (with the target non-F1 terminating donor CU 803) as described above with respect to step 912 of FIG. 9. Before sending the handover response (e.g. Handover Response message 1314) to the non-F1 terminating donor-CU 802, the F1 terminating donor-CU 801 may check whether a DU migration is on-going for the co-located IAB-DU 872 of the IAB-MT 871 of the IAB node 870. If there is an on-going DU migration, the F1 terminating donor-CU 801 may wait for the completion of this DU migration before sending the handover response in Handover Response message 1314 with a positive response. In other words, the F1 terminating donor-CU 801 sends a handover response as a positive response on completion of an on-going DU migration in order to trigger the non-F1 terminating donor-CU 802 to execute an MT migration. Alternatively, when the F1 donor-CU 1304 determines a DU migration is on-going, the F1 donor-CU 1304 may send a handover response in the Handover Response message 1314 which is a negative response (e.g. indicating the F1 donor-CU 1304 has rejected the handover request).

FIG. 14b is a flowchart showing an example method 1410, in accordance with one or more embodiments of the invention, performed at a first donor CU (e.g. the F1 terminating donor-CU of an IAB-node) for use in a migration process (or for use in part of a migration process) for a MT of an IAB node. Method 1410 is for managing, at the F1 terminating donor-CU of an IAB-node, the consecutive MT migration of the IAB-node toward a target IAB topology different from the IAB topology controlled by the source non F1 terminating donor-CU of the IAB-node. For example, with reference to the IAB communication system shown in and described with respect to FIG. 8, the first IAB donor CU performing the method 1410 may be the IAB donor CU 801 (e.g a F1 terminating donor CU of the IAB node 870 with which the IAB node 870 retains a F1 connection). The IAB node may be mobile IAB-node 870 belonging to IAB topology 8001 controlled by the IAB donor CU 801. The migration process may involve the migration of the MT 871 of the mIAB node 870 from IAB donor DU 806 in the IAB topology 8002 controlled by the IAB donor CU 802, which is operating as the source non-F1 terminating donor CU, to IAB donor DU 807 in the IAB topology 8003 controlled by the IAB donor CU 803, which is operating as the target non-F1 terminating donor CU. The method 1410 as shown in and described with respect to FIG. 14b may be performed by software elements and/or hardware elements. The F1 terminating IAB donor CU may be implemented in a communication device 400 as shown in and described with reference to FIG. 4 with the method as shown in and described with respect to FIG. 14b being performed by one or more processing units, such as the central processing unit 411.

At step 1411, a F1 terminating donor-CU, like the IAB-donor-CU 801, receives a handover request for requesting migration of a MT of the IAB to the third IAB topology. The handover request includes IAB node identification information for identifying the IAB node 870 having a MT to be migrated and identification information for identifying the target IAB donor CU 803 managing the third IAB topology 8003 to which the MT of the IAB node 870 is to be migrated. For example, a F1 terminating donor-CU, like the donor-CU 801, receives, from a source non-F1 terminating donor-CU like the donor-CU 802, of an IAB-node like the IAB-node 870, a handover request for the IAB-node toward a target non-F1 terminating donor-CU, like the donor-CU 803. The request includes the identifier of the target non-F1 terminating donor-CU 803 along with the identifiers of the IAB-node known by the two donor-CUs (F1 terminating donor-CU 801 and source non-F1 terminating donor-CU 802). The request may be the Handover request 1312 discussed above.

At step 1412, the F1 terminating donor-CU 801 may execute the MT migration of the IAB-node 870 toward the target non-F1 terminating donor-CU 803 using a handover procedure (e.g. in response to receiving the handover request from the source non-F1 terminating donor-CU like the donor-CU 802). For example, the F1 terminating donor-CU 801 may initiate and execute the MT migration of the IAB-node 870 using the handover procedure 1313 discussed above. Migrating the MT of the IAB-node 870 to the target IAB donor CU 803 may include sending, by the source F1 donor-CU 801 to the target IAB donor CU 803, a request to migrate the MT of the IAB-node 870 to a target cell of the third IAB topology (e.g. a target cell of an IAB-node in the third IAB topology which has been determined, through measurements of radio signals received at the IAB-node, to provide better quality radio signals than in the source serving cell). In response, the source F1 donor-CU 801 receives, from the third IAB donor CU 803, a response including configuration information associated with one or more routing paths for routing data associated with the IAB node in the third IAB topology.

At step 1413, the F1 terminating donor-CU 801 sends a handover response to the source non-F1 terminating donor-CU 802. The handover response may indicate handover has been accepted (positive handover response) when handover has been accepted by the target non-F1 terminating donor CU 803 and may indicate handover has been rejected (negative handover response) when handover has been rejected by the target non-F1 terminating donor CU. When handover has been accepted, the handover response may include configuration information for the IAB-node 870 as received from the target non-F1 terminating donor-CU 803 at step 1412. For example, the configuration information is associated with one or more routing paths for routing data associated with the mobile IAB node 870 in the third IAB topology 8003 based on the configuration information received from the target IAB donor CU 803 and may include one or more addresses associated with a target IAB donor DU (such as IAB donor DU 807) of the third IAB topology via which data is to be routed for the mobile IAB node 870 in the third IAB topology. The response may be the Handover Response 1314 discussed above.

Although not shown in FIG. 14b, the source F1 donor-CU 801 may determine whether a migration process for a DU (e.g. IAB-DU 872) of the IAB-node 870 has been initiated (e.g. and is on-going) and in response to determining the migration process for the DU of the IAB node has been initiated, the source F1 donor-CU 801 may delay migrating the MT of the IAB node to the target IAB donor CU 803 until completion of the migration process for the DU of the IAB node. Alternatively, in response to determining a migration process for the DU of the IAB node has been initiated, the source F1 donor-CU 801 may send, to the source non-F1 terminating donor-CU 802, a handover response rejecting the handover request. In an another example, the source F1 donor-CU 801 may delay initiating a migration process for the DU of the IAB node 870 until completion of the migration process for the MT of the IAB node, such as until completion of the setting up of the one or more routing paths (e.g. for F1 traffic).

Step 1412 is shown in dotted lines in FIG. 14b since the handover response sent by the F1 terminating donor-CU 801 in step 1413 may be sent without initiating migration of the MT. For example, when the F1 terminating donor-CU 801 receives, at step 1410, the handover request (e.g. in a Handover Request message 1312) from the source non-F1 terminating donor-CU 802, the F1 terminating donor-CU 801 may acknowledge this request by sending a handover response (e.g. the Handover Response message 1314) to the non-F1 terminating donor-CU 802, at step 1413. As discussed above, upon reception of this handover response, the non-F1 terminating donor-CU 802 executes MT migration (with the target non-F1 terminating donor CU 803) as described with respect to step 912 of FIG. 9. Before sending the handover response (e.g. Handover Response message 1314) to the non-F1 terminating donor-CU 802, the F1 terminating donor-CU 801 may check whether a DU migration is on-going for the co-located IAB-DU 872 of the IAB-MT 871 of the IAB node 870. If there is an on-going DU migration, the F1 terminating donor-CU 801 may wait for the completion of this DU migration before sending the handover response in Handover Response message 1314 with a positive response. In other words, the F1 terminating donor-CU 801 sends a handover response as a positive response on completion of an on-going DU migration in order to trigger the non-F1 terminating donor-CU 802 to execute an MT migration. Alternatively, when the F1 donor-CU 1304 determines a DU migration is on-going, the F1 donor-CU 1304 may send a handover response, at step 1413, in the Handover Response message 1314 which is a negative response (e.g. indicating the F1 donor-CU 1304 has rejected the handover request).

Thus, migration of the MT may be executed by the F1 terminating donor-CU 801 in response to receiving the handover request from the source non-F1 terminating donor-CU 802 (at step 1411) or as discussed above, migration of the MT may be initiated by the F1 terminating donor-CU 801 in response to receiving the handover request from the source non-F1 terminating donor-CU 802 (at step 1411) but executed by the source non-F1 terminating donor-CU 802.

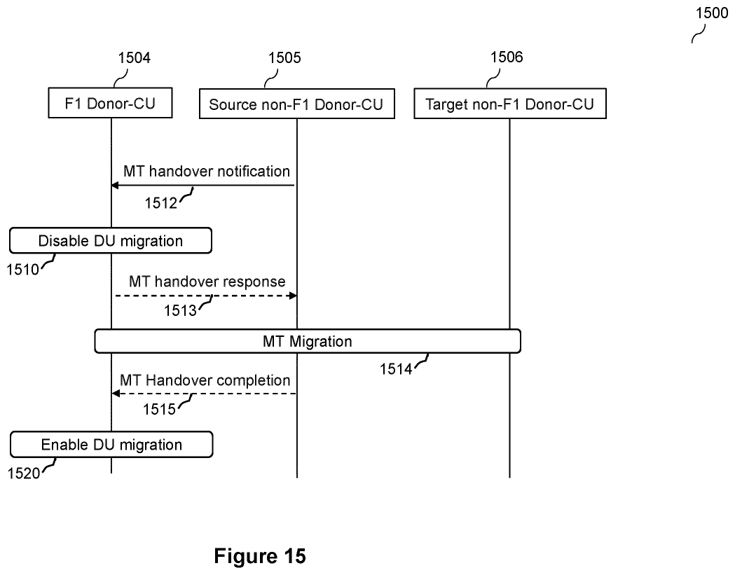

FIG. 15 is a schematic and simplified diagram 1500 illustrating some example message flows according to one or more embodiments of the invention, to avoid initiating a DU migration of an IAB-node during a consecutive MT migration of the IAB-node. Consecutive MT migrations may involve multiple MT migrations between different parent IAB nodes which are connected (directly or indirectly) to different donor-DUs which are both managed by the same donor-CU but which is different to the donor-CU serving the DU of the IAB node. Consecutive MT migration may alternatively involve a new MT migration between different parent IAB nodes which are managed by different donor-CUs which are different to the donor-CU serving the DU of the IAB node.

This FIG. 15 shows a source non-F1 terminating donor-CU (or non-F1 donor-CU) 1505 terminating the RRC connection to an IAB-node (not represented) that may be a mobile IAB-node like the IAB-node 870 of FIG. 8 and/or the IAB node 123 of FIG. 1, composed of a Mobile Termination (MT), and of a Distributed Unit (DU), a F1 terminating donor-CU (or F1 donor-CU) 1504 terminating the F1 connection to the IAB-node, and a target non-F1 donor-CU 1506 that should become the new non-F1 terminating donor-CU for the IAB-node. As an example and with reference to the IAB communication system of FIG. 8, the F1 terminating donor CU 1504 for the IAB-node is the donor-CU 801, the MT 871 of the IAB-node 870 has migrated to the IAB topology 8002 managed by donor-CU 802 and so the source non-F1 terminating donor CU 1505 is the donor-CU 802. As the IAB-node moves towards the IAB topology 8003, the IAB node 860 is identified as a target IAB node to which the MT 871 of IAB node 870 can be migrated and so the target non-F1 terminating donor CU 1506 is the donor-CU 803.

A reason for performing DU migration may be to reduce the processing load at the F1 donor-CU 1504, or because the IAB-node is geographically far from the F1 donor CU 1504 and close to an area where there is no more Xn or IP connectivity between the F1 donor CU 1504 and a target F1 donor-CU.

Briefly, the procedure for DU migration of the IAB-node may be performed according to the following procedure. Upon the decision of or determination by the source F1 donor-CU of the IAB-node to perform the DU migration toward another IAB topology managed by another donor-CU, which donor-CU becomes the target F1 donor-CU, the first step corresponds to sending a request to the IAB node to establish a new F1 connection between the target F1 donor-CU and the IAB node. For example, with reference to FIG. 8, the source F1 donor-CU for IAB node 870 may be donor-CU 801 which decides for IAB-DU 872 of IAB node 870 to perform DU migration towards the IAB topology 8003 and thus, donor-CU 803 is the target F1 donor-CU. This may require activation of a second logical DU entity in the IAB node through a message sent by the F1 donor-CU to the IAB-node. Thus, once a second logical DU entity in the IAB node is activated, the IAB node has two logical DU entities that share the same hardware for the BAP, RLC, and MAC layers. In one example, they share the same physical layer (i.e. the same hardware resources), while in another example they rely on separated physical layers. Each of the logical DU entities serve one or more cells. The cell(s) of a one logical DU entity (e.g. first logical DU) are identified by identifiers (e.g. Physical Cell Identifier (PCI), New Radio Cell Group Identifier (NCGI)) to the cell(s) having different values to the identifiers of the other logical DU entity (e.g. second logical DU). After activation, the second logical DU of the IAB-node may send a F1 setup request message to the target F1 donor-CU for requesting set up of the F1 connection between the IAB-node and the target F1 donor-CU. In the F1 setup response, the target F1 donor-CU may request the second logical DU of the IAB-node to activate new cell(s), and may inform the source F1 donor-CU about the activation of the new cell(s).

The next step consists in the handover of UEs served by the IAB node, from the cell(s) of the first logical DU of the IAB-node to the cell(s) of the second logical DU. The target F1 donor-CU may perform a path switch procedure toward the core network to request the delivery of the user data related to the UEs via the second logical DU. Then, the target F1 donor-CU has to setup the backhaul path(s) to/from the migrated IAB-node, either in its own topology if there is a backhaul path to reach the IAB-node in the IAB topology controlled by the target F1 donor-CU, or through the IAB topology of the non-F1 donor-CU of the IAB-node. In this latter case, the target F1 donor-CU may trigger a procedure to request traffic migration to the non-F1 donor-CU of the IAB-node. Once the handover of all UEs served by the first logical DU of the IAB-node is completed, the source F1 donor-CU may deactivate the first logical DU of the mobile IAB-node. Also, the source F1 donor-CU may release the traffic (user traffic, control traffic) related to the UEs that were served by the IAB-node through the first logical DU. If the traffic was offloaded in an IAB topology controlled by another donor-CU (i.e. the non-F1 donor-CU), the source F1 donor-CU may apply a procedure to request the traffic release to the non-F1 donor-CU.

MT migration may be considered as comprising MT handover, such as procedure 910 described with respect to FIG. 9 or 1010 described with respect to FIG. 10, and transport migration (F1-C/F1-U path setup), such as procedure 920 described with respect to FIG. 9 and procedures 1020 and 1030 described with respect to FIG. 10. If the F1 donor-CU has changed on DU migration, MT handover should not be impacted but transport migration may fail. The mobile IAB-MT's source donor CU can send the info on the mobile IAB-MT's target donor CU to the mobile IAB-DU's donor CU after the completion of IAB-MT handover, HO. However, if the F1 donor CU has changed during the MT handover, then it is the old F1 donor-CU that will be informed not the new and transport migration may. It appears DU migration may be more impacted by a concurrent MT migration because protocol messages exchanged to support DU migration are transmitted through the IAB topology managed by the non-F1 donor-CU. Thus, F1 setup procedure or UE handover may fail because of the change of IAB topology to communicate with the migrated IAB node (the change of IAB topology arising due to MT migration).

Thus, according to the above description, it appears that the DU migration procedure may fail or may be interrupted at different steps if a MT migration is performed during the DU migration. Indeed, a consecutive MT migration of the IAB-node may involve the setup of a new backhaul path through a new IAB topology, leading to some packet loss before all the IAB-donor-CUs having to communicate with the mobile IAB-node are informed of this change. As a safe approach to avoid service interruption at the UEs served by the IAB-node, the DU migration should be executed and completed while the co-located MT stays connected to the same IAB-donor-CU.

Assuming that the source non-F1 donor-CU 1505 receiving a measurement report from the IAB-node, determines the need to hand over the MT part of the IAB-node toward a parent IAB-node belonging to the IAB topology of the target non-F1 donor-CU 1506 (e.g. parent IAB node 860 of IAB topology 8003), or toward a parent IAB-node belonging to the IAB topology of the source non-F1 donor-CU 1505 but involving a new IAB-donor-DU to communicate with the IAB-node (e.g. in the case where IAB-node 870 is initially connected to parent IAB node 830 which is connected to the donor-DU 805 and when the MT 871 of the IAB-node 870 is migrated by the non-F1 donor-CU 802 toward the parent IAB-node 850 which is connected to donor-DU 806). Therefore, a MT migration procedure shall be executed or initiated like the procedure described with reference to FIG. 9 (for migration towards a new IAB topology) or FIG. 6 (for migration to a parent IAB nod with a new IAB donor DU).

In order to prevent the triggering of the DU migration of the IAB-node during this MT migration procedure (which starts with a MT handover procedure, such as procedure 910 as described with respect to FIG. 9), the source non-F1 donor-CU 1506 sends, to the F1 donor-CU 1504, a MT migration notification for indicating the MT of the IAB node is to be migrated to a new parent IAB node. The MT migration notification (or MT handover notification) may be included in a MT handover notification (or IAB NODE MIGRATION REQUEST) message 1512 sent to the F1 donor-CU 1504. The MT migration notification may be sent before executing migration of the MT of the IAB node to the second parent IAB node (e.g. before performing the MT migration procedure/process, for example, before starting the MT handover procedure/process).

In an example, the message 1512 is sent before the execution of the IAB-MT Handover preparation procedure 912 described with reference to FIG. 9, or before sending the message 612 described with reference to FIG. 6. As described above, message 612 includes information for identifying the target donor-DU (or new donor-DU) to which the IAB-node is to be migrated for setting up a new routing path via the target donor-DU.

Assuming that a RRC Reestablishment procedure is triggered by the IAB-node as described with reference to FIG. 11, the source non-F1 donor-CU 1505 may inform the F1 donor-CU 1504 with the message 1512 sent after the reception of the message from the target non-F1 donor-CU 1506 (e.g. RETRIEVE UE CONTEXT REQUEST message) requesting the UE context of the IAB-node as part of the context retrieval procedure 1112 described with reference to FIG. 11.

The MT migration notification includes IAB node identification information for identifying the IAB node having the MT to be migrated. The identification information may include at least one identifier of the IAB node. In the case where the MT migration is toward a new IAB topology, the notification may also include identification information for identifying the target non-F1 donor-CU 1506. For example, the message 1512 includes the identifier(s) of the IAB-node known by the two donor-CUs (F1 donor-CU 1504 and source non-F1 donor-CU 1505), and it may include the identifier of the target non-F1 donor-CU 1506. Such identifier(s) of the IAB-node may include the identifiers known to the F1 terminating donor CU and the non-F1 terminating donor CU of the IAB node: for example, the message may include one or more of the information elements F1-Terminating IAB-donor UE XnAP ID and non-F1-Terminating IAB-donor UE XnAP ID or RRC-Terminating IAB-donor UE XnAP ID and BAP address(es) assigned to the IAB node. The identification information (or identifier for the target non-F1 donor-CU 1506) may include the PCI or NCGI for the target cell in the target IAB topology to which the MT is to be migrated.

Upon reception of this message 1512, the F1 donor-CU 1504 may disable the execution of DU migration for this IAB-node in the operation 1510. For example, the F1 donor-CU 1504 may disable initiating a migration process for the DU of the IAB-node. In case the message 1512 indicates that the target non-F1 donor-CU 1506 for MT handover corresponds to the target F1 donor-CU for a migration of the co-located DU of the IAB-node (e.g. the DU and MT are to be migrated to the same donor-CU), the F1 donor-CU 1504 may not disable the DU migration as the target non-F1 donor CU (and thus also target F1 donor-CU) may be able to concurrently handle the MT migration and DU migration. However, a DU migration toward another target F1 donor-CU (e.g. a donor-CU that is not the same as the donor-CU to which the MT is to be migrated) is disabled.

Then, the F1 donor-CU 1504 may respond to the source non-F1 donor-CU 1505 by sending the MT handover response (or IAB NODE MIGRATION RESPONSE) message 1513. The source non-F1 donor-CU 1505 may wait for this acknowledgment message 1513 to launch the execution of the MT migration procedure 1514 (for example, as described with respect to FIG. 6, FIG. 9, FIG. 10, or FIG. 11). For example, the F1 donor-CU 1504 may execute migration of the MT of the IAB node after receiving the MT migration response in message 1513.

In case of a DU migration procedure for the IAB-node is on-going at the reception of the MT handover notification message 1512, the F1 donor-CU 1504 may wait for the completion of this DU migration procedure before sending the MT handover response message 1513. As an alternative method, the F1 donor-CU 1504 may send a MT handover response (or IAB NODE MIGRATION REJECT) message 1513 that indicates that the MT handover is rejected because a DU migration is on-going (i.e. the cause of rejection is included in the message 1513).

Once the MT migration operation 1514 is completed, the source non-F1 donor-CU 1505 may send a MT handover completion message 1515 to the F1 donor-CU 1505 (e.g. for indicating the migration of the MT of the IAB node is completed). The message 1515 includes the identifier(s) of the IAB-node known by the two donor-CUs (F1 donor-CU 1504 and source non-F1 donor-CU 1505, and it may include the identifier of the target non-F1 donor-CU 1506).

After reception of the MT handover completion message 1515, the F1 donor-CU 1504 can enable again a DU migration of the IAB-node at the operation 1520.

The operation MT migration 1514 may correspond to the execution of the procedure described with reference to the FIGS. 6, 9, 10, or 11. In each of these procedures, the F1 donor-CU 1504 is involved at some point, and the message 1515 may then not be necessary. Thus, the operation 1520 may also be triggered after the reception of an IAB transport migration response from the source F1 donor-CU 1505 or from the target F1-donor-CU 1506 (e.g. message 1036 or 1033 in the FIG. 10).

According to one example, the MT handover notification message 1512 may be the HANDOVER REQUEST message specified in TS 38.423 V17.2.0 section 9.1.1.1, but with a new information element indicating that it is a notification for a MT handover of an IAB-node to be performed between a source non-F1 donor-CU and a target non-F1 donor CU. This message includes the identifiers of the related IAB-node known by the two donor-CUs (source non-F1 donor-CU sending the message and F1 donor-CU receiving the message), and it may include the identifier of the target non-F1 donor-CU in addition to the other information elements present in the message as specified in TS 38.423. Besides, the MT handover response message 1513 may be the HANDOVER REQUEST ACKNOWLEDGE message specified in TS 38.423 V17.2.0 section 9.1.1.2, but with a new information element indicating that it is an acknowledgment for a MT handover of an IAB-node to be performed between a source non-F1 donor-CU and a target non-F1 donor CU. In case of rejection of MT handover, the MT handover response message 1513 may be the HANDOVER PREPARATION FAILURE message specified in TS 38.423 V17.2.0 section 9.1.1.3, but with a new information element indicating that it is a rejection of MT handover of an IAB-node including the cause of the rejection (e.g. because of load issue).

According to another example, the MT handover notification message 1512 may be the NG-RAN NODE CONFIGURATION UPDATE message specified in TS 38.423 V17.2.0 section 9.1.3.4, but with a new information element indicating that it is a notification for a MT handover of an IAB-node to be performed between a source non-F1 donor-CU and a target non-F1 donor CU. This message includes the identifiers of the related IAB-node known by the two donor-CUs (source non-F1 donor-CU sending the message and F1 donor-CU receiving the message), and it may include the identifier of the target non-F1 donor-CU in addition to the other information elements present in the message as specified in TS 38.423. Besides, the MT handover response message 1513 may be the NG-RAN NODE CONFIGURATION UPDATE ACKNOWLEDGE message specified in TS 38.423 V17.2.0 section 9.1.3.5, but with a new information element indicating that it is an acknowledgment for a MT handover of an IAB-node to be performed between a source non-F1 donor-CU and a target non-F1 donor CU. In case of rejection of MT handover, the MT handover response message 1513 may be the NG-RAN NODE CONFIGURATION UPDATE FAILURE message specified in TS 38.423 V17.2.0 section 9.1.3.6, but with a new information element indicating that it is a rejection of MT handover of an IAB-node including the cause of the rejection (e.g. because of load issue).

According to another example, the MT handover notification message 1512 may be the MOBILITY CHANGE REQUEST message specified in TS 38.423 V17.2.0 section 9.1.3.22, but with a new information element indicating that it is a notification for a MT handover of an IAB-node to be performed between a source non-F1 donor-CU and a target non-F1 donor CU. This message includes the identifiers of the related IAB-node known by the two donor-CUs (source non-F1 donor-CU sending the message and F1 donor-CU receiving the message), and it may include the identifier of the target non-F1 donor-CU in addition to the other information elements present in the message as specified in TS 38.423. Besides, the MT handover response message 1513 may be the MOBILITY CHANGE ACKNOWLEDGE message specified in TS 38.423 V17.2.0 section 9.1.3.23, but with a new information element indicating that it is an acknowledgment for a MT handover of an IAB-node to be performed between a source non-F1 donor-CU and a target non-F1 donor CU. In case of rejection of MT handover, the MT handover response message 1513 may be the MOBILITY CHANGE FAILURE message specified in TS 38.423 V17.2.0 section 9.1.3.24, but with a new information element indicating that it is a rejection of MT handover of an IAB-node including the cause of the rejection (e.g. because of load issue).

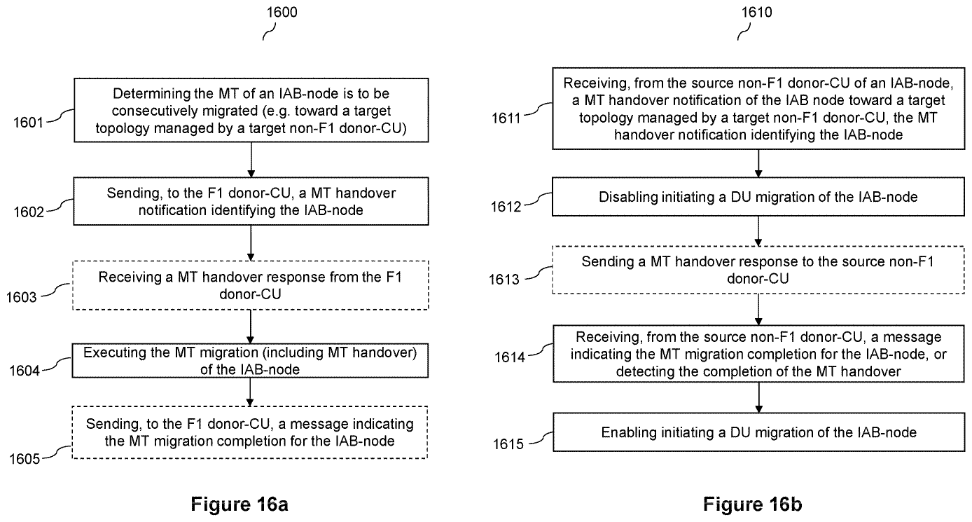

FIG. 16a is a flowchart of an example method 1600 in accordance with one or more embodiments of the present invention, for use in managing, at a second IAB donor CU (e.g. the source non-F1 terminating donor-CU) of an IAB-node, the consecutive MT migration of the IAB-node in a manner that it does not compete with a DU migration of the IAB-node. The consecutive MT migration of the IAB-node involves migration of the MT of the IAB-node from a first parent IAB node of the IAB topology managed or controlled by the second IAB donor CU (e.g. the source non-F1 terminating donor-CU) toward a second parent IAB node. In an example, the first parent IAB node involves or uses a first backhaul path including a first IAB donor DU of the second IAB topology managed by the second IAB donor CU to route data associated with the IAB node and the second parent IAB node involves or uses a second backhaul path including a second IAB donor DU of the second IAB topology to route data associated with the IAB node (e.g. the migration is between two different donor DUs in the same topology). In this case, the source non-F1 donor-CU may decide to apply the intra-CU topology adaptation procedure for the IAB-node as discussed above with reference to FIG. 6. In another example, the second parent IAB node is part of a third IAB topology managed by a third IAB donor CU. In this case, the consecutive MT migration of the IAB-node is toward a target IAB topology different from the IAB topology controlled by a first IAB donor CU (e.g. the F1 terminating donor-CU) of the IAB-node (e.g. the target IAB topology is not the IAB topology controlled by the F1 terminating donor-CU of the IAB-node), for example as discussed above with reference to FIG. 9.

For example, with reference to the IAB communication system shown in and described with respect to FIG. 8, the second IAB donor CU performing the method 1600 may be the IAB donor CU 802 (e.g. a non-F1 terminating donor CU of the IAB node 870 with which the IAB node 870 has a RRC connection). The IAB node may be mobile IAB-node 870 belonging to IAB topology 8001 controlled by the IAB donor CU 801 (e.g. a F1 terminating donor CU of the mobile IAB node 870 with which the mobile IAB node 870 retains a F1 connection). In FIG. 15, the non-F1 terminating donor CU is referred to by the reference number 1505, the F1 terminating donor CU is referred to by the reference number 1504 and the target non-F1 terminating donor CU is referred to by the reference number 1506. In an example, the migration process may involve the migration of the MT 871 of the IAB node 870 from a first parent IAB node (e.g. IAB node 830) of the IAB topology 8002 controlled by the IAB donor CU 802 to a second IAB node (e.g. IAB node 850) of the same IAB topology 8002 controlled by the IAB donor CU 802 with the first parent IAB node 830 being in a backhaul path with a first donor DU 805 which is different to donor DU 806 in the backhaul path for the second IAB node 850. In another example, the migration process may involve the migration of the MT 871 of the IAB node 870 from IAB donor DU 806 in the IAB topology 8002 controlled by the IAB donor CU 802, which is operating as the source non-F1 terminating donor CU, to IAB donor DU 807 in the IAB topology 8003 controlled by the IAB donor CU 803, which is operating as the target non-F1 terminating donor CU. The method 1600 as shown in and described with respect to FIG. 16a may be performed by software elements and/or hardware elements. The non-F1 terminating IAB donor CU may be implemented in a communication device 400 as shown in and described with reference to FIG. 4 with the method as shown in and described with respect to FIG. 16a being performed by an apparatus for the non-F1 terminating IAB donor CU including one or more processing units, such as the central processing unit 411.

At step 1601, a source non-F1 terminating donor-CU (or source non-F1 donor-CU), like the donor-CU 802, of an IAB-node, like the IAB-node 870, determines the MT of the IAB node is to be migrated toward a second parent IAB node. For example, the source non-F1 donor-CU 802 determines the MT 871 of the IAB node 870 is to be consecutively migrated toward a target topology (e.g. IAB topology 8003) managed by a target non-F1 terminating donor-CU (or target non-F1 donor-CU), such as donor-CU 803. Alternatively, the source non-F1 donor-CU 802 determines the MT 871 of the IAB node 870 is to be consecutively migrated toward a parent IAB-node (e.g. IAB node 850) in the same IAB topology 8002 managed by the source non-F1 donor-CU 802. The parent IAB-node to which the MT 871 of the IAB node 870 is to be migrated is connected (directly or indirectly) to a different donor DU to that of the donor DU in the current backhaul path for the IAB node 870.

At step 1602, the source non-F1 donor-CU 802 sends, to the F1 donor-CU, such as donor-CU 801, a MT handover notification message identifying the IAB-node 870. For example, the source non-F1 donor-CU 802 sends a MT migration notification (or MT handover notification) for indicating the MT 871 of the IAB-node 870 is to be migrated. The MT migration notification (or MT handover notification) includes identification information for identifying the IAB-node having the MT to be migrated. The MT migration notification may be included in the MT handover notification (or IAB NODE MIGRATION REQUEST) message 1512 as discussed above. The source non-F1 donor-CU 802 may send a MT migration notification (or MT handover notification) before executing migration of the MT of the IAB node as discussed above, with reference to FIG. 15 and to the sending of the message 1512.

At step 1603, the source non-F1 donor-CU 802 may receive a MT handover response message (or MT migration response) from the F1 donor-CU 801, as a response to the MT handover notification message of step 1602. The MT handover response (or MT migration response) may be included in the MT handover response (or IAB NODE MIGRATION RESPONSE) message 1513 as discussed above.

At step 1604, the source non-F1 donor-CU 802 executes the MT migration procedure (e.g. including MT handover) for the IAB-node 870. For example, the source non-F1 donor-CU 802 may launch the execution of the MT migration procedure 1514 starting with MT handover (for example, as described with respect to FIG. 6, FIG. 9, FIG. 10, or FIG. 11) after receiving the MT handover response (or IAB NODE MIGRATION RESPONSE) message 1513.

At step 1605, the source non-F1 donor-CU 802 may send, to the F1 donor-CU 801, a message indicating the MT migration is completed for the IAB-node 870. For example, the source non-F1 donor-CU 802 may send a MT handover completion message 1515 as discussed above.

FIG. 16b is a flowchart of an example method 1610 in accordance with one or more embodiments of the present invention, for use in managing migration of a DU of an IAB node during a consecutive MT migration of the IAB-node. The method 1610 is performed at a first IAB donor CU (e.g. the F1 terminating donor-CU) of the IAB-node. The method involves disabling, at the F1 terminating donor-CU of the IAB-node, the DU migration of the IAB-node during a consecutive MT migration of the IAB-node. The consecutive MT migration of the IAB-node involves migration of the MT of the IAB-node from a first parent IAB node of the IAB topology managed or controlled by the second IAB donor CU (e.g. the source non-F1 terminating donor-CU) toward a second parent IAB node. In an example, the first parent IAB node involves or uses a first backhaul path including a first IAB donor DU of the second IAB topology managed by the second IAB donor CU to route data associated with the IAB node and the second parent IAB node involves or uses a second backhaul path including a second IAB donor DU of the second IAB topology to route data associated with the IAB node (e.g. the migration is between two different donor DUs in the same topology). In this case, the source non-F1 donor-CU may decide to apply the intra-CU topology adaptation procedure for the IAB-node as discussed above with reference to FIG. 6. In another example, the second parent IAB node is part of a third IAB topology managed by a third IAB donor CU. In this case, the consecutive MT migration of the IAB-node is toward a target IAB topology different from the IAB topology controlled by a first IAB donor CU (e.g. the F1 terminating donor-CU) of the IAB-node (e.g. the target IAB topology is not the IAB topology controlled by the F1 terminating donor-CU of the IAB-node).

For example, with reference to the IAB communication system shown in and described with respect to FIG. 8, the first IAB donor CU performing the method 1610 may be the IAB donor CU 801 (e.g a F1 terminating donor CU of the IAB node 870 with which the IAB node 870 retains a F1 connection). The IAB node may be mobile IAB-node 870 belonging to IAB topology 8001 controlled by the IAB donor CU 801. In FIG. 15, the non-F1 terminating donor CU is referred to by the reference number 1505, the F1 terminating donor CU is referred to by the reference number 1504 and the target non-F1 terminating donor CU is referred to by the reference number 1506. In an example, the migration process may involve the migration of the MT 871 of the IAB node 870 from a first parent IAB node (e.g. IAB node 830) of the IAB topology 8002 controlled by the IAB donor CU 802 to a second IAB node (e.g. IAB node 850) of the same IAB topology 8002 controlled by the IAB donor CU 802 with the first parent IAB node 830 being in a backhaul path with a first donor DU 805 which is different to donor DU 806 in the backhaul path for the second IAB node 850. In another example, the migration process may involve the migration of the MT 871 of the IAB node 870 from IAB donor DU 806 in the IAB topology 8002 controlled by the IAB donor CU 802, which is operating as the source non-F1 terminating donor CU, to IAB donor DU 807 in the IAB topology 8003 controlled by the IAB donor CU 803, which is operating as the target non-F1 terminating donor CU. The method 1610 as shown in and described with respect to FIG. 16b may be performed by software elements and/or hardware elements. The F1 terminating IAB donor CU may be implemented in a communication device 400 as shown in and described with reference to FIG. 4 with the method as shown in and described with respect to FIG. 16b being performed by an apparatus for the F1 terminating IAB donor CU including one or more processing units, such as the central processing unit 411.

At step 1611, a F1 terminating donor-CU (or F1 donor-CU), like the IAB-donor-CU 801, receives from the source non-F1 terminating donor-CU (or source non-F1 donor-CU) 802 of an IAB-node, such as IAB-node 870, a MT handover notification of the IAB node. Thus, the F1 donor-CU 801 receives a MT migration notification (or MT handover notification) for indicating the MT 871 of the IAB-node 870 is to be migrated from a first parent IAB node (e.g. current parent IAB node) to a second parent IAB node (e.g. new or target parent IAB node). The MT migration notification (or MT handover notification) includes identification information for identifying the IAB-node having the MT to be migrated. The MT handover notification of the IAB node may indicate the MT 871 of the IAB node 870 is to be consecutively migrated toward a target topology (e.g. IAB topology 8003) managed by a target non-F1 terminating donor-CU (or target non-F1 donor-CU), the MT handover notification identifying the IAB-node. The source non-F1 donor-CU may be the IAB donor CU 802, and the target non-F1 donor-CU may be the IAB donor CU 803. Alternatively, the MT handover notification of the IAB node may indicate the MT 871 of the IAB node 870 is to be consecutively migrated toward a parent IAB-node (e.g. IAB node 850) in the same IAB topology 8002 managed by the source non-F1 donor-CU 802. The parent IAB-node to which the MT 871 of the IAB node 870 is to be migrated is connected (directly or indirectly) to a different donor DU to that of the donor DU in the current backhaul path for the IAB node 870. The MT migration notification may be included in the MT handover notification (or IAB NODE MIGRATION REQUEST) message 1512 as discussed above.

At step 1612, the F1 donor-CU disables initiating a DU migration procedure for the IAB-node. For example, after receiving or in response to receiving the MT migration notification, the F1 donor-CU 801 disables initiating a migration process for the DU of the IAB node until completion of the migration process for the MT of the IAB node.

The F1 donor-CU 801 enables initiating a migration process for the DU of the IAB node after the MT of the IAB node has been migrated to the second parent IAB node (e.g. after completion of the migration process for the MT of the IAB node), step 1615. The F1 donor-CU 801 may determine the MT of the IAB node has been migrated to the second parent IAB node (e.g. the migration process for the MT of the IAB node is completed) as discussed below with reference to step 1614.

At step 1613, the F1 donor-CU 801 may send a MT handover response message (or MT migration response) to the source non-F1 donor-CU 802, as a response to the MT handover notification message of step 1611. The MT handover response message (or MT migration response) may be included in the MT handover response (or IAB NODE MIGRATION RESPONSE) message 1513 as discussed above.

At step 1614, the F1 donor-CU 801 may receive from the source non-F1 donor-CU 802 a message indicating the MT migration completion for the IAB-node. For example, the source non-F1 donor-CU 802 may send a MT handover completion message 1515 as discussed above. As an alternative step, the F1 donor-CU 801 may detect the completion of the MT migration through the exchanges of messages with the source non-F1 donor-CU 802 or the target non-F1 donor-CU 803 at the end of the MT migration procedure.

At step 1615, the F1 donor-CU enables initiating a DU migration procedure for the IAB-node.

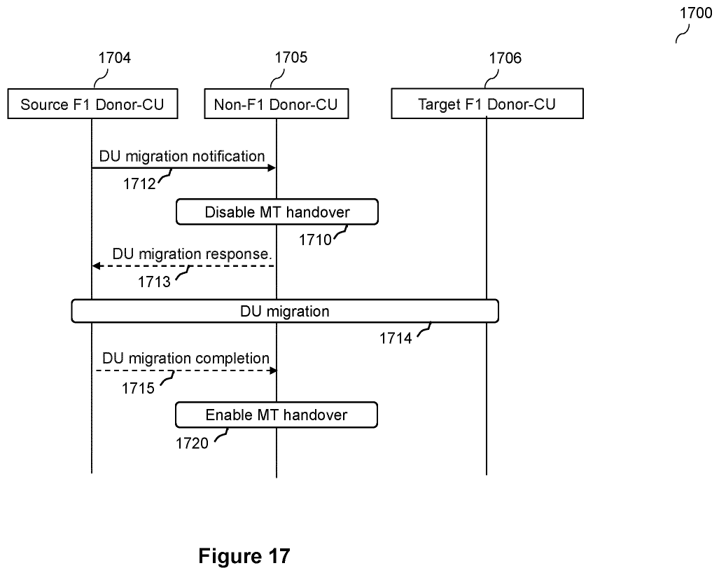

FIG. 17 is a schematic and simplified diagram 1700 illustrating some example message flows according to one or more embodiments of the invention, to avoid initiating a consecutive MT migration of an IAB-node during a DU migration of the IAB-node. Consecutive MT migrations may involve multiple MT migrations between different parent IAB nodes which are connected (directly or indirectly) to different donor-DUs which are both managed by the same donor-CU but which is different to the donor-CU serving the DU of the IAB node. Consecutive MT migration may alternatively involve a new MT migration between different parent IAB nodes which are managed by different donor-CUs which are different to the donor-CU serving the DU of the IAB node.

This FIG. 17 shows a non-F1 terminating donor-CU (or non-F1 donor-CU) 1705 terminating the RRC connection to an IAB-node (not represented) that may be a mobile IAB-node like the IAB-node 870 of FIG. 8 and/or the IAB node 123 of FIG. 1, composed of a Mobile Termination (MT), and of a Distributed Unit (DU), a source F1 terminating donor-CU (or F1 donor-CU) 1704 terminating the F1 connection to the IAB-node, and a target F1 donor-CU 1706 that should become the new F1 terminating donor-CU for the IAB-node. As an example and with reference to the IAB communication system of FIG. 8, the source F1 terminating donor CU 1704 for the IAB-node is the donor-CU 801, the MT 871 of the IAB-node 870 has migrated to the IAB topology 8002 managed by donor-CU 802 and so the non-F1 terminating donor CU 1705 is the donor-CU 802. As the IAB-node moves towards the IAB topology 8003, this topology is identified as a target IAB topology to which the DU 872 of IAB node 870 can be migrated (for instance for load balancing purpose), and so the target F1 terminating donor CU 1706 is the donor-CU 803.

Briefly, the procedure for DU migration of the IAB-node may be performed according to the following procedure. Upon the decision of or determination by the source F1 donor-CU of the IAB-node to perform the DU migration toward another IAB topology managed by another donor-CU, which donor-CU becomes the target F1 donor-CU, the first step corresponds to sending a request to the IAB node to establish a new F1 connection between the target F1 donor-CU and the IAB node. As mentioned above, the source F1 donor-CU of the IAB-node may decide to perform the DU migration to reduce the processing load at the source F1 donor-CU, or because the IAB-node is geographically far from the source F1 donor-CU and close to an area where there is no more Xn or IP connectivity between the source F1 donor CU and a target F1 donor-CU. For example, with reference to FIG. 8, the source F1 donor-CU for IAB node 870 may be donor-CU 801 which decides for IAB-DU 872 of IAB node 870 to perform DU migration towards the IAB topology 8003 and thus, donor-CU 803 is the target F1 donor-CU. This may require activation of a second logical DU entity in the mobile IAB node through a message sent by the source F1 donor-CU to the IAB-node. Thus, once a second logical DU entity in the IAB node is activated, the IAB node has two logical DU entities that share the same hardware for the BAP, RLC, and MAC layers. In one example, they share the same physical layer (i.e. the same hardware resources), while in another example they rely on separated physical layers. Each of the logical DU entities serve one or more cells. The cell(s) of a one logical DU entity (e.g. first logical DU) are identified by identifiers (e.g. Physical Cell Identifier (PCI), New Radio Cell Group Identifier (NCGI)) to the cell(s) having different values to the identifiers of the other logical DU entity (e.g. second logical DU). After activation, the second logical DU of the IAB-node may send a F1 setup request message to the target F1 donor-CU for requesting set up of the F1 connection between the IAB-node and the target F1 donor-CU. In the F1 setup response, the target F1 donor-CU may request the second logical DU of the IAB-node to activate new cell(s), and may inform the source F1 donor-CU about the activation of the new cell(s).

The next step consists in the handover of UEs served by the IAB node, from the cell(s) of the first logical DU of the IAB-node to the cell(s) of the second logical DU. The target F1 donor-CU may perform a path switch procedure toward the core network to request the delivery of the user data related to the UEs via the second logical DU. Then, the target F1 donor-CU has to setup the backhaul path(s) to/from the migrated IAB-node, either in its own topology if there is a backhaul path to reach the IAB-node in the IAB topology controlled by the target F1 donor-CU, or through the IAB topology of the non-F1 donor-CU of the IAB-node. In this latter case, the target F1 donor-CU may trigger a procedure to request traffic migration to the non-F1 donor-CU of the IAB-node. Once the handover of all UEs served by the first logical DU of the IAB-node is completed, the source F1 donor-CU may deactivate the first logical DU of the mobile IAB-node. Also, the source F1 donor-CU may release the traffic (user traffic, control traffic) related to the UEs that were served by the IAB-node through the first logical DU. If the traffic was offloaded in an IAB topology controlled by another donor-CU (i.e. the non-F1 donor-CU), the source F1 donor-CU may apply a procedure to request the traffic release to the non-F1 donor-CU.

According to the above description, it appears that the DU migration procedure may fail or may be interrupted at different steps if a MT migration of the IAB-node is performed during the DU migration. Indeed, a MT migration of the IAB-node may involve the setup of a new backhaul path through a new IAB topology, leading to some packet loss before all the IAB-donor-CUs having to communicate with the mobile IAB-nodes are informed of this change. As a safe approach to avoid service interruption at the UEs served by the IAB-node, the DU migration should be executed and completed while the co-located MT stays connected to the same IAB-donor-CU.

In order to prevent the triggering of the MT migration (starting with the MT handover) of the IAB-node during the DU migration procedure/process, the source F1 donor-CU 1704 sends, to the non-F1 donor-CU 1705, a DU migration notification for indicating the DU of the IAB node is to be migrated to an IAB topology managed by the target F1 donor-CU 1706. The DU migration notification may be included in a DU migration notification (or IAB NODE MIGRATION REQUEST) message 1712 sent to the non-F1 donor-CU 1705. The message 1712 may be sent before the first step of the DU migration procedure (i.e. activation of a second logical DU in the IAB-node). For example, the message 1712 may be sent before executing migration of the DU of the IAB node (e.g. before performing the DU migration procedure/process).

The message 1712 includes the identifier(s) of the IAB-node known by the two donor-CUs (source F1 donor-CU 1704 and non-F1 donor-CU 1705), and it may include the identifier of the target F1 donor-CU 1706. Thus, the DU migration notification includes IAB node identification information for identifying the IAB node having the DU to be migrated. The identification information may include at least one identifier of the IAB node. Such identifier(s) of the IAB-node may include the identifiers known to the F1 terminating donor CU and the non-F1 terminating donor CU of the IAB node: for example, the message may include one or more of the information elements F1-Terminating IAB-donor UE XnAP ID and non-F1-Terminating IAB-donor UE XnAP ID or RRC-Terminating IAB-donor UE XnAP ID and BAP address(es) assigned to the IAB node. Identification information (or identifier) for the target non-F1 donor-CU 1706 may include the PCI or NCGI for the target cell in the target IAB topology to which the DU is to be migrated.

Upon reception of this message 1712, the non-F1 donor-CU 1705 may disable the execution of MT handover for this IAB-node in the operation 1710. For example, the non-F1 donor-CU 1705 may disable initiating a MT migration process (e.g. which includes disabling MT handover which is part of the MT migration process) for the MT of the IAB-node. In case the message 1712 indicates that the target F1 donor-CU for DU migration corresponds to the target non-F1 donor-CU for a handover of the co-located MT of the IAB-node (e.g. the DU and MT are to be migrated to the same donor-CU), the non-F1 donor-CU 1705 may not disable the MT migration as the target non-F1 donor CU (and thus also target F1 donor-CU) may be able to concurrently handle the MT migration and DU migration. However, a MT handover toward another target non-F1 donor-CU (e.g. a donor-CU that is not the same as the donor-CU to which the DU is to be migrated) is disabled.

Then, the non-F1 donor-CU 1705 may respond to the source F1 donor-CU 1704 by sending the DU migration response (or IAB NODE MIGRATION RESPONSE) message 1713. The source F1 donor-CU 1704 may wait for this acknowledgment message 1713 to launch the execution of the DU handover procedure 1714. For example, the source F1 donor-CU 1704 may execute migration of the DU of the IAB node after receiving the DU migration response in message 1713.

In case of a MT migration procedure for the IAB-node is on-going at the reception of the DU migration notification message 1712, the non-F1 donor-CU 1705 may wait for the completion of this on-going MT migration procedure before sending the DU migration response message 1713. As an alternative method, the non-F1 donor-CU 1705 may send a DU migration response (or IAB NODE MIGRATION REJECT) message 1713 that indicates that the DU migration is rejected because a MT migration is on-going (i.e. the cause of rejection is included in the message 1713).

Once the DU migration operation 1714 is completed, the source F1 donor-CU 1704 may send a DU migration completion message 1715 to the non-F1 donor-CU 1705 (e.g. for indicating the migration of the DU of the IAB node is completed). The message 1715 includes the identifier(s) of the IAB-node known by the two donor-CUs (source F1 donor-CU 1704 and non-F1 donor-CU 1705, and it may include the identifier of the target F1 donor-CU 1706).

After reception of the DU migration completion message 1715, the non-F1 donor-CU 1705 can enable again a MT migration process (e.g. which includes enabling MT handover which is part of the MT migration process) of the IAB-node at the operation 1720.

In the procedure for DU migration, the non-F1 donor-CU 1705 is involved at some point, when the source F1 donor-CU 1704 releases the traffic migrated toward the IAB topology controlled by the non-F1 donor-CU 1705, and if the target F1 donor-CU 1706 requests traffic migration toward the IAB topology controlled by the non-F1 donor-CU 1705. Thus, the message 1715 may then not be necessary, and the operation 1720 may also be triggered after sending an IAB transport migration response to the source F1 donor-CU 1704 or to the target F1-donor-CU 1706.

According to one example, the DU migration notification message 1712 may be the HANDOVER REQUEST message specified in TS 38.423 V17.2.0 section 9.1.1.1, but with a new information element indicating that it is a notification for a DU migration of an IAB-node to be performed between a source F1 donor-CU and a target F1 donor CU. This message includes the identifiers of the related IAB-node known by the two donor-CUs (source F1 donor-CU sending the message and non-F1 donor-CU receiving the message), and it may include the identifier of the target F1 donor-CU in addition to the other information elements present in the message as specified in TS 38.423. Besides, the DU migration response message 1713 may be the HANDOVER REQUEST ACKNOWLEDGE message specified in TS 38.423 V17.2.0 section 9.1.1.2, but with a new information element indicating that it is an acknowledgment for a DU migration of an IAB-node to be performed between a source F1 donor-CU and a target F1 donor CU. In case of rejection of DU migration, the DU migration response message 1713 may be the HANDOVER PREPARATION FAILURE message specified in TS 38.423 V17.2.0 section 9.1.1.3, but with a new information element indicating that it is a rejection of DU migration of an IAB-node including the cause of the rejection (e.g. because of load issue).

According to another example, the DU migration notification message 1712 may be the NG-RAN NODE CONFIGURATION UPDATE message specified in TS 38.423 V17.2.0 section 9.1.3.4, but with a new information element indicating that it is a notification for a DU migration of an IAB-node to be performed between a source F1 donor-CU and a target F1 donor CU. This message includes the identifiers of the related IAB-node known by the two donor-CUs (source F1 donor-CU sending the message and non-F1 donor-CU receiving the message), and it may include the identifier of the target F1 donor-CU in addition to the other information elements present in the message as specified in TS 38.423. Besides, the DU migration response message 1713 may be the NG-RAN NODE CONFIGURATION UPDATE ACKNOWLEDGE message specified in TS 38.423 V17.2.0 section 9.1.3.5, but with a new information element indicating that it is an acknowledgment for a DU migration of an IAB-node to be performed between a source F1 donor-CU and a target F1 donor CU. In case of rejection of DU migration, the DU migration response message 1713 may be the NG-RAN NODE CONFIGURATION UPDATE FAILURE message specified in TS 38.423 V17.2.0 section 9.1.3.6, but with a new information element indicating that it is a rejection of DU migration of an IAB-node including the cause of the rejection (e.g. because of load issue).

According to another example, the DU migration notification message 1712 may be the MOBILITY CHANGE REQUEST message specified in TS 38.423 V17.2.0 section 9.1.3.22, but with a new information element indicating that it is a notification for a DU migration of an IAB-node to be performed between a source F1 donor-CU and a target F1 donor CU. This message includes the identifiers of the related IAB-node known by the two donor-CUs (source F1 donor-CU sending the message and non-F1 donor-CU receiving the message), and it may include the identifier of the target F1 donor-CU in addition to the other information elements present in the message as specified in TS 38.423. Besides, the DU migration response message 1713 may be the MOBILITY CHANGE ACKNOWLEDGE message specified in TS 38.423 V17.2.0 section 9.1.3.23, but with a new information element indicating that it is an acknowledgment for a DU migration of an IAB-node to be performed between a source F1 donor-CU and a target F1 donor CU. In case of rejection of DU migration, the DU migration response message 1713 may be the MOBILITY CHANGE FAILURE message specified in TS 38.423 V17.2.0 section 9.1.3.24, but with a new information element indicating that it is a rejection of DU migration of an IAB-node including the cause of the rejection (e.g. because of load issue).

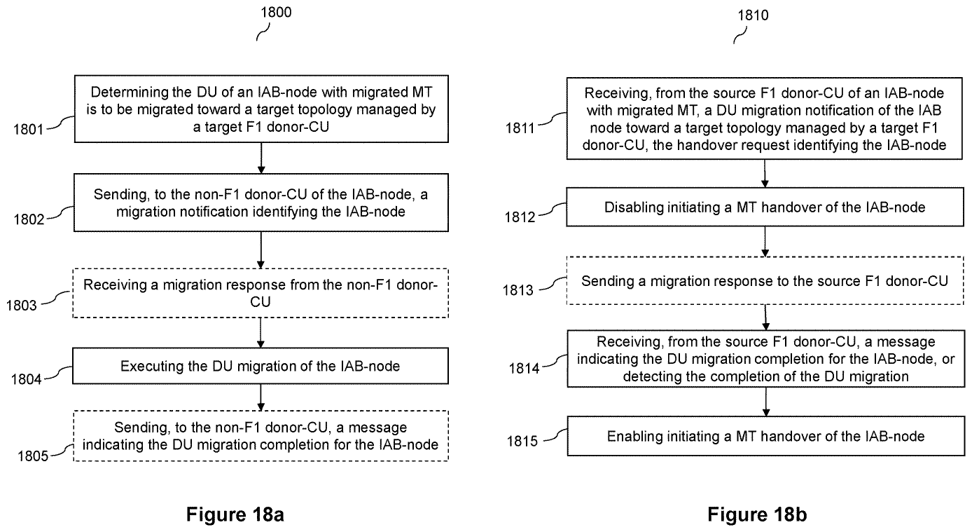

FIG. 18a is a flowchart of an example method 1800 in accordance with one or more embodiments of the present invention, for managing, at a first IAB donor CU (e.g. the source F1 terminating donor-CU) of an IAB-node managing or controlling a first IAB topology, the DU migration of the IAB-node in a manner that it does not compete with a consecutive MT migration of the IAB-node. The consecutive MT migration of the IAB-node may involve migration of the MT of the IAB-node from a first parent IAB node of a second IAB topology managed or controlled by a second IAB donor CU (e.g. the source non-F1 terminating donor-CU) toward a second parent IAB node. In an example, the first parent IAB node involves or uses a first backhaul path including a first IAB donor DU of the second IAB topology managed by the second IAB donor CU to route data associated with the IAB node and the second parent IAB node is in a second backhaul path including a second IAB donor DU of the second IAB topology to route data associated with the IAB node (e.g. the migration is between two different donor DUs in the same topology). In this case, the source non-F1 donor-CU may decide to apply the intra-CU topology adaptation procedure for the IAB-node as discussed above with reference to FIG. 6. In another example, the second parent IAB node is part of a third IAB topology managed by a third IAB donor CU. In this case, the consecutive MT migration of the IAB-node is toward a target IAB topology different from the IAB topology controlled by a first IAB donor CU (e.g. the F1 terminating donor-CU) of the IAB-node (e.g. the target IAB topology is not the IAB topology controlled by the F1 terminating donor-CU of the IAB-node).

For example, with reference to the IAB communication system shown in and described with respect to FIG. 8, the first IAB donor CU performing the method 1800 may be the IAB donor CU 801 (e.g. a F1 terminating donor CU of the IAB node 870 with which the IAB node 870 retains a F1 connection). The IAB node may be mobile IAB-node 870 belonging to IAB topology 8001 controlled by the IAB donor CU 801, with a migrated MT controlled by the IAB donor CU 802 (e.g. a non-F1 terminating donor CU of the mobile IAB node 870 with which the mobile IAB node 870 has a RRC connection). The migration process involves the migration of the DU 872 of the IAB node 870 from the IAB donor CU 801, which is operating as the source F1 terminating donor CU, to the IAB donor CU 803 controlling the IAB topology 8003, which is operating as the target F1 terminating donor CU. In FIG. 17, the non-F1 terminating donor CU is referred to by the reference number 1705, the F1 terminating donor CU is referred to by the reference number 1704 and the target F1 terminating donor CU is referred to by the reference number 1706. The method 1800 as shown in and described with respect to FIG. 18a may be performed by software elements and/or hardware elements. The source F1 terminating IAB donor CU may be implemented in a communication device 400 as shown in and described with reference to FIG. 4 with the method as shown in and described with respect to FIG. 18a being performed by an apparatus for the F1 terminating IAB donor CU including one or more processing units, such as the central processing unit 411.

At step 1801, a source F1 terminating donor-CU (or source F1 donor-CU), like the donor-CU 801, of an IAB-node, like the IAB-node 870, determines the DU 872 of the IAB node 870 is to be migrated toward a target topology (e.g. IAB topology 8003) managed by a target F1 terminating donor-CU (or target F1 donor-CU) 803, while the MT 871 of the IAB-node was already migrated toward a non-F1 terminating donor-CU (or non-F1 donor CU) 802.

At step 1802, the source F1 donor-CU 801 sends, to the non-F1 donor-CU, a DU migration notification message identifying the IAB-node 870. For example, the source F1 donor-CU 801 sends a DU migration notification for indicating the DU 872 of the IAB-node 870 is to be migrated. The DU migration notification includes identification information for identifying the IAB-node having the DU to be migrated. The DU migration notification may be included in the DU migration notification (or IAB NODE MIGRATION REQUEST) message 1712 as discussed above. The source F1 donor-CU 801 may send a DU migration notification before executing migration of the DU of the IAB node as discussed above, with reference to FIG. 17 and to the sending of the message 1712.

At step 1803, the source F1 donor-CU 801 may receive a DU migration response message from the non-F1 donor-CU 802, as a response to the DU migration notification message of step 1802. The DU migration response may be included in the DU migration response (or IAB NODE MIGRATION RESPONSE) message 1713 as discussed above.

At step 1804, the source F1 donor-CU 801 executes the DU migration procedure for the IAB-node 870. For example, the source F1 donor-CU 801 executes the DU migration procedure/process after receiving the DU migration response (or IAB NODE MIGRATION RESPONSE) message 1713.

At step 1805, the source F1 donor-CU 801 may send, to the non-F1 donor-CU 802, a message indicating the DU migration is completed for the IAB-node 870. For example, the source F1 donor-CU 801 may send a DU migration completion message 1715 as discussed above.

FIG. 18b is a flowchart of an example method 1810 in accordance with one or more embodiments of the present invention, for use in managing migration (e.g. including handover) of a MT of an IAB node managed by a second IAB donor CU (e.g. the non-F1 terminating donor-CU) which manages a second IAB topology during a DU migration of the IAB-node from a first IAB topology managed by a first IAB donor CU (e.g. the F1 terminating donor-CU) toward a third IAB topology managed by a third IAB donor CU (e.g. the target F1 terminating donor-CU). The method 1810 is performed at the second IAB donor CU (e.g. the non-F1 terminating donor-CU). The method involves disabling, at the non-F1 terminating donor-CU of an IAB-node, the MT migration (e.g. including disabling MT handover) of the IAB-node during a DU migration of the IAB-node.

For example, with reference to the IAB communication system shown in and described with respect to FIG. 8, the second IAB donor CU performing the method 1810 may be the IAB donor CU 802 (e. g a non-F1 terminating donor CU of the IAB node 870 with which the IAB node 870 has a RRC connection). The IAB node may be mobile IAB-node 870 belonging to IAB topology 8001 controlled by the IAB donor CU 801. Thus in this case IAB donor CU 801 is the first IAB donor CU and IAB topology 8001 is the first IAB topology. The third IAB donor CU is the IAB donor CU 803. In FIG. 17, the non-F1 terminating donor CU is referred to by the reference number 1705, the F1 terminating donor CU is referred to by the reference number 1704 and the target F1 terminating donor CU is referred to by the reference number 1706. The method 1810 as shown in and described with respect to FIG. 18b may be performed by software elements and/or hardware elements. The non-F1 terminating IAB donor CU may be implemented in a communication device 400 as shown in and described with reference to FIG. 4 with the method as shown in and described with respect to FIG. 18b being performed by an apparatus for the non-F1 terminating IAB donor CU including one or more processing units, such as the central processing unit 411.

At step 1811, a non-F1 terminating donor-CU (or non-F1 donor-CU), like the IAB-donor-CU 802, receives from the source F1 terminating donor-CU (or source F1 donor-CU) of an IAB-node 870, a DU migration notification of the IAB node toward a target topology managed by a target F1 terminating donor-CU (or target F1 donor-CU), the DU migration notification identifying the IAB-node. The source F1 donor-CU may be the IAB donor CU 801, and the target F1 donor-CU may be the IAB donor CU 803. Thus, the non-F1 donor-CU 802 receives a DU migration notification for indicating the DU 872 of the IAB-node 870 is to be migrated toward a third IAB topology 8003. The DU migration notification includes identification information for identifying the IAB-node having the DU to be migrated. The DU migration notification may be included in the DU migration notification (or IAB NODE MIGRATION REQUEST) message 1712 as discussed above.

At step 1812, the non-F1 donor-CU 802 disables initiating a MT migration procedure/process (starting with MT handover) for the IAB-node. For example, the non-F1 donor-CU 802 disables initiating a migration process for the MT of the IAB node until completion of the migration process for the DU of the IAB node.

The non-F1 donor-CU 802 enables initiating a migration process for the MT of the IAB node after the DU of the IAB node has been migrated to the third IAB topology (e.g. after completion of the migration process for the DU of the IAB node), step 1815. The non-F1 donor-CU 802 may determine the DU of the IAB node has been migrated to the third IAB topology (e.g. the migration process for the DU of the IAB node is completed) as discussed below with reference to step 1814.

At step 1813, the non-F1 donor-CU 802 may send a DU migration response message to the source F1 donor-CU 801, as a response to the DU migration notification message of step 1811. The DU migration response may be included in the DU migration response (or IAB NODE MIGRATION RESPONSE) message 1713 as discussed above.

At step 1814, the non-F1 donor-CU 802 may receive from the source F1 donor-CU 801 a message indicating the DU migration is completed for the IAB-node. For example, the source F1 donor-CU 801 may send a DU migration completion message 1715 as discussed above. As an alternative step, the non-F1 donor-CU 802 may detect the completion of the DU migration through the exchanges of messages with the source F1 donor-CU 801 or the target F1 donor-CU 803 at the end of the DU migration procedure.

At step 1815, the non-F1 donor-CU enables initiating a MT migration procedure for the IAB-node (e.g. which includes enabling MT handover which is part of the MT migration process).

It can be noted that the procedure described with reference to FIG. 15 can be used alone without the procedure described with reference to FIG. 17. Inversely, the procedure described with reference to FIG. 17 can be used alone without the procedure described with reference to FIG. 15. Also, both procedures may be used in a complementary manner. The MT migration may have priority over DU migration as MT migration may be necessary to avoid service interruption because of bad radio conditions. Then, in case of MT handover notification message 1512 and DU migration notification message 1712 being generated at the same time or substantially at the same time, the F1 donor-CU 1504/1704 should cancel the DU migration upon reception of the message 1512, or it should wait for an acknowledgment message 1713 from the non-F1 donor-CU 1505/1705 that is an acknowledgment from the non-F1 donor-CU for a DU migration of an IAB-node to be performed between a source F1 donor-CU and a target F1 donor CU, before launching the DU migration.

Sending the MT migration notification and/or DU migration notification as described above with reference to FIGS. 15 to 18 provides a relatively simple way to ensure that a MT migration is executed and completed while the co-located DU stays connected to the same donor, and/or a DU migration is executed and completed while the co-located MT stays connected to the same donor. This helps to reduce the chance of failure of at least one of the migration procedures whilst also avoiding complex signalling.

In other words and as a summary, it can be noted that executing a mobile IAB-MT (mIAB-MT) migration at the same time as the co-located mobile IAB-DU (mIAB-DU) migration may lead to failure of at least one of the procedures or it may drastically increase the complexity of signalling. As a safe approach, mIAB-MT migration should be executed and completed while the co-located mIAB-DU stays connected to the same donor-CU, and mIAB-DU migration should be executed and completed while the co-located mIAB-MT stays connected to the same donor-CU.

To avoid concurrent migrations of mIAB-MT and mIAB-DU, a single donor-CU should control the sequence of mIAB-MT and mIAB-DU migrations for a mobile IAB-node. As, on one hand, the donor-CU serving the mIAB-DU decides whether to execute the mIAB-DU migration, and, on the other hand, the donor CU serving the mIAB-DU is informed about the mIAB-MT handover, the donor-CU serving the mIAB-DU appears as the appropriate donor-CU to control the sequence. Moreover, the donor-CU serving the mIAB-DU may know when a mIAB-MT migration is completed as it can directly exchange Xn IAB Transport Migration messages with the target donor CU.

Consequently, one can observe that the F1 terminating donor-CU of an IAB-node is the appropriate donor-CU to control the sequence of IAB-MT and IAB-DU migrations for the mobile IAB-node.

Thus, when the non-F1 terminating donor-CU or RRC terminating donor-CU of a mobile IAB-node detects the need to execute a mIAB-MT migration to connect the mIAB-MT to a target non-F1 terminating donor-CU, the non-F1 terminating donor-CU should let the F1 terminating donor-CU trigger the mIAB-MT migration at the appropriate time.

It is then proposed that the non-F1 terminating donor-CU of a mobile IAB-node should let the F1 terminating donor trigger the inter-donor migration of the mIAB-MT at the appropriate time.

As a possible way to control the sequence, the non-F1 terminating donor-CU detecting the need for a mIAB-MT migration to connect the mIAB-MT to a target non-F1 terminating donor-CU, may first inform the F1 terminating donor-CU. Then, the F1 terminating donor-CU will trigger the inter-donor mIAB-MT migration at the appropriate time, and will respond to the non-F1 terminating donor-CU.

When analysing the impact of concurrent MT handover and DU migration for a mobile IAB-node, it appears that it is the DU migration that may fail due to the possible modification of the backhaul path to communicate with the mobile IAB-node. Depending on when the original backhaul path between the mobile IAB-node and the source non-F1 terminating donor-CU is no longer available, F1 setup procedure or UE handover procedure in DU migration is likely to fail at some point. On the other hand, the handover of the mobile IAB-MT (mIAB-MT) should not be impacted by a concurrent migration of the co-located mobile IAB-DU (mIAB-DU).

As a safe approach, a mIAB-DU migration should be executed and completed while the co-located mIAB-MT stays connected to the same donor-CU. However, assuming a mIAB-MT handover should not be delayed to maintain backhaul connection and to avoid service interruption at the served UEs, a mIAB-MT handover may be triggered when a mIAB-DU migration is on-going. What can be done is to limit the cases of concurrent MT handover and DU migration by preventing the triggering of a mIAB-DU migration while a handover of the co-located mIAB-MT is on-going.

Thus, when the non-F1 terminating donor-CU of a mobile IAB-node detects the need to execute a mIAB-MT handover, the non-F1 terminating donor-CU may immediately inform the F1 terminating donor-CU.

It is then proposed that the non-F1 terminating donor-CU of a mobile IAB-node may inform the F1 terminating donor before executing a MT handover of the mobile IAB-node.

Then, the F1 terminating donor-CU may disable the execution of a DU migration for the mobile IAB-node until completion of the handover process for the co-located mIAB-MT.

Several of the aforementioned features make it possible to effectively decouple mIAB-MT handover and mIAB-DU migration.

While the present invention has been described with reference to embodiments and examples, it is to be understood that the invention is not limited to the disclosed embodiments and examples. It will be appreciated by those skilled in the art that various changes and modification might be made without departing from the scope of the invention, as defined in the appended claims. All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

In the preceding embodiments and examples, the functions described may be implemented in hardware, software, firmware, or any combination thereof. If implemented in software, the functions may be stored on or transmitted over, as one or more instructions or code, a computer-readable medium and executed by a hardware-based processing unit.

Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

1-19. (canceled)

20. A method for use in a migration process in which a Mobile Termination, MT, of an Integrated Access and Backhaul, IAB, node is migrated from a source IAB donor Central Unit, CU, of a second IAB topology, terminating a RRC connection to the IAB node, to a target IAB donor CU of a third IAB topology, the IAB node having a connection to a F1-terminating IAB donor CU of a first IAB topology, the method at the IAB node comprising:
sending, to the F1-terminating IAB donor CU, identification information for identifying the target IAB donor CU.

21. The method of claim 20, further comprising:
receiving, from the target IAB donor CU, one or more addresses associated with a target IAB donor DU of the third IAB topology via which data associated with the IAB node is to be routed in the third IAB topology;
sending, to the F1-terminating IAB donor CU, address information including the one or more addresses.

22. The method of claim 21, wherein the address information and identification information are sent by the IAB node in one message.

23. The method of claim 20, further comprising sending, to the F1-terminating IAB donor CU, IAB node identification information for identifying the IAB node.

24-25. (canceled)

26. A method for use in a migration process in which a Mobile Termination, MT, of an Integrated Access and Backhaul, IAB, node is migrated from a source IAB donor Central Unit, CU, of a second IAB topology, terminating a RRC connection to the IAB node, to target IAB donor CU of a third IAB topology, the IAB node having a connection to a F1-terminating IAB donor CU of a first IAB topology, the method at the F1-terminating IAB donor CU comprising:
receiving, from the IAB node, identification information for identifying the target IAB donor CU.

27-28. (canceled)

29. The method of claim 26, further comprising updating, at the F1-terminating IAB donor CU and based on the received information, one or more routing paths to be used for routing data associated with the IAB node.

30. The method of claim 26, further comprising receiving IAB node identification information for identifying the IAB node.

31-69. (canceled)

70. The method of claim 20, wherein the IAB node is a mobile IAB node.

71. An apparatus for an Integrated Access and Backhaul, IAB, node for an IAB communication system, the apparatus comprising:
one or more processing units configured to:
send, to a first IAB donor Central Unit, CU, of a first topology in the case where a Mobile Termination, MT, of the IAB node is migrated from a source IAB donor CU, of a second IAB topology, terminating a RRC connection to the IAB node, to a target IAB donor CU of a third IAB topology, the IAB node having a connection to the first IAB donor CU as a F1-terminating IAB donor CU, identification information for identifying the target IAB donor CU.

72. An apparatus for a first Integrated Access and Backhaul, IAB, donor Central Unit, CU, for an IAB communication system, the apparatus comprising:
one or more processing units configured to: receive, from an IAB node in the case where a Mobile Termination, MT, of the IAB node is migrated from a source IAB donor CU, of a second IAB topology, terminating a RRC connection to the IAB node, to a target IAB donor CU of a third topology, the IAB node having a connection to the first IAB donor CU, as a F1-terminating IAB donor CU, of a first IAB topology, identification information for identifying the target IAB donor CU.

73. (canceled)

74. A non-transitory computer-readable storage medium carrying a computer program comprising program instructions which, when the computer program is executed by one or more processors of an Integrated Access and Backhaul, IAB, node, cause the IAB node to: send, to a first IAB donor Central Unit, CU, of a first topology in the case where a Mobile Termination, MT, of the IAB node is migrated from a source IAB donor CU, of a second IAB topology, terminating a RRC connection to the IAB node, to a target IAB donor CU of a third IAB topology, the IAB node having a connection to the first IAB donor CU as a F1-terminating IAB donor CU, identification information for identifying the target IAB donor CU.

75. The method of claim 20, wherein the identification information is sent by the IAB node in a gNB-DU CONFIGURATION UPDATE message.

76. (canceled)

77. (canceled)

78. The method of claim 26, further comprising initiating an IAB Transport Migration Management procedure for the F1-U paths of the IAB node.

79. The method of claim 26, wherein the information is received in a gNB-DU CONFIGURATION UPDATE message.

80. The method of claim 26, wherein the IAB node is a mobile IAB node.

81. The apparatus of claim 71, wherein the identification information is sent by the IAB node in a gNB-DU CONFIGURATION UPDATE message.

82. The apparatus of claim 71, wherein the one or more processing units are further configured to send, to the F1-terminating IAB donor CU, IAB node identification information for identifying the IAB node.

83. The apparatus of claim 71, wherein the IAB node is a mobile IAB node.

84. (canceled)

85. (canceled)

86. The apparatus of claim 72, wherein the one or more processing units are further configured to receive IAB node identification information for identifying the IAB node.

87. The apparatus of claim 72, wherein the one or more processing units are further configured to initiate an IAB Transport Migration Management procedure for the F1-U paths of the IAB node.

88. The apparatus of claim 72, wherein the information is received in a gNB-DU CONFIGURATION UPDATE message.

89. The method of claim 26, wherein the IAB node is a mobile IAB node.
